(19) United States
(12) Patent Application Publication
(10) Pub. No.: US 2026/0362243 A1
(43) Pub. Date: Nov. 12, 2026

(54) User Plane Function Based Rate Limiting for 6th Generation Video Streaming Devices

(71) Applicant: Oswego Technologies LLC, columbus, NJ (US)

(72) Inventor: Long Vu, Singapore (SG)

(21) Appl. No.: 19/657,528

(22) Filed: Apr. 24, 2026

(30) Foreign Application Priority Data
May 7, 2025 (VN) 1-2025-03128
Jul. 24, 2025 (VN) 1-2025-05299

(51) Int. Cl. H04W 28/24; H04L 67/104; H04W 28/22

(52) U.S. Cl. CPC H04W 28/24; H04L 67/104; H04W 28/22

(57) ABSTRACT

A method performed by a user equipment (UE) may comprise receiving video content, from a video server, via a user plane function (UPF) of a cellular network and receiving, in accordance with information held in the user plane function (UPF), rate limiting information that indicates a rate limit applicable between the UE and the video server. In embodiments, the cellular network administers a policy having a time defined constraint measured according to a number of seconds, wherein the constraint corresponds to a rate limit of the video content. The UE may self-adapt and/or rate-adjust the video content, based on the rate limit information and the number of seconds. In embodiments, the number of seconds is between 60 and 120 seconds.

### CROSS REFERENCE TO RELATED APPLICATIONS

This application claims priority to Vietnam Patent Application No. 1-2025-03128 filed on May 7, 2025 and Vietnam Patent Application No. 1-2025-05299 filed on Jul. 24, 2025, the contents of each of which are incorporated by way of reference entirely herein.

### SUMMARY

A method performed by a user equipment (UE) may comprise receiving video content, from a video server, via a user plane function (UPF) of a cellular network and receiving, in accordance with information held in the user plane function (UPF), rate limiting information that indicates a rate limit applicable between the UE and the video server. In embodiments, the cellular network administers a policy having a time defined constraint measured according to a number of seconds, wherein the constraint corresponds to a rate limit of the video content. The UE may self-adapt and/or rate-adjust the video content, based on the rate limit information and the number of seconds. In embodiments, the number of seconds is between 60 and 120 seconds.

The method may further comprise temporarily disabling some rate limiting for a number of seconds when the network upgrades the capacity. In embodiments, the rate limiting information is information indicating an increase from a previous rate limit. The UPF applies rate limiting controls to flows other than video flows, including a bulk download flow.

### BRIEF DESCRIPTION OF THE DRAWINGS

FIG. 1 provides a high-level view of the entities involved in the application;

FIG. 2 is a flowchart showing an example process of negotiating and establishing a micro-SLA for QoS between the UE's agent and the network controller;

FIG. 3 is a schematic diagram of the internal components of the user equipment's intelligent QoS agent;

FIG. 4 is a schematic diagram of the internal architecture of the network-side intent-based QoS negotiation controller (150);

FIG. 5A is a sequence diagram (message flow) illustrating the communication exchanges between the UE, RAN, and core network during an intent-based QoS negotiation;

FIG. 5B is a continuation of FIG. 5A;

FIG. 6A is a time-sequence diagram depicting the lifecycle of a micro-SLA enforcement;

FIG. 6B is a continuation of FIG. 6A;

FIG. 6C is a continuation of FIG. 6A;

FIG. 7 illustrates an example of network slicing integration with the micro-SLA framework;

FIG. 8 shows a use case scenario involving a non-terrestrial network (satellite) component;

FIG. 9 is a deployment diagram focusing on backward compatibility and implementation in current 5G systems;

FIG. 10 addresses multi-user scenarios;

FIG. 11 illustrates an overall system architecture for an AI-driven peer-to-peer multimedia streaming system operating over a 3GPP wireless network;

FIG. 12 is a block diagram showing the system components and modular architecture of the peer-to-peer streaming system;

FIG. 13A is a flowchart illustrating an exemplary peer discovery and content streaming session setup procedure in the system;

FIG. 13B is a continuation of FIG. 13A;

FIG. 14A depicts an AI model lifecycle and federated learning workflow integrated within the peer-to-peer streaming system;

FIG. 14B is a continuation of FIG. 14A;

FIG. 15A shows a schematic diagram of dynamic switching between content delivery modes, including peer-to-peer (P2P), unicast, and multicast, in the streaming system;

FIG. 15B is a continuation of FIG. 15A;

FIG. 16A is a signaling diagram illustrating an example sequence of messages for peer discovery and session setup over the 3GPP network;

FIG. 16B is a continuation of FIG. 16A;

FIG. 17A illustrates an AI-driven peer selection process and routing decision mechanism for content delivery in the streaming network;

FIG. 17B is a continuation of FIG. 17A;

FIG. 18A depicts quality of service (QoS) management and congestion control mechanisms employed in the peer-to-peer streaming system; and

FIG. 18B is a continuation of FIG. 18A;

### DETAILED DESCRIPTION

An adaptive framework is disclosed for dynamic, intent-driven Quality of Service (QoS) negotiation in 5G/6G mobile networks. In the proposed system, user equipment (UE) includes an intelligent agent embedded within a user application or operating system, capable of conveying high-level intent information about the application's QoS needs to the network. An AI-enabled network-side controller receives these intent-based requests and negotiates short-term micro Service Level Agreements (micro-SLAs) with the UE's agent. During a micro-SLA, the network temporarily adjusts resource allocations (e.g. bandwidth, latency prioritization) to fulfill the requested QoS enhancement for the specified duration or context. The negotiation process involves the UE agent monitoring application context and performance requirements, sending a QoS enhancement request describing the intent (such as a need for low latency or high throughput for a brief period), and the network controller autonomously determining an optimal QoS adjustment (if network conditions and policies permit) using predictive analytics and real-time network state. The micro-SLA is then enforced via standard 5G/6G mechanisms-for example, by instructing core network functions (Policy Control, Session Management) to modify QoS parameters or by assigning the UE to a suitable network slice—and is terminated or re-negotiated once the intent context ends. The application ensures backward compatibility with existing 5G architectures (e.g. leveraging Policy Control Function and Network Exposure interfaces) while introducing new logical components for intent interpretation and negotiation. Example use cases include on-demand video streaming at enhanced quality, augmented reality sessions requiring low latency, and opportunistic high-throughput data transfers during brief connectivity windows (such as when a satellite link is available). By intelligently matching short-term user needs with network capabilities, the framework improves user experience and network efficiency, enabling real-time QoS adaptation beyond the static policies of current mobile networks.

The present application relates generally to telecommunications networking and Quality of Service (QoS) management in mobile networks. More particularly, it concerns a system and method for adaptive QoS negotiation between user equipment and network controllers in 5G/6G architectures, using intent-based communication to establish short-term micro service level agreements that dynamically enhance network resource allocation for specific user application needs.

Mobile network operators traditionally provide QoS guarantees through static arrangements, such as service-level agreements (SLAs) or predefined QoS profiles associated with a user's subscription or a particular network slice. In current 4G and 5G systems, the QoS for a user's traffic is typically determined by network-managed policies and subscription data. For instance, in 5G architecture, the Policy Control Function (PCF) defines QoS rules for each session, which are then enforced by the Session Management Function (SMF) and ultimately realized in the user plane (e.g., by the gNodeB and the User Plane Function). User applications themselves have little to no ability to request ad hoc changes to their QoS treatment; the network primarily makes QoS decisions based on static service profiles or operator-defined rules.

While 5G introduces the concept of network slicing and a richer QoS framework (with QoS flows of varying priorities and characteristics), these mechanisms are configured by the network in advance or through operator intervention. For example, an operator can assign a high-resolution video service to a “video slice” with certain guaranteed bandwidth, but the end-user device cannot on its own negotiate a new QoS level in real time beyond what is provisioned. The Network Exposure Function (NEF) does allow external Application Functions (AFs) to interact with the 5G core to request policy and QoS modifications, but such interfaces are typically intended for trusted application servers or enterprise services rather than on-device apps, and they are not designed for frequent, rapid negotiation on a per-user-flow basis.

As a result of these limitations, applications with time-varying or context-dependent demands often face a mismatch in QoS. For instance, a mobile augmented reality (AR) application may only occasionally need ultra-low latency and high throughput (e.g., during a critical interaction or scene), but under current networks it must either operate within the constraints of its default QoS (risking degraded performance during those critical moments) or the operator must permanently assign it a high QoS level (wasting resources when the application's demand is lower). There is no standard mechanism for a user's device to say to the network: “I am about to need significantly better QoS for the next 120 seconds for a specific task”, and have the network grant that request temporarily. The absence of fine-grained, on-demand QoS negotiation leads to either suboptimal user experience or inefficient resource utilization.

The concept of offering micro-SLAs—essentially short-term, granular QoS guarantees for individual application flows—has been discussed in the industry as a way to personalize network services. In fact, some visionary frameworks have suggested a “personalized approach” where an application could explicitly request resources and obtain a micro-SLA for each flow it needs. Once a micro-SLA is in force, the disclosed framework does not bar the UE from transmitting additional intent messages; instead, any subsequent intent is conveyed with an explicit SLA-Identifier field that links the new request to the active contract. The network-side Intent-Aware QoS Controller interprets that identifier as a signal that the flow is already under an elevated guarantee and, accordingly, evaluates the new intent at a higher admission priority than intents originating from UEs that are operating without a micro-SLA. If the supplemental request merely refines or extends the parameters of the existing guarantee, the controller attempts to merge the two requirement sets—subject to current cell-wide resource ceilings and operator policy—into a single, updated micro-SLA; if the merge would violate those limits, the controller issues a counter-offer (reduced bandwidth, shorter duration, or deferred start-time), thus preserving network stability while still affording the SLA-bearing UE preferential treatment over best-effort traffic. Such an approach would treat the network as “smart” and resource-aware, in contrast to “dumb pipe” models where the network just provides best-effort service with finite resources. However, to date, existing mobile network standards and products do not implement this kind of per-flow micro-SLA negotiation. Applications remain largely at the mercy of pre-configured QoS or whatever adaptive behavior the network itself performs without explicit input from the application.

There are some existing mechanisms and research efforts aimed at more dynamic QoS management, but they fall short of enabling agent-to-network negotiation based on application intent. For example, 5G systems support Reflective QoS for the uplink, wherein a UE can automatically apply QoS rules for its uplink traffic based on markings observed in downlink packets (when the network indicates reflective QoS is allowed). Reflective QoS is a useful tool for low-latency adjustment of uplink traffic behavior, but it is entirely network-driven-the network marks downlink packets and the UE simply mirrors that QoS for matching uplink flows. The UE cannot initiate a new QoS policy; it can only respond to hints provided by the network, and the mechanism is limited to aligning uplink QoS with downlink treatment.

Another relevant development in 5G is the Network Data Analytics Function (NWDAF), which collects and analyzes network data (e.g., traffic load, performance trends) to assist other network functions in decision-making. NWDAF can generate analytics such as predicted cell congestion or expected QoS degradation, which policy functions might use to adjust how resources are allocated. In some proposals, NWDAF-assisted QoS provisioning is considered, meaning the network's AI/analytics could proactively adjust QoS configurations or slicing based on anticipated needs. For instance, if analytics predict a surge in video traffic, the network might preemptively allocate more resources or prioritize certain flows. While this adds a layer of network intelligence, it still operates from the network's perspective, without explicit, real-time negotiation with individual user applications. The application's specific intent (e.g., “user is starting a critical video conference now”) may not be known to the network unless the network infers it indirectly (which can be error-prone).

Prior patent literature also reflects the growing interest in more adaptive QoS control. For example, WO2022/005037 is understood to describe methods and apparatuses for providing network analysis information in a wireless communication network (such as a 5G network). Based on its title and context, that disclosure likely focuses on how a network node (possibly analogous to NWDAF or another analytics entity) can supply analysis or predictive information to assist in network management decisions regarding QoS or resource allocation. While providing analytics to network functions can improve overall QoS handling, WO2022/005037 does not teach or suggest a user-driven QoS negotiation. It addresses network-side improvements (making the network more aware or predictive) rather than allowing a user equipment to actively negotiate a temporary QoS improvement for its own traffic.

Another example is US2024/0163734, titled “Device and method for providing a quality of service function.” In that published application, a solution is described in which a device (likely a network node) monitors the QoS of a communication service and determines changes in QoS, then transmits the determined change to the application entity or network entities. In essence, the device can query various entities (the application, the UE, or network components) for monitoring information, detect if the QoS for a service has deviated, and then inform relevant parties of this change so that actions can be taken. This is a reactive approach to QoS management: when something like a QoS degradation or change is detected, the system responds by notifying an application or adjusting policies. Notably, US2024/0163734 does not describe any mechanism for the application to request a QoS upgrade ahead of time, nor does it involve an agent in the UE negotiating terms with the network. It is fundamentally different from an intent-based negotiation; it is more about the network (or an intermediary device) informing the application of QoS changes or in one embodiment autonomously tweaking QoS based on monitored data. In summary, US2024/0163734's solution improves QoS consistency by monitoring and reacting to changes, but it does not empower the application to ask for specific QoS levels on-demand for future needs.

Apart from patents, various research and industry efforts point toward intent-based networking as a key paradigm for future networks, especially in the context of 6G and fully autonomous network management. The concept of intents involves an operator or application expressing what it needs (in declarative terms), and the network being smart enough to configure how to achieve it. Intents are essentially high-level requirements, such as “ensure at least 50 Mbps throughput and 20 ms latency for this application for the next 2 minutes”, without specifying the technical details of how to allocate resources. In an intent-driven system, the network (often with the help of AI) translates these requirements into low-level configurations-for example, by adjusting scheduling weights, moving the user to a less congested cell or slice, activating additional carriers, etc. Industry publications (e.g., by major telecom vendors and standards bodies) have underscored that moving toward intent-based, autonomous networks can speed up service delivery and improve performance, as the network can dynamically adapt to meet the expressed objectives. However, much of the focus to date has been on operator intents (e.g., a service provider specifying a business-level intent for network operation) or on high-level slicing and orchestration. Little has been concretely done regarding user equipment or application intents being fed directly into the network control loop in real time.

One notable vision from Ericsson describes an Intent Management Function (IMF) in future networks that could allow different domains (business, service, resource domains) to exchange intents and fulfill them autonomously. In that vision, if one domain needs resources from another, it would send an intent rather than a fixed command, and the receiving domain's IMF would decide how to satisfy it. Requirements negotiation and dynamic conflict resolution are mentioned as features of such intent interfaces. This aligns conceptually with a goal of the present application which is to achieve on a smaller scale between a UE's application and the mobile network: the application expresses a requirement (intent) and the network decides how to fulfill it, if possible. The Ericsson framework goes further to suggest that utility functions and AI-driven decision-making can be used to handle multiple intents and optimize outcomes. These ideas strongly indicate that an intent-aware, AI-assisted QoS negotiation is both technically feasible and considered valuable in the evolution toward 6G.

In summary, the prior art and current state of technology reveal the following gaps. Existing QoS management is largely static or reactive. Networks can enforce QoS profiles and can react to issues (via monitoring or analytics) but do not allow real-time, application-initiated negotiation of QoS for a short duration. No standardized method exists for a UE to request and obtain a temporary QoS boost tailored to its immediate needs. Prior solutions such as NWDAF-based analytics (e.g., WO2022/005037) and QoS monitoring functions (e.g., US2024/0163734) improve network automation and stability, but remain network-centric. They do not incorporate explicit signaling of application intent from the UE, nor do they establish a defined short-term contract (micro-SLA) with clear start/end and guaranteed parameters as a result of a negotiation. The concept of intent-based, autonomous QoS control is emerging but not yet implemented in practical systems. There is a recognized need for translating high-level service requirements into network actions on the fly, which the present application directly addresses from the UE-network interaction standpoint.

Accordingly, there is a clear need for a new approach that empowers user-side intelligent agents to collaborate with network intelligence in order to tailor QoS in real time. Such an approach should ensure that when an application has a critical requirement (e.g., a brief spike in needed bandwidth or a latency-sensitive operation), the request is conveyed in meaningful terms to the network, and the network can respond by allocating resources commensurate with that request for just as long as needed. The solution must preserve fairness and network stability—leveraging AI to evaluate requests against current network load and policies—and integrate with existing network functions like PCF, SMF, admission control, and slicing mechanisms. Ideally, the solution should be deployable as an enhancement to 5G networks (with software updates or additional functions) and form a native capability in future 6G architectures.

The present application provides such a solution through an Adaptive Agent-to-Network QoS Negotiation Framework using intent-aware micro-SLAs.

The application disclosed herein provides a system, architecture, and method for real-time negotiation of Quality of Service (QoS) levels between a user's device and a mobile network, driven by the user application's intent and realized through short-term micro-SLAs (micro Service Level Agreements). This solution enables on-demand, fine-grained QoS enhancements within 5G/6G networks in a manner that is not possible with existing static or network-centric QoS control mechanisms.

In one aspect, the application is a method for adaptive QoS negotiation in a wireless network. The method involves a user equipment (UE)-resident intelligent agent and a network-side QoS controller engaging in a handshake to temporarily elevate or modify QoS for a specific data flow or service. The process can be summarized as follows (with details and variations described later):

Intent Signaling from UE: A UE (e.g., a smartphone, tablet, AR headset, or any 5G/6G-connected device) monitors its active applications and detects when an application or service anticipates a need for enhanced network performance. This anticipation could be triggered by user action (e.g., the user launching a 4K video stream or a video conference) or by application logic (e.g., a game entering a latency-critical phase). The UE's embedded QoS agent formulates an intent message describing the desired QoS improvement. The intent message is high-level and declarative, meaning it specifies requirements or objectives (for example, “require 50 Mbps downlink and 10 Mbps uplink for video stream, with latency under 30 ms, for the next 120 seconds”) rather than low-level network parameters. The intent may include context like the type of service (video, voice, AR, etc.), priority level from the user's perspective, and the anticipated duration or scope of the need.

Network-Side Negotiation & AI-Based Decision: The network receives the intent message at an Intent-aware QoS Negotiation Function (IQNF)-this can be a new functional entity or an enhancement of an existing one (such as part of the PCF or a dedicated network application function). The IQNF acts as the counterparty in the negotiation on behalf of the operator's network. Upon receiving the request, the IQNF evaluates it using several inputs: current network conditions (e.g., cell load, backhaul capacity, slice resource availability), the subscriber's profile and privileges (ensuring the user is authorized for QoS boosts, in one embodiment tied to a subscription tier or dynamic policy), and predictive analytics (potentially via AI/ML algorithms) to foresee the impact of granting the request. The network's AI can consider historical data and real-time telemetry-for instance, consulting a NWDAF for predicted congestion or using a trained model to decide if the requested micro-SLA can be accommodated without harming other users'experience. If the request is feasible, the network then determines the specific QoS parameters and resources it can allocate to fulfill the intent. This essentially translates the high-level intent into a concrete micro-SLA offer. For example, the network might respond: “Approved: 50 Mbps guaranteed downlink, 15 ms target latency, for duration 120 s on flow ID X.” In cases where the full request cannot be granted, the network might negotiate a reduced offer (e.g., a lesser bandwidth or shorter duration) or deny the request, possibly suggesting a reason (or the UE can infer it if no upgrade occurs).

Micro-SLA Establishment: Once the network agrees (fully or partially) to the requested QoS boost, a micro-SLA is established. In practical terms, this means the network updates its QoS enforcement for the specific flow or service identified by the UE. This could involve several actions within the peer to peer context, for example, different UEs may be assigned micro-SLAs for direct communication. In a 5G context, a micro-SLA could involve the following: the PCF installs a new policy rule for the UE's session, the SMF sets up or modifies a QoS Flow with the requested characteristics (e.g., switching from a non-guaranteed bit rate to a guaranteed bit rate flow for that traffic, adjusting the 5QI (5G QoS Identifier) to one with a higher priority/low latency, or assigning a specific dynamic QoS profile), and the RAN (gNodeB) is informed of the changed priorities (ensuring scheduling and radio bearers reflect the new QoS). If network slicing is utilized, the network might even move the UE's traffic to a specialized slice (for example, a slice that has more bandwidth or lower latency) for the duration of the micro-SLA. The micro-SLA is characterized by its limited temporal scope and specific performance targets, in contrast to a regular SLA which might be broad and long-term. For every accepted intent the network writes an explicit validity field into the temporary policy object—either an absolute expiry timestamp or a duration counter—so the guarantee self-terminates without additional signalling at the end of the window (typically 5 s-10 min). Optionally, the same object may include resource envelopes such as (i) per-direction Guaranteed Bit-Rate ceilings, (ii) a latency budget, and/or (iii) a maximum data-volume cap, any of which can serve as an independent termination trigger once exceeded. Thus time, bandwidth, latency and—where configured—byte count jointly fence the scope of the micro-SLA, ensuring that elevated treatment is strictly transient and cannot persist beyond the contractual bounds. The micro-SLA effectively “boosts” the UE's service quality temporarily. Micro-SLAs assigned to the UE may have different temporal scopes.

Enforcement and Monitoring: During the micro-SLA period, the network continuously enforces the agreed QoS parameters. The UE's agent and the network's controller may also monitor the experience to ensure the intent is being met. If conditions change (say, the cell suddenly becomes congested or the user moves to a poor coverage area), the network's controller can use its AI logic to adapt—it might adjust some parameters, inform the UE of changes, or in extreme cases, revoke the micro-SLA if it can no longer be sustained (optionally, with an apology or reason code). Similarly, depending on P2P metrics, micro-SLA may be adjusted. If real-time analytics indicate that continuing the micro-SLA would jeopardise overall cell performance, the Intent-Aware QoS Controller issues a Revocation-Warning message carrying the active sla_id, the revocation cause code (e.g., network-congestion, mobility-out-of-range), and a grace interval (default two seconds). Upon receiving this notice the UE acknowledges and may immediately down-shift codec rate or buffer depth. At the expiry of the grace interval the controller expunges the temporary policy rule, instructs the SMF to remove the dedicated QoS flow, and sends a Revocation-Complete confirmatory message; the UE thereafter reverts to baseline QoS. The revocation cause is logged locally by the UE's agent and fed into its intent-generation heuristics—thereby discouraging similar high-demand requests under comparable radio or congestion conditions—while the network's analytics module records the event for future admission-control tuning. The agent on the UE can also be monitoring application performance; if the needed quality is achieved earlier than expected or no longer required (e.g., user stops the high-quality video early), the UE can early-terminate the micro-SLA by sending a cancellation intent, allowing the network to release resources sooner.

Micro-SLA Termination: Once the duration expires or the application's high-QoS phase ends (irrespective of whether the micro-SLA is directed to P2P or not), the micro-SLA is terminated. The network automatically reverts the UE's QoS handling to its default state (the baseline service). This could mean tearing down the dedicated QoS flow or reverting to a lower priority 5QI. The termination can be initiated by the network (via a timer or completion of data volume) or by the UE (explicit message indicating completion). The framework ensures a graceful downgrade so that there is no abrupt loss of connectivity—ideally, the transition out of the micro-SLA maintains service continuity albeit at normal QoS levels. Records of the micro-SLA (e.g., duration, data transferred, quality metrics) can be logged by the network for billing or analytics.

This high-level method enables something fundamentally new: applications actively collaborating with the network to get the right QoS at the right time. The novel features and advantages of the application include:
Intent-Based Communication: The UE's request is based on what the application needs, not on guesswork by the network. By conveying rich context (such as service type and importance), the agent allows the network's decision to be more informed. This is a shift from implicit QoS (where network infers needs via traffic heuristics) to explicit QoS negotiation. It aligns with the emerging paradigm of intent-driven networking, but applies it in a unique UE-to-network scenario.
Micro-SLA Concept: The application formalizes the idea of a micro-scale SLA that is ad hoc and ephemeral. Unlike traditional SLAs or quality guarantees, which are static commitments, a micro-SLA per the application is dynamically instantiated and terminated. This ensures that enhanced QoS is provided only when necessary, minimizing resource wastage. For example, if a user needs high throughput for a 1 GB file download, the micro-SLA might last just a minute to allow that download at top speed, after which it ends—the user doesn't consume high network resources all the time, only for that needed interval.

In another example, a micro-SLA may be instantiated or terminated based on P2P metrics derived from core network components or from the UEs directly.
Adaptive AI-Controlled Network Response: The network side controller can leverage artificial intelligence and policy rules to make real-time decisions on QoS requests. It can balance the requesting user's needs with network-wide performance. If multiple UEs request micro-SLAs simultaneously, the controller can prioritize based on policies (such as subscription priority or the nature of the intents) and optimize global resource allocation. This adaptive decision-making ensures that the application's framework can be deployed in complex, loaded network scenarios without compromising fairness or stability.
Seamless Integration with 5G Core and Evolution to 6G: The application is designed to work within the framework of existing mobile core networks. An implementation in a 5G system might utilize an Application Function (AF) co-located with the operator's network that communicates with PCF/SMF via standard APIs (using the NEF as needed) to install the micro-SLA policies—effectively making the UE's agent an authorized client of the policy control system. Alternatively, a proprietary signal could be introduced between UE and gNodeB/AMF to carry the intent (for instance, a Non-Access Stratum message or an extension of the RRC signaling), which the network then translates at the core level. These approaches mean that current 5G networks can adopt the application with software updates and minor standard extensions, maintaining backward compatibility. Looking forward, 6G architectures could incorporate a dedicated intent signaling plane or enhanced control channels to natively support this negotiation. The application explicitly covers and anticipates such evolutions, ensuring that the described framework can become an integral part of next-generation mobile networks.
Support for Heterogeneous and Non-Terrestrial Networks: The negotiation framework is access-agnostic. It can be used over traditional cellular links (macro cells, small cells) as well as non-terrestrial networks (NTN) like satellite links or high-altitude platform systems that are integrated into 5G/6G. For example, if a UE has dual connectivity to a 5G terrestrial network and a LEO satellite, the agent could negotiate a micro-SLA specifically when the satellite is overhead to exploit a high-capacity downlink for a bursty transfer. The network controller, understanding the limited-time availability of that satellite connectivity, can grant a micro-SLA knowing that additional spectrum is temporarily at hand. This flexibility addresses scenarios where connectivity quality can vary greatly with time and environment. When the non-terrestrial link is nearing loss of visibility, the framework treats the event as a deterministic context change and executes an automatic make-before-break routine. The NTN gateway or associated control node periodically emits a “link-remaining-time” indicator (or, in 3GPP NTN terminology, a Service Availability Report) that gives the Intent-Aware QoS Controller advance knowledge—typically tens of seconds—of the pending outage. If the micro-SLA's expiry time extends beyond the advertised window, the controller (i) attempts to migrate the guarantee to an available terrestrial or alternate NTN access by issuing a pre-handover SLA-Adjust message that preserves the original QoS envelope, or (ii) where equivalent resources are not obtainable, transmits a Revocation-Warning specifying the residual satellite window and, if appropriate, a reduced but still-useful QoS profile. The UE acknowledges, throttles or buffers its traffic accordingly, and—should a terrestrial bearer be configured—seamlessly redirects the flow when the controller finalises the path switch. Consequently, data delivery either completes under an adjusted contract or downgrades gracefully to baseline service before the satellite fully departs the coverage footprint, preventing abrupt session failure while freeing spectrum for subsequent passes.
Use Case Versatility: The application benefits numerous use cases. Some examples include: (a) Ultra-HD Streaming and Cloud Gaming—a user's device requests high throughput and low latency when a streaming session starts, ensuring initial buffering is fast and interactivity is smooth; (b) Augmented/Virtual Reality—an AR headset signals its need for extremely low latency and reliable throughput during a specific task (like remote assistance or an industrial operation), and the network responds by prioritizing that device's traffic on the RAN and core for that duration; (c) Emergency or Mission-Critical Uplink—a vehicle or drone might negotiate a micro-SLA to upload sensor data or live video to the cloud when a critical event is detected, guaranteeing that the data gets through quickly even if the network is congested; (d) Scheduled Bulk Sync—a smartphone might defer a large cloud backup until it has a good opportunity (like the user entering a 5G mmWave zone or a satellite pass), then negotiate a micro-SLA to utilize the sudden boost in available bandwidth to complete the backup swiftly; (e) Enterprise and Slice Augmentation—even within a network slice that generally provides a certain QoS, a particular user or app could briefly raise its slice's parameters via this negotiation (with the slice controller acting as or interfacing with the IQNF). The application thus serves both consumer and industrial applications, improving Quality of Experience (QoE) and enabling new services. For bidirectional AR/VR or holographic-telepresence sessions, the framework allows each endpoint to embed a shared session-hash (e.g., SHA-256 of the SDP fingerprint) in its IntentRequest. When the Intent-Aware QoS Controller detects two or more concurrent intents that carry an identical session-hash—and that specify complementary traffic directions—it automatically instantiates a paired micro-SLA object. The paired contract allocates symmetric uplink and downlink guarantees, aligns latency budgets, and enforces a common expiry so that both legs of the call experience balanced quality. Any subsequent intent from either party that references the same session-hash is evaluated as a refinement of the paired SLA rather than as an independent demand, thereby simplifying admission control and preventing duplex-session starvation. If network resources later become constrained, the controller downgrades or revokes the two legs atomically, preserving conversational integrity and avoiding one-sided video interruption.

Distinctness from Prior Art: As detailed in the background, no existing solution provides this combination of UE-driven intent signaling, AI-assisted network negotiation, and micro-SLA enforcement. For example, unlike the device in US2024/0163734 which monitors QoS passively, the present application's UE agent actively requests QoS improvements and shapes the outcome. And unlike NWDAF-based suggestions that are broad and automated, here the network responds to a specific user's request, making it a two-way negotiation. This interactive paradigm is unique and forms the crux of the application's novelty.

The application encompasses various embodiments and configurations. In some embodiments, the UE's intelligent agent could be a part of the device's operating system or modem firmware, acting on behalf of multiple applications. In others, each application might include its own agent module that communicates with a central agent manager on the device. The communication between the UE and network controller for intents could use existing signaling channels (augmented with new Information Elements for intent data) or a new protocol atop user-plane or control-plane channels. The protocol is a lightweight Intent-Signalling Protocol (ISP-1) that re-uses existing transports—HTTP/2 over TLS in the user plane or a compact NAS extension in the control plane—while introducing five mandatory fields: msg-type, app-id, flow-filter, requested-QoS (GBR, latency, priority), and a subscriber-signed policy-token that authenticates the request. A successful response returns an sla-id UUID for subsequent updates; failures are conveyed with standard HTTP or NAS cause codes, allowing legacy nodes to ignore the extension without impact. Typical message size is <200 bytes, so no new bearer or keep-alive procedures are required. Security and authentication are also considered: the network must verify that the requesting agent is legitimate (to prevent abuse such as unauthorized QoS requests). This could be achieved by cryptographic tokens or by tying the feature to subscribers who have this capability enabled.

The application can be expressed as a method, a UE device with specific functionalities, a network-side system or node enabling the negotiation, and a comprehensive system of UE plus network working together. All such expressions, including any computer-readable medium carrying program instructions to implement the agent or controller logic, are intended to be within the scope of this patent. The subsequent detailed description and claims delineate these aspects.

In summary, the Adaptive Agent-to-Network QoS Negotiation via Intent-Aware Micro-SLA Framework introduces a dynamic, intelligent way to optimize network resource usage and user experience by aligning them in real time. It transforms the traditionally static QoS provisioning model into an interactive, adaptive service where the network can truly hear what applications intend to do and adjust accordingly, to the benefit of both users and the network operator.

In embodiments, the adaptive QoS negotiation framework is shown with reference to the accompanying drawings. The drawings and examples are intended to illustrate the principles of the application, and it will be understood that numerous variations and modifications can be made without departing from the spirit or scope of the application as set forth in the claims. Wherever appropriate, the same reference numbers are used in different figures to denote the same or similar elements for consistency and clarity.

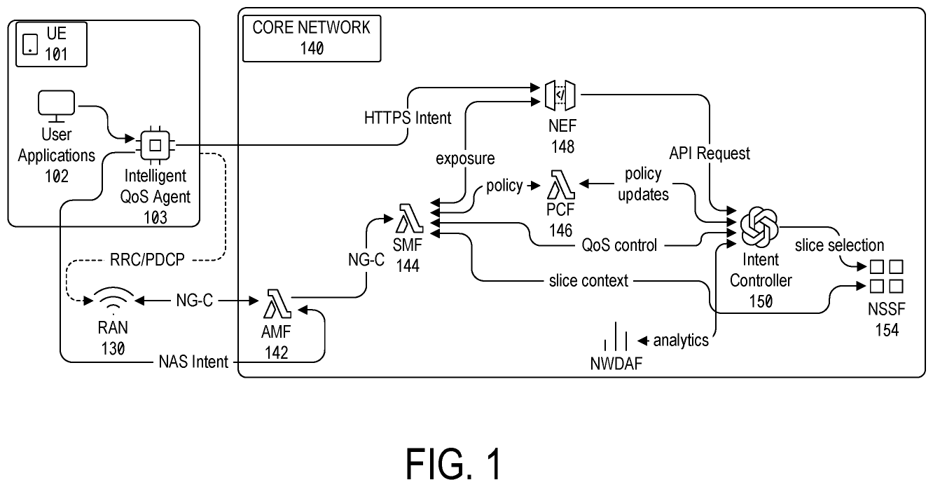

FIG. 1 is a block diagram illustrating an overall architecture of a mobile network system implementing the adaptive intent-aware QoS negotiation framework. It depicts a user equipment (UE) 101 with an embedded intelligent agent 103 communicating over a 5G/6G radio access network (RAN) 130 to a core network 140 that includes an intent-based QoS negotiation controller 150 in addition to standard core functions (AMF, SMF, PCF, etc.).

Referring to FIG. 1, the architecture of a communication system implementing the application is shown. A user equipment (UE) 101 is depicted, which may be any device capable of wireless connectivity in a 5G or 6G network (such as a smartphone, tablet, wearable device, IoT module, vehicle-mounted device, etc.). The UE 101 includes one or more user applications 102 that generate traffic and have certain performance needs. Examples of applications 102 include a streaming video client, a VoIP/videoconferencing app, a gaming app, an AR/VR application, a file synchronization service, among others. In line with the application, the UE 101 is equipped with an Intelligent QoS Agent 103 (also simply referred to as “agent” for brevity). This agent 103 can be implemented in software (running on the device's processor) and possibly with support from lower-level firmware (in the modem or OS network stack) to interface with the network.

The UE 101 communicates with the Radio Access Network (RAN) 130. In a 5G context, the RAN 130 would typically be a gNodeB (next-generation NodeB) base station that provides the air interface and connects to the 5G Core Network. In FIG. 1, RAN node 130 is shown linking the UE to the operator's core network 140 via standard interfaces (NG interface in 5G). It is within the RAN 130 that initial radio resource scheduling happens; the RAN thus plays a role in enforcing QoS (through mechanisms like configuring dedicated bearers or QoS flows, and scheduling priorities).

The Core Network 140 in FIG. 1 encompasses the necessary control-plane and user-plane functions. Illustrated within core 140 are standard 5G control functions: an Access and Mobility Management Function (AMF) 142 that manages UE registration, connection, and mobility; a Session Management Function (SMF) 144 that manages PDU sessions (IP sessions) and configures user-plane paths and QoS rules; and a Policy Control Function (PCF) 146 which makes policy decisions, including authorization of QoS and slicing for sessions, based on subscriber data, operator policies, and network context. These components interact as per 5G specifications for normal operation. For instance, when a UE establishes a data session, the SMF 144 may consult the PCF 146 to obtain authorized QoS parameters (such as permitted 5QI values, maximum bitrates, etc.), and the AMF 142 signals the RAN 130 to set up corresponding radio bearers.

Crucially, the architecture in FIG. 1 introduces an Intent-Based QoS Negotiation Controller 150 as a functional element of the core network 140. This controller 150 is responsible for handling the new intent-aware negotiation and micro-SLA management that the application provides. In different deployment scenarios, controller 150 could be realized in different ways:

It could be a new standalone network function (NF) in a 5G core, interfacing with the PCF 146 and possibly the NWDAF or other analytics engines. As a standalone NF, it might be accessed via an API or service interface by UEs or AFs.

It could be integrated as an enhancement to the PCF 146 itself. Since the PCF already decides on QoS policy, adding intent interpretation and negotiation logic to it is logical. In this case, controller 150 would represent the augmented capabilities of PCF 146.

It might also be partially distributed: e.g., some logic in the edge (at the gNodeB or a distributed unit) for quicker response on RAN decisions, with other logic in the core for policy consistency.

For conceptual clarity, FIG. 1 shows it as a distinct block 150 that communicates with other functions. The controller 150 contains sub-components, such as an interface to receive intents from the UE's agent, an AI-driven decision module, and linkages to the PCF/SMF to enact QoS changes.

The communication between the UE 101 and the intent controller 150 can occur via multiple pathways. One straightforward approach is using the existing control signaling path: the UE could send a Non-Access Stratum (NAS) message to the AMF 142 conveying the intent, which then forwards it (or triggers a call) to the controller 150. This would require defining a new NAS message type or extending an existing one (for example, an extension of the PDU Session Modification procedure). Another approach is using an application-layer signaling: the UE's agent 103 might open a secure connection (HTTPS/HTTP2 or similar) to a known network endpoint (which could be an API gateway to controller 150, possibly the NEF 148 if the NEF is considered as a secure exposure point). In that case, the intent message might travel over the user plane as data, into the core, and be routed to the controller 150. This second approach treats the problem similarly to how an external application function would request policy changes, but here the “external” AF is effectively running on the UE. In both cases, security and authentication are managed—the network will authenticate the UE and ensure it's authorized to request QoS changes (for instance, some users might not have the feature, or some intents might require additional charging or subscriptions).

Also shown in FIG. 1 is the Network Data Analytics Function (NWDAF) 152 and optionally a Network Slice Selection Function (NSSF) 154 to indicate that the application can leverage existing 5G infrastructure for analytics and slicing. The NWDAF 152 can provide analytics (like predicted load in a cell or slice) to the intent controller 150, aiding its decisions. The NSSF 154, which normally assists in selecting appropriate slices for a session, could be involved if the micro-SLA negotiation includes possibly moving the user to a different slice (or instantiating a slice on demand). For instance, if the UE's intent indicates a need that matches a URLLC-type slice (ultra-reliable low-latency communications), the controller 150 might request the NSSF 154 to switch the session to a URLLC slice for the duration (assuming the UE and network support that).

It's worth noting that not every deployment needs separate NWDAF or NSSF involvement—these are optional components to illustrate integration. A simpler deployment might handle everything within a single network node's intelligence.

In summary, FIG. 1 provides the context: the UE 101 with agent 103 on one side, and the mobile network core 140 with the negotiation controller 150 on the other, communicating over the existing wireless interface (via RAN 130). This forms the environment in which the subsequent processes occur.

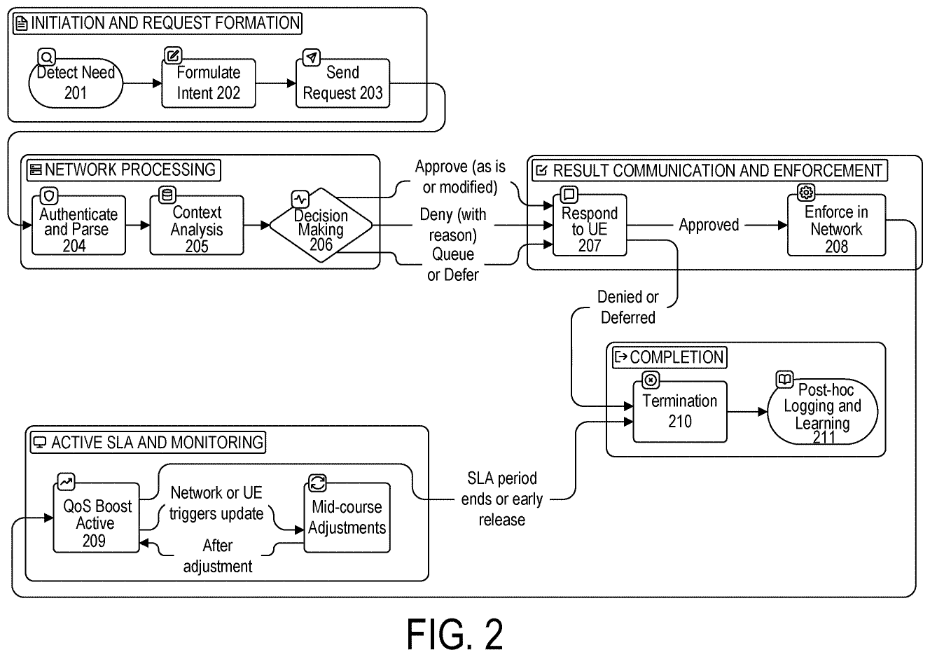

FIG. 2 is a flowchart showing an example process of negotiating and establishing a micro-SLA for QoS between the UE's agent and the network controller. The flowchart outlines steps such as application intent detection, request message formulation, network decision-making with possible AI analytics, QoS parameter adjustment, and micro-SLA termination.

FIG. 2 outlines the logical flow. Detect Need (Step 201): The process starts when the UE's agent detects a condition that may warrant improved QoS. This corresponds to the Application Monitor (301) and Decision logic (302) in the UE. For example, the user presses “Play” on a 4K video stream or the device switches to a high-quality video mode. The agent assesses that the current network policy (say, best-effort with no guarantee) might not sustain this smoothly, thus a need is flagged. Formulate Intent (Step 202): The agent composes an intent message capturing the requirement. Using the Intent Generator (303), it might fill in: Service=“Video/Streaming”, Required downlink>=20 Mbps, Latency=tolerant (e.g., 50 ms okay), Duration=5 minutes (video length). It also attaches context like which flow (could be identified by a QoS Flow ID or by a filter such as destination server IP/port if known). Send Request (Step 203): Through the Communication Interface (305) and potentially NAS/Networking layers, the UE transmits this request to the network.

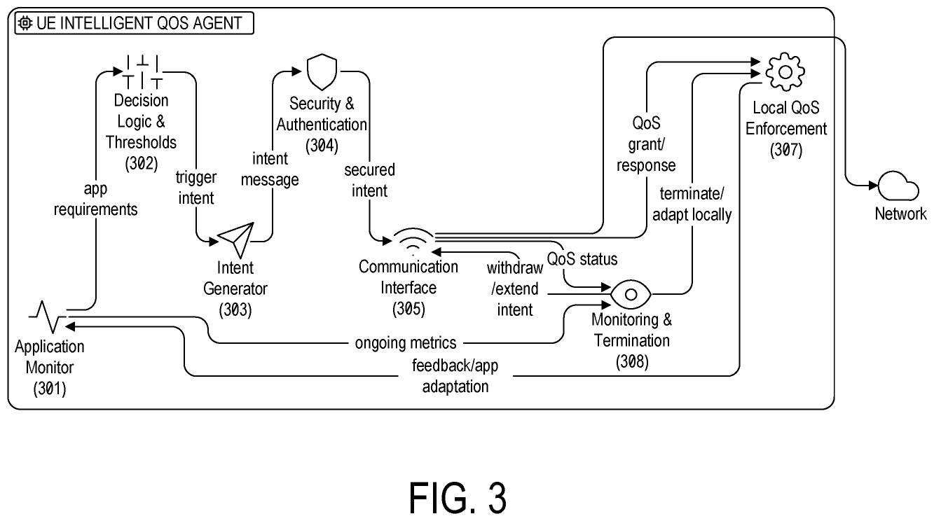

FIG. 3 is a schematic diagram of the internal components of the user equipment's intelligent QoS agent. It highlights sub-modules such as an Application Monitor (301) that gathers application requirements, an Intent Generator (303) that creates intent messages from those requirements, a Communication Interface (305) for signaling to the network, and a QoS Adaptation Controller (307) that interacts with the device's modem or OS to apply any local changes and measure performance.

The UE's intelligent agent 103 is a cornerstone of the application on the device side. FIG. 3 breaks down the components of this agent in one embodiment. As shown, the agent may comprise:
Application Monitor (301): This sub-component continuously or periodically monitors the UE's application layer to detect QoS-related events or requirements. It can use various signals—for example, it may intercept operating system intents/callbacks when a video starts playing or a large file transfer begins. It might also get direct hints from applications (if those apps are aware of this system; e.g., a game could call an API provided by the agent to notify it of an upcoming high-intensity period). The monitor might consider metrics like data rate demand, frame rates (for video/VR), buffer levels, user input patterns, etc. Essentially, it translates application context into a potential need for network resources. In one embodiment, the network delivers to the UE a carrier-signed priority profile, either during initial registration or via an authenticated over-the-air update—that maps each recognised application or service class to a default priority, optional guaranteed-bit-rate ceilings, and permitted 5QI values. The intelligent agent stores this profile locally and, when multiple applications simultaneously request QoS elevation, ranks their intents according to the profile before forwarding them to the network controller. Because the profile is cryptographically authenticated, only operator-authorised updates can affect on-device prioritisation, enabling dynamic traffic hierarchy without modification of individual applications.
Decision Logic & Thresholds (302): The agent doesn't necessarily send an intent for every minor change; there are thresholds and logic to decide when to trigger a negotiation. This block 302 contains configurable rules or even a local AI model that evaluates whether the current or upcoming application demand warrants a micro-SLA request. For example, if a user is watching 480p video and suddenly switches to 4K resolution, the agent might identify this as a trigger (the expected bandwidth requirement jumps significantly). Or if a user opens an enterprise VR meeting app, the agent knows that app usually needs low latency and high reliability, thus it should request it. Some thresholds might be user-defined or learned (the device could learn the typical bandwidth usage of certain apps and predict when a spike beyond normal usage occurs).
Intent Generator (303): Once the decision to request enhanced QoS is made, this component formulates the actual Intent Message. The message would include fields such as: Application ID or Flow ID (to identify what traffic the request pertains to—e.g., a specific PDU session or even a specific 5-tuple flow if needed), Desired QoS Parameters (which could be expressed in user terms like “high bandwidth” or numeric targets like throughput, latency, jitter, packet loss tolerance), Duration (how long the boost is needed, if known; some apps might say “approx 2 minutes” or some might say “until further notice but likely short”), Intent Type (possibly from a set of categories such as “video streaming”, “real-time control”, “bulk transfer”, etc., which helps the network understand the nature of the request), and Priority Level (if multiple intents from the same UE could exist or to indicate how critical this is—e.g., an emergency video call versus a background file sync). The message could be encoded in a JSON/XML if over HTTP, or in a compact binary TLV if via NAS/RRC. In any case, 303 ensures the message is standards-compliant for whatever interface is chosen.
Security & Authentication Module (304): Before sending the intent, the agent might attach security credentials. If using a NAS message, it will inherently be protected by the 5G NAS security (integrity and ciphering). If using an API (NEF/AF path), the agent likely uses an HTTPS request with proper authentication (in one embodiment using the device's subscriber identity, or a token provisioned by the network). Module 304 handles fetching and attaching such credentials, ensuring the request is trusted by the network. It may use, for instance, an OAuth token that the network issued during device registration.
Communication Interface (305): This handles the actual transmission of the request to the network. For a NAS-based approach, it interfaces with the device's lower-layer NAS implementation to send a custom message. For an HTTP-based approach, it opens a socket and sends the request data to the known server (which could be an IP address/URL stored in the device, possibly provided by the network during registration or via a broadcast parameter). In some designs, the communication might even occur at the IP layer to a special network address that the operator reserves for this QoS negotiation service. The operator conveys the endpoint in a controlled manner: during initial attach or subsequent configuration-update, the Access and Mobility Management Function (AMF) includes an Intent-API-Endpoint information element—typically a fully qualified domain name such as intent.mnc XXX.mcc YYY.3gppnetwork.org. That FQDN is resolvable only inside the operator's private DNS realm and translates to one or more RFC 1918 IP addresses reachable solely from subscriber address space. Because the mapping is withheld from public DNS and is distributed exclusively over NAS or secured device-management channels (e.g., OMA-DM), neither external third parties nor un-authenticated devices obtain the address; consequently, only authorised UEs can originate QoS-negotiation traffic, and the operator retains full control over exposure of the service.
Local QoS Enforcement Hooks (307): Interestingly, the agent can also prepare the device for the QoS change. On modern devices, there might be APIs to adjust how aggressive the device is in using bandwidth (for example, a video app could temporarily disable some rate limiting if it knows the network gave it more capacity). The agent might instruct the application to adjust its bitrates, or inform the OS to prioritize the traffic of that app. If the network grants the micro-SLA, the agent receives a response (via Comm Interface 305) detailing what was granted (e.g., “you have 50 Mbps downlink for this flow”). The agent can then feed this back to the application (if the app is able to adapt its behavior based on network feedback-not all apps can, but for instance a streaming client could decide to increase video quality knowing it has a guaranteed pipe for now). These feedback and local enforcement loops amplify the benefit of the network's QoS change by aligning the app's behavior with it.
Monitoring & Termination (308): After sending the request, the agent 103 doesn't go idle. This component 308 monitors the ongoing session. It checks if the desired QoS is achieved (maybe reading metrics like actual throughput or latency—many devices have quality measurement APIs). It also listens for a termination condition—in one embodiment a timer if the agent itself set one for the expected duration, or a message from the application that the heavy phase is over, or a user action like closing the app. If the condition for ending the micro-SLA is met on the UE side (before the negotiated time), the agent can send an Intent Withdrawal or Micro-SLA Release message to the network to conclude the contract early. Conversely, if the network signals that it must end the micro-SLA (due to unforeseen issues or end of allocated time), the agent receives that and informs the application or at least stops expecting elevated QoS. Monitoring also helps in possibly extending a micro-SLA: if the time is nearly up but the user clearly still needs high QoS (e.g., the user is still on the VR call beyond the originally estimated duration), the agent could automatically send a follow-up request to extend the micro-SLA.

In embodiments, it may be that a condition for ending a micro-SLA of a peer device in a P2P environment is met and so the P2P environment may change, e.g. a micro-SLA may be adapted for both peers or a group of peers given the change.

This detailed breakdown in FIG. 3 shows that the UE's agent is not merely a dumb transmitter of requests; it embodies intelligence to decide when to request, what to request, and how to adapt both the request and the application's behavior based on outcomes. Implementations can vary: a lightweight version of the agent might rely more on the application to tell it when to request and might not do heavy monitoring, whereas an advanced version (especially if baked into the OS) can do sophisticated pattern recognition (in one embodiment using machine learning on the device to predict when the user is about to need high QoS—e.g., based on past habits or app usage sequences).

One emphasis is that all this must be done efficiently and securely on the UE, without overly draining device resources. The agent could be event-driven (waking up only when needed) and leverage hardware support for monitoring (like modem statistics). It also should have the ability to rate-limit requests—for example, not spamming the network with too frequent intents. Policies can be in place (some possibly by the network's instruction) like “at most one intent request per minute” or “if denied, wait a while before retrying”, to ensure stability.

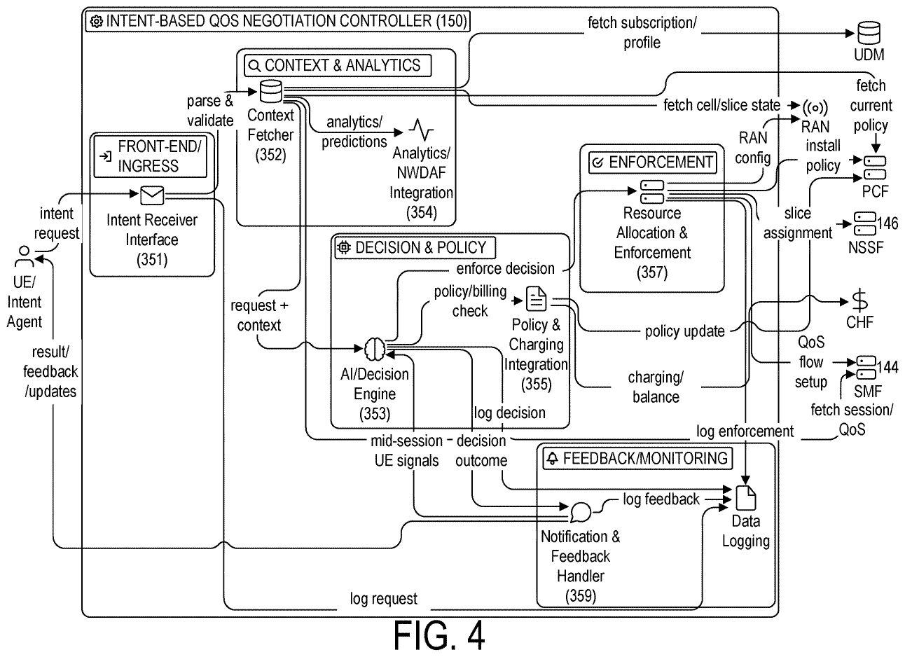

FIG. 4 is a schematic diagram of the internal architecture of the network-side intent-based QoS negotiation controller (150). This diagram includes components such as an Intent Receiver module (351) for handling incoming UE requests, an AI Engine (353) and Policy/Charging integration module (355) that evaluate requests against network analytics and policies, a Resource Manager (357) that coordinates with core network functions (like PCF/SMF) to enforce decisions, and a Monitoring/Feedback module (359) that tracks the ongoing micro-SLA performance.

On the network side, FIG. 4 illustrates the internal modules of the Intent-Based QoS Negotiation Controller 150, which is the functional entity handling the core intelligence of the framework within the operator's infrastructure.

Components in FIG. 4 include:
Intent Receiver Interface (351): This front-end handles incoming intent messages from UEs. It could be a server process listening on an API endpoint (for HTTP/JSON based communication) or a handler within the AMF/PCF if using control-plane signaling. The receiver authenticates the message (checking the credentials/tokens via possibly the network's subscriber database or AAA functions) and parses the intent data. It then creates an internal representation of the request, including the identity of the requesting UE, the targeted flow or application, and the requested QoS improvements. If certain requests are malformed or the UE is not authorized (e.g., a user on a basic plan tries to request premium QoS which they shouldn't), the receiver can reject them outright according to operator policy.
Context Fetcher (352): Before a decision is made, the controller gathers relevant context. Module 352 interacts with other network functions to retrieve information such as the UE's subscription profile from the Unified Data Management (UDM) or policy repository (e.g., “is this user allowed Gold-level QoS?”), current QoS settings of the UE's sessions from SMF/PCF (“what is he getting now?”), and in one embodiment the current network state from analytics (“how congested is cell X?”). If the request pertains to a specific cell or slice, it might query the RAN for current load or the NWDAF 152 for predictions. It may also consider how many other micro-SLAs are active in that cell or for that user. This context forms the input for decision-making.
AI/Decision Engine (353): This is the brain of the controller. It can use rule-based logic, machine learning models, or a combination to decide on the request. In one embodiment, the AI/Decision Engine (353) subscribes to a cloud-resident Policy-Rule Repository exposed by the operator through a service-based interface. Each rule is expressed in JSON using a deterministic grammar—conditions (cell-load, slice-quota, subscriber-tier, radio technology) and actions (grant, cap, deny, counter-offer). The operator pushes rule updates via a signed REST PUT/policy-rules/{version} call; upon reception the engine performs a digest check, activates the new version atomically, and acknowledges with 200 OK. This mechanism allows real-time tuning—e.g., inserting a festival-specific congestion cap—without upgrading UE software or restarting the controller, thereby ensuring that business policy changes propagate immediately into admission decisions. Some example logic:
Policy Rules: The operator might set rules like “Do not grant more than 100 Mbps to any user in cell if cell load>80%” or “VIP users (or specific application categories) get priority in contention”. These are checked first to eliminate requests that violate hard rules.
Policy Rules: The operator might set specific rules for sidelink/D2D communication like “Do not assign more than 10 Mbps to a group of UEs within these three base stations” or “only micro-SLA users may be assigned resources north of 10 Mbps”. These are checked first to eliminate requests that violate hard rules.
Resource Availability Check: The engine checks if the requested resources are available. For example, if the UE asks for 50 Mbps downlink guaranteed and currently the cell has only 30 Mbps free capacity, the engine might decide to deny or offer less. If slicing is in use, it checks slice quotas.
AI Prediction: If using ML, the engine might have a predictive model (e.g., a trained neural network or decision tree) that given the current state and the request, outputs a decision or a score (like how beneficial or risky granting it is). The model might be trained on historical data to maximize overall satisfaction or network utilization.
Multi-Request Coordination: The engine also looks at other concurrent intent requests. Suppose two UEs in the same sector request high throughput micro-SLAs at once. The engine might approve both but at slightly reduced levels, or approve one fully and queue the other for a few seconds later (maybe staggering them). It might use a fairness algorithm or priority queue for this. To prevent a single device from saturating control bandwidth, the controller applies a leaky-bucket limiter keyed to each UE's IMSI: capacity three intents, leak rate one intent every five seconds; excess requests receive a 429 Too-Many-Intents(retryAfter=t) response and are silently dropped. The UE learns allowable ranges in advance because, during registration, the network delivers a carrier-signed Intent-Capability Descriptor that lists authorised service classes, maximum GBR, and admissible 5QI values. The UE's agent caches this descriptor and suppresses any local intent that would fall outside the enumerated bounds, thereby aligning on-device behaviour with network policy while keeping request traffic within manageable limits even when multiple concurrent flows originate from the same handset.
Determining QoS Parameters: If it decides to grant, the engine calculates the exact QoS parameters to assign. Perhaps the UE asked for 50 Mbps, but the network decides 40 Mbps is safer—it will grant 40. Or the user asked for unspecified “better latency”, the network might choose to move them to a low-latency scheduling algorithm and perhaps shorten the RAN TTI or enable URLLC configurations if applicable. All these specifics are determined here.
Duration: The engine may also decide on the duration of the micro-SLA if the request was open-ended or if network policy imposes a cap (e.g., “grant for up to 60 seconds, then reevaluate”).

This engine 353 essentially produces a decision: either Reject, Accept as requested, or Accept with modifications. Modifications can be in terms of level of QoS or duration.
Policy & Charging Integration (355): Because QoS changes can have implications on policy control and even billing, module 355 ensures the decision aligns with those systems. If the user's plan requires charging for QoS boosts (some operators might treat this as a premium add-on or count it as extra data), this module would interface with the charging system (CHF in 5G) to record usage or to check balance (for example, “does user have QoS tokens available?”). Policy integration also means updating the PCF's view: this module might create a temporary policy rule that the PCF 146 then enforces. In one design, module 355 could literally be part of PCF, implementing the Npcf_PolicyAuthorization service endpoints that an AF (the agent effectively acting as an AF) would use. So it could map the intent into a Policy Authorization request internally.
Resource Allocation & Enforcement (357): Once a positive decision is made, this component carries out the necessary actions in the network to enforce the micro-SLA. It interacts with:
The PCF/SMF: For example, instruct SMF 144 to establish a new QoS Flow with specified parameters for the UE's PDU session. This could involve sending a Network-Initiated QoS Flow Establishment message. The SMF would then send the appropriate messages to the RAN (gNodeB) to set up a corresponding Data Radio Bearer with the desired priority/GBR, and to the UPF to apply any rate limits or specific treatment.
The RAN (if direct control is possible): In some advanced scenarios, the controller 150 might directly send RAN configuration (especially in a 6G context where slicing and resource allocation might be more dynamic). In 5G, typically PCF/SMF indirectly influence RAN via QoS policies.
Slicing mechanisms: If a slice change is needed, it coordinates with NSSF 154 to reassign the UE's session to a slice with different characteristics or to instantiate a slice sub-net for the application. This might be done by interacting with slice management functions or orchestrators.

It also sets an internal timer for the micro-SLA duration. If using PCF rules, it could include a validity time for the policy.
Notification & Feedback Handler (359): The controller doesn't operate in a vacuum-it communicates the outcome. If the request is approved (or modified), it sends a response back to the UE's agent via the Intent Receiver interface (which acts as a two-way interface). For example, an HTTP 200 OK with a response JSON might indicate the granted QoS and duration. If the request is denied, a response (in one embodiment with a reason code like “network busy” or “not authorized”) is sent so the agent can handle it (maybe the agent will not bother the user or will retry later). During the micro-SLA, this module might also provide feedback: for instance, if halfway through the micro-SLA, network conditions worsen, the controller could send an Intent Update or Warning to the UE agent: “We might not meet the requested latency due to new load.” Such feedback could be used by the UE to adapt (maybe lower its demands proactively).

Additionally, 359 listens for any messages from the UE that may come during the micro-SLA—e.g., if the UE says “I'm done early” (intent withdrawal) or requests an extension. It will funnel those to the Decision Engine 353 for further action.

Finally, when the micro-SLA expires, 359 may optionally send a brief notification to the UE (“micro-SLA ended”) if the UE wouldn't otherwise know (though if a time was given, the UE might already know when it ends).
Interaction with NWDAF/Analytics (354) and Data Logging: Not explicitly numbered in the figure description but implied, the controller can incorporate external analytics. It may subscribe to NWDAF events (like “alert me if cell load>X”), enhancing its responsiveness. Also, every negotiation event (request, grant, outcome) can be logged for training future AI models or for operator review. The data might include what intent was requested and whether it was successful-over time, this can allow the operator to refine policies or even for the AI to improve its predictions (reinforcement learning could be used where the “reward” is something like improved total throughput or user QoE scores).

The network controller is essentially the arbiter that weighs the demand against the capability and policy. It is novel in that it's taking input from individual users in real time rather than just following static rules. One skilled in the art will recognize that implementing such a controller can leverage existing components: for instance, much of the heavy lifting can be done by extending a Policy Control Function (PCF) and tying it with an analytics module (NWDAF). In fact, 3GPP PCF has a service called Policy Authorization where an AF can request a certain QoS for a flow and the PCF decides whether to allow it—the application parallels that concept but with the AF being in/on the UE and the policies being dynamic micro-SLAs. Thus, an implementation may reuse the AF/PCF model: treat the UE agent as an AF that communicates an “AF request” to PCF for QoS resources, and PCF (with NWDAF input) decides and installs policies. This would be a standards-aligned way to implement it with minimal changes (just need to allow the UE to host the AF client and ensure security).

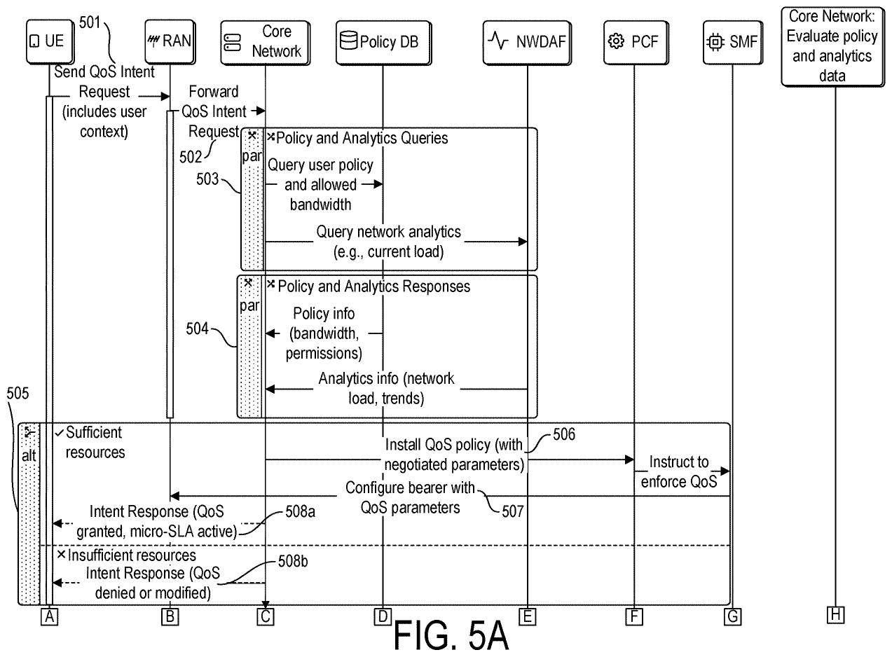

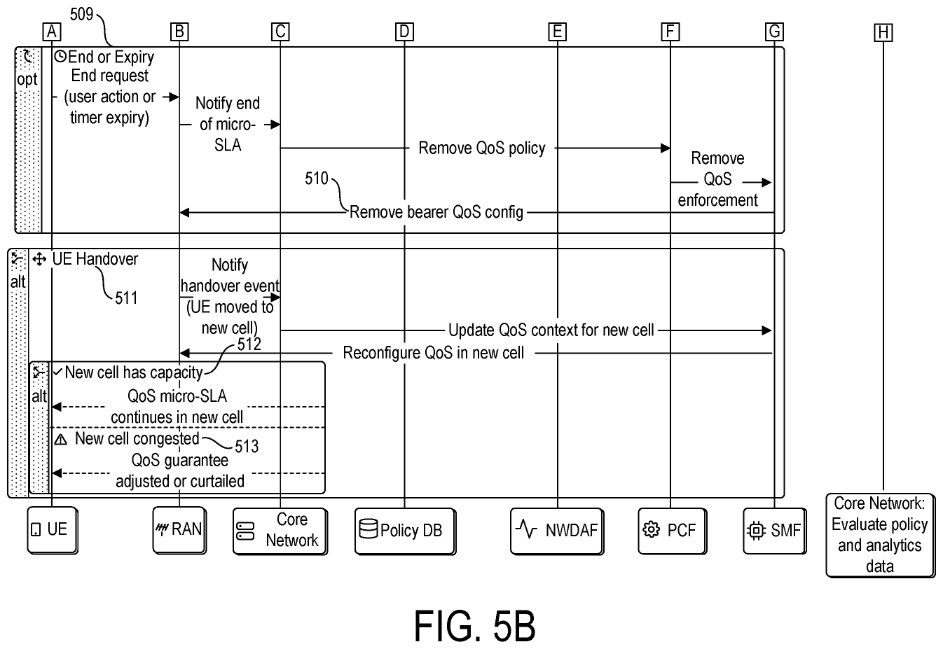

FIG. 5 is a sequence diagram (message flow) illustrating the communication exchanges between the UE, RAN, and core network during an intent-based QoS negotiation. It shows, step by step, messages such as the UE's QoS Intent Request, the network's acknowledgment or query to policy/analytics functions, the network's QoS Negotiation Response (approval/modification), and the subsequent configuration messages (e.g., PCF to SMF to RAN instructions) that implement the micro-SLA. FIG. 5 captures the temporal order of signaling events in one embodiment of the protocol.

In FIG. 5, this is shown as message (1) QoS_Intent_Request from UE 101 to the network controller 150 (via the RAN 130 and core transit). If it's via the core, the AMF 142 might relay it to PCF/Controller 150. If via an API, it goes through UPF to NEF to controller etc. The key is that the content of the request is delivered intact to the controller 150.
Authenticate & Parse (Step 204): The network controller receives the request at the Intent Receiver 351. It authenticates (ensuring the UE is who it says it is and allowed to make requests) and parses the request data to extract all relevant fields. If the request is not well—formed or violates a basic policy (e.g., unrecognized app ID or user not subscribed to any QoS negotiation feature), the controller can decide an immediate rejection at this stage. Assuming it passes, the process moves on.
Context Analysis (Step 205): The controller fetches current context via Context Fetcher 352. In FIG. 5, one can imagine messages like (2) Policy_Query from controller 150 to PCF 146 or UDM, asking “what is user 101's allowed QoS normally?” and (3) Network_Status_Check perhaps to NWDAF 152 or RAN 130, asking “what's the current cell load or predicted throughput availability?”. The controller aggregates information such as: current data rate of UE, other micro-SLAs in progress in that cell, user's priority tier, etc.
Decision Making (Step 206): Now the AI/Decision engine 353 applies its logic. Based on context: Case A: The network is relatively free, user is premium-likely to approve full request. Case B: Network is moderately loaded, user is regular—in one embodiment approve but slightly cap or shorten duration (like “can do 15 Mbps, not 20, for next 3 minutes”). Case C: Network is heavily loaded or the request is extremely high (e.g., user wants 100 Mbps but only 10 available)—likely to deny, or if possible, queue it (maybe respond “wait 30 seconds” or “denied due to busy”). Case D: Not authorized—e.g., user doesn't have any QoS privileges—then denial with a specific cause.

Suppose the network finds it can grant the video enough bandwidth (because cell utilization is 50% and some capacity can be allocated). The engine decides: Grant 20 Mbps guaranteed, use 5QI=7 (video QoS with low packet loss) for this flow, for 5 minutes. It also notes an end time.
Respond to UE (Step 207): The controller sends a response back to the UE with the decision. In FIG. 5, message (7) QoS_Intent_Response goes from controller 150 to UE 101. If approved, it contains details of what's granted. If modified, it states the modifications. If denied, it says denied (optionally with a reason like a numeric code). Let's say the case is approved as requested.

Enforce in Network (Step 208): Almost in parallel with step 7, the controller triggers enforcement actions. FIG. 5 shows internal messages like (5) Apply_QoS_Rule from controller 150 to PCF 146 or directly to SMF 144. This could be an invocation like: create a policy rule for UE 101's session with flow filter=video server's IP, and set QoS=20 Mbps guaranteed, priority X, etc. The SMF then executes this: it installs the QoS rule in the user plane (UPF) and sends an RAN Notification (via AMF or direct) to gNodeB to allocate a corresponding bearer. This is indicated by message (6) RAN_Config_Update in FIG. 5 to RAN 130. At this point, the network has reserved or earmarked the needed resources for that user. For example, the gNodeB may create a new MAC scheduler queue for the UE with a guaranteed rate, and the UPF may ensure at least 20 Mbps is delivered from the data network interface.
QoS Boost Active (Step 209): The micro-SLA is now in effect. The UE's traffic for that specific application should now experience the elevated QoS. In the video example, the streaming data is flowing with guaranteed throughput so the video should play in high quality without buffering. Both UE and network monitor this phase. The network's Monitoring module might collect stats and ensure the promised QoS is being met (if not, it could adjust internal parameters). The UE's agent monitors as well (308), in one embodiment periodically checking if buffer starvation is gone, etc.
Mid-course Adjustments (Optional): If conditions change drastically during the micro-SLA, the network might send an update. For instance, if a surge of other traffic comes in, the controller might send Intent_Update to the UE: “Due to network condition, throughput might drop to 15 Mbps”. Similarly, the UE might send an extension request if needed. These are optional flows; if everything goes as planned, they might not occur. They're represented by dashed lines in FIG. 5 potentially, not explicitly numbered.
Termination (Step 210): When the micro-SLA period ends (either after the agreed duration or triggered early by one side), the elevated QoS is withdrawn. FIG. 5 shows possibly a (8) QoS_Intent_Release from UE to network if UE finishes early, or conversely the network just lets the timer expire. In either case, the network executes a teardown: PCF/SMF remove the special QoS rule (SMF may send a modification to RAN to delete the dedicated bearer or revert to default), and normal QoS resumes for that traffic. The controller 150 logs the end of that micro-SLA and frees any reserved margin in its resource accounting. The UE's agent also informs the application (if necessary) that the special QoS is no longer guaranteed, so the app could adjust (for example, a video app might lower its bitrate to adapt to likely normal network conditions again, or a file transfer app might know that it might slow down now).

Post-hoc Logging and Learning (Step 211): After termination, the network might log the outcome (was the SLA successful, how much data delivered, etc.) and possibly feed this back to training data for the AI. The UE might also record experience (if for example it noticed that even with micro-SLA the quality wasn't as expected, it might include that in future decisions or send feedback to network in some diagnostic report). This concludes one full cycle of negotiation. The whole process from detection to enforcement could be very fast—ideally on the order of a few hundred milliseconds or less—to be useful for real-time needs. The design should ensure minimal signaling delay. For example, if using NAS, it might piggyback on an existing message if possible. If using user-plane API, it's just one round-trip on a perhaps low-latency slice. In implementation, steps like sending response to UE and enforcing in network can be done concurrently to save time (the network can provision resources while the acceptance travels to UE).

The sequence in FIG. 5A and FIG. 5B concretely might be: UE—>Network: Intent Request 501 (with context). The RAN forwards 502 the Intent Request to the core network. Network—>Policy DB/NWDAF 503: Check (optional simultaneous queries). Network<—Policy/NWDAF 504: Response (giving info like user allowed bandwidth, network load, etc). Network: Decision made 505 (logic internal). Network—>PCF/SMF: Install QoS (with given QoS parameters) 506. SMF—>RAN: Bearer QoS setup (RAN config) 507. Network—>UE: Intent Response (grant/deny info 508a/508b). [Later] UE or Timer triggers: End request or expiry 509. Network—>PCF/SMF—>RAN: Remove QoS rule 510. (UE gets back to normal state).

The UE may move between cells (e.g. handover 511) during a micro-SLA. Ideally, because this is integrated with the core's QoS, if a handover 511 occurs, the new cell's gNodeB will be informed of the QoS context (via handover signaling which includes QoS Flow contexts). This way, the micro-SLA can continue in the new cell if that cell has capacity 512. If the new cell is too congested 513, the network might have to adjust or drop the SLA (the controller can be notified by SMF/AMF that the user moved to a congested cell, and then decide maybe to curtail the guarantee to what that cell can do). This is an advanced scenario; it highlights that mobility is supported by virtue of using the mobile core's inherent QoS management-any QoS flows set up are part of the PDU session and thus move with the session. Where the serving RAN node itself is mobile—such as a low-Earth-orbit satellite about to leave the UE's footprint—the satellite gateway publishes a link-remaining-time indicator that the AMF relays to the Intent-Aware QoS Controller. The controller attempts a make-before-break hand-over to terrestrial NR or to a successor NTN beam, cloning the active micro-SLA when full resources are available or issuing an SLA-Adjust with a reduced QoS envelope when only partial capacity exists; if no viable bearer can sustain even a reduced profile, it transmits a Revocation-Warning followed by orderly termination at the advertised link-end time. The UE may include a preferred_access flag in subsequent intents—e.g., “NR-terrestrial” for latency-critical sessions and “NTN” for delay-tolerant bulk sync—enabling dynamic, per-intent path selection while keeping micro-SLA management seamless across heterogeneous and moving access networks.

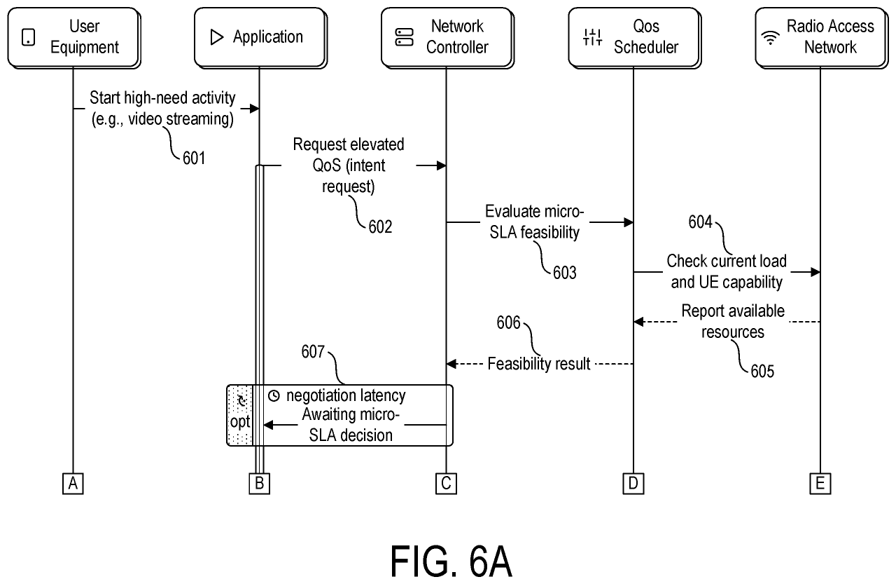

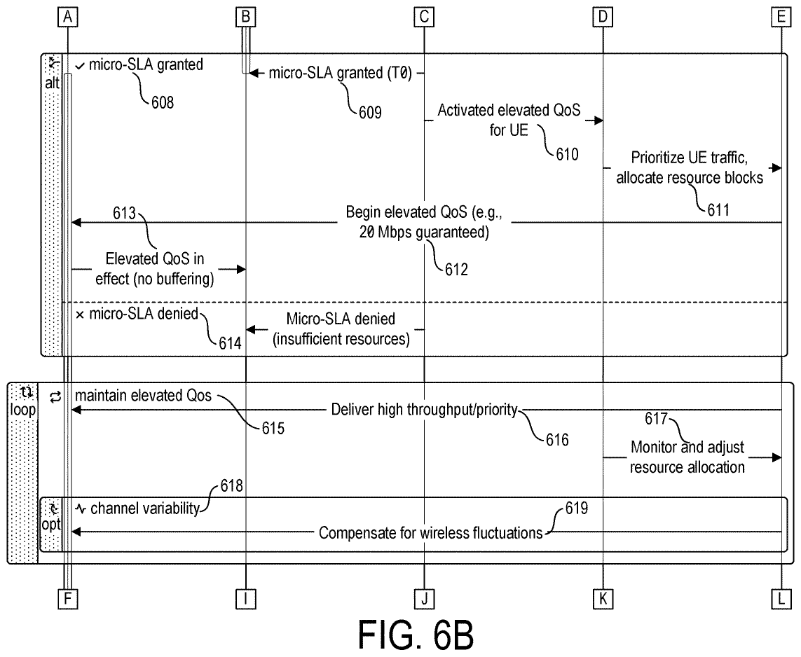

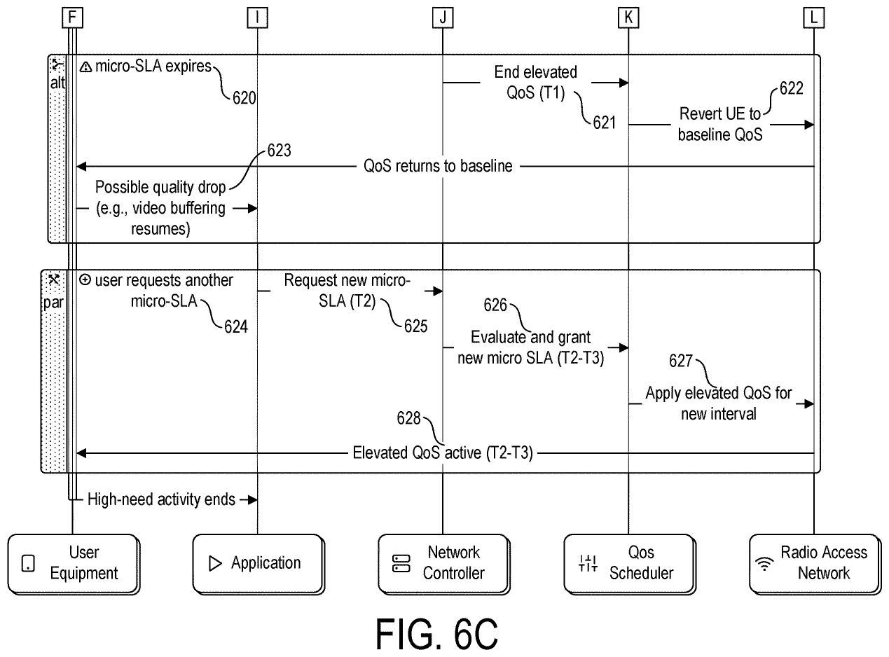

A micro-SLA enforcement and lifecycle operation is described in FIG. 6A and FIG. 6B.

FIG. 6 is a time-sequence diagram depicting the lifecycle of a micro-SLA enforcement. The QoS for a particular flow may be elevated at the start of a micro-SLA and then may return to normal after the micro-SLA period. It may also indicate triggers like the request time, the granted interval, and the expiration point.

FIG. 6 provides a conceptual timeline of how a micro-SLA affects the QoS level over time.

Before time T0 (the start of the micro-SLA), the UE's traffic is at baseline QoS. For instance, it might be using a default non-guaranteed bearer, competing evenly with other traffic. The quality might fluctuate with network load.

At time T0, the micro-SLA kicks in 601 (as a result of the negotiation described above). Immediately or very shortly thereafter, the QoS metric jumps to Elevated Level 602. Feasibility is evaluated 603, current load is checked 604 and available resources reported 605. A feasibility result 606 is returned and a micro SLA decision is awaited 607. Beginning at FIG. 6B, micro-SLA granted 608/609 and QoS may be elevated for the UE 610. UE traffic may be prioritized and allocated 600. If throughput guarantee is the metric, it goes from 0 (no guarantee) to, say, 20 Mbps guaranteed 612. If priority, it jumps from normal priority to top priority. “Micro-SLA active”. Micro-SLA granted

During the interval T0 609 to T1 621, the QoS is maintained at the elevated level 613. A micro SLA may also be denied 614 alternatively. Minor variations might occur but generally the metric stays above what it was baseline. For example, throughput delivered stays 615 near the requested 20 Mbps. The graph might have a line indicating the guaranteed level and actual delivered 616, where actual could be equal or higher (if network gave more when available). Monitoring 617 may be performed and if the channel is variable 618, compensations may be made 619.

At time T1 621, which is the intended end (for example, after 5 minutes or when the user's high-need activity ends), the micro-SLA period ends 620 at the top of FIG. 6C. The guarantee is withdrawn 622. This could be a drop from 623 the elevated level back to the baseline level. If the baseline level is lower (which it typically is), you see a downward step.

After T1 621, the traffic goes back to being best-effort or whatever default QoS the user had. If the user's application is still active, it might still get some resources but now not assured-possibly the throughput could dip if network conditions are worse at that time.

Prior to T0, the user's QoS may have not been actually not sufficient for the app (e.g., the video was buffering). Then from T0 to T1 with the micro-SLA, the quality is good (no buffering), and after T1 if the video is over, it doesn't matter, or if the video continues, maybe it might start buffering again since the boost is gone.

Thus, FIG. 6 encapsulates the benefit: a temporary uplift in performance, targeted and timely. It also reflects that these micro-SLAs are transient; they don't permanently change the user's service level.

Multiple micro-SLAs may happen sequentially for the same user. For example, a user requests again 624 at T2 625 and gets another boost 627 after evaluation 626 and is elevated from T2 to T3 628, etc.

From an enforcement standpoint: the network might implement the guarantee by ensuring scheduling such that the UE gets needed resource blocks on the radio. That guarantee might not always translate to exactly a straight line throughput due to wireless channel variability, but the network will try to compensate (maybe by using more robust coding or more blocks to maintain throughput). If the user is on the edge of cell and can't physically get 20 Mbps due to signal, the guarantee is a best effort up to that, but the network likely knows the UE's radio capability and wouldn't promise beyond what the link can do.

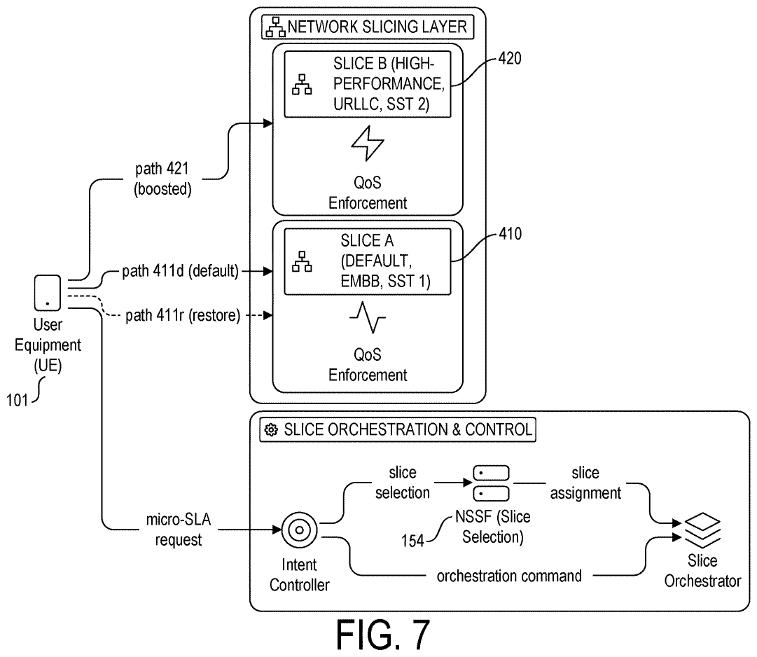

FIG. 7 illustrates an example of network slicing integration with the micro-SLA framework. In this diagram, the normal operation places the UE on a default slice (410) with standard QoS, and upon negotiating a micro-SLA, the UE's traffic is moved to or augmented by a high-performance slice (420) (or a dedicated slice segment) which provides the required QoS. FIG. 7 shows both the baseline and boosted paths, demonstrating how slicing can be leveraged for fulfilling intents.

Network slicing is a prominent feature of 5G, allowing different logical networks to be created on shared infrastructure for different service types or customer groups. The application can leverage slicing as one method of providing the requested QoS. FIG. 7 illustrates an example where slicing is used to fulfill the micro-SLA.

In FIG. 7, one can imagine two slices: Slice A (410)—a default slice that the UE is initially on. Perhaps this is an eMBB (enhanced Mobile Broadband) slice with moderate QoS, or just the generic slice. Slice B (420)—a special slice, possibly with greater resources or specific QoS characteristics (like low-latency or high bandwidth). For example, Slice B could be a URLLC slice or a dedicated enterprise slice with lots of reserved capacity that is currently under-utilized.

The diagram likely shows the UE connected to the network through Slice A at first (represented by a path or link 411d, 411r depending on default or restore). The UE's traffic flows go through slice A's QoS handling. When the UE's agent requests an enhanced QoS, the network's intent controller (in conjunction with NSSF 154 and slice orchestration) decides to move the UE's session to Slice B. This could happen by establishing a PDU session on Slice B (some devices can have multiple PDU sessions; or by releasing and re-establishing on a different slice if needed, though that might be slow—alternatively, dual connectivity to two slices could be possible in the future).

So at time T0 (similar to earlier timeline), slice change occurs. The link may switch from 411d, 411r to 421 (UE now attached via Slice B path 421). In Slice B, the UE is allocated the needed QoS easily because slice B has reserved capacity or specific scheduling for that type of service.

After the micro-SLA period, at time T1, the UE might be switched back to Slice A (path 411d or 411r again).

Not all implementations will do a slice switch, some might just tweak QoS within one slice. But for scenarios where slice separation is strong (a slice may be had for “low latency services”), temporarily placing a user into that slice can effectively grant them better latency and priority.

One challenge is slice switching overhead. In current 5G, slice selection happens at session setup, and switching slice on the fly isn't standard. However, one could simulate it by having multiple simultaneous sessions or by the network just treating the user's flows with the other slice's policy (some vendors might allow dynamic slice change but not sure if standardized). Slice elasticity might improve.

The figure labels each slice to show certain characteristics or an identifier (e.g., Slice A=SST 1 (eMBB) and Slice B=SST 2 (URLLC) using 3GPP slicing terminology where SST is Slice/Service Type).

It's also possible that the micro-SLA is fulfilled by creating a dedicated slice instance just for that user's application for a short time. That would be an extreme case (spinning up a slice on demand, which might be too slow in practice for very short terms, but maybe feasible for longer micro-SLAs or for planned events).

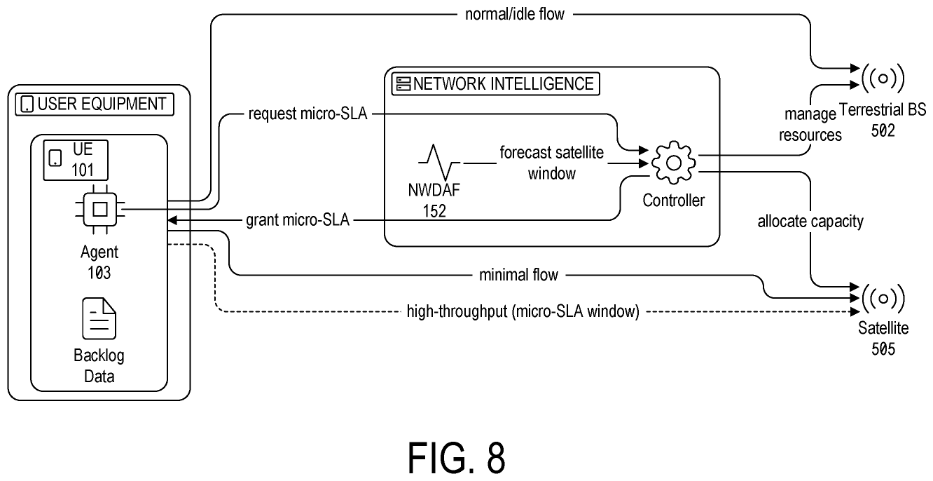

FIG. 8 shows a use case scenario involving a non-terrestrial network (satellite) component. The diagram includes a satellite station or relay 505 in addition to a terrestrial cellular base station (502). It illustrates a UE 101 communicating with a satellite link for a portion of time and negotiating a micro-SLA to exploit a brief window of improved connectivity (for example, when the satellite is in line-of-sight). This highlights support for limited-time availability of resources.

FIG. 8 addresses scenarios beyond the typical cellular coverage—specifically, integration with satellites or other intermittent resources. In this figure, the UE 101 is shown with connectivity to both a terrestrial base station 502 and a satellite 505 (for example, a Low Earth Orbit satellite providing direct-to-device communication or through a satellite gateway). Many future networks envisage multi-access connectivity where devices can use cellular when available and satellite when out of coverage, or even simultaneously for redundancy/bandwidth.

The use case: suppose the user is in a remote area where normal cellular is weak or has limited capacity, but occasionally a satellite pass occurs providing a high-bandwidth downlink (albeit with higher latency). Or consider the opposite: the satellite is usually low bandwidth but at certain times can allocate a high burst.

The UE's agent 103 can be aware of the presence of the satellite link (the device's modem might know when it has line-of-sight or the ephemeris schedule). Alternatively, the network can broadcast availability (e.g., “satellite window open from 12:00 to 12:05”).

When such a window opens, the UE might have backlog of data (like photos or logs) that it held off due to cost or speed. The agent triggers an intent: “I have 500 MB to upload, and I see high capacity link now, please give me maximum throughput for the next 3 minutes to send this data.”

The network's controller sees that through the satellite gateway 505, there is currently extra capacity (maybe because the satellite has lesser load or uses a different spectrum). It grants the micro-SLA focusing on that access. It might instruct the UE to primarily use the satellite path for this data (if the UE is multi-homed, the policy could say route this flow via satellite PDN). Or if the satellite is integrated as just another cell (some architectures treat NTN similarly to a cell), then it's about scheduling more resources on the satellite.

The UE 501 may send data via satellite 505 link (during micro-SLA, indicating heavy usage), whereas the terrestrial link 502 might be idle or just doing normal stuff.

Another scenario is limited-time promotions or edge resources: e.g., a specific Wi-Fi offload hotspot is available for a short time—though not exactly what asked, but conceptually similar that something is only temporarily there.

For example, UE may have a normal state—minimal throughput via satellite due to constraints,” then the UE negotiates micro-SLA when satellite overhead—boosting to high throughput path.

This example underscores the adaptability of the application. The network's decision engine could incorporate awareness of these external factors. Possibly NWDAF 152 could forecast when a satellite will have coverage and inform the controller, which might then proactively allow micro-SLAs at those times.

The application covers not just static network conditions but dynamic availability and potentially heterogeneous networks (multi-RAT, multi-access management), demonstrating robustness and broad applicability.

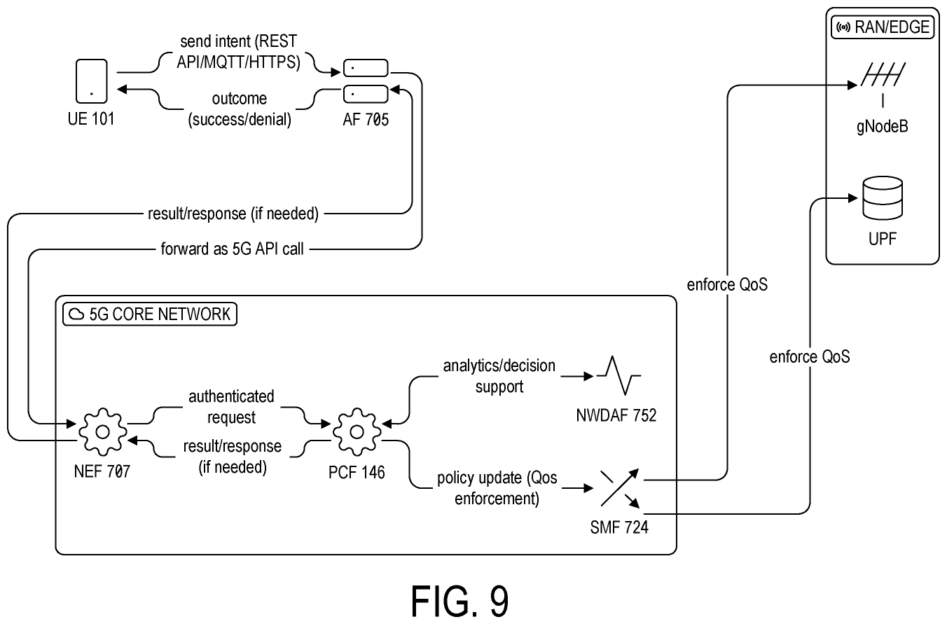

FIG. 9 is a deployment diagram focusing on backward compatibility and implementation in current 5G systems. It shows how the UE's intent can be conveyed via an Application Function (AF) server 705 through the Network Exposure Function (NEF) 707 to the core network's PCF 146. The figure outlines the data flow for operators who implement the application by introducing an AF/NEF intermediary, thereby requiring minimal changes to the UE's standard interfaces (the UE could send the intent over HTTPS to the AF, for instance).

While the UE could talk directly to the core, one practical integration in a 5G network is using the existing Network Exposure Function (NEF) and Application Function (AF) framework. FIG. 9 illustrates how the application can be mapped to that.

In FIG. 9: The UE 101 might not directly send NAS to PCF because current 3GPP doesn't define a “QoS request from UE” NAS message. Instead, the UE 101's agent opens a connection to an Application Function (AF) 705. This AF could be a service hosted by the operator in the cloud or edge. It acts as a mediator. The UE sends its intent (perhaps as a REST API call or MQTT message) to the AF 705. The AF 705 is a trusted entity to the core network. According to 3GPP, an AF could be an application server that, for example, requests certain QoS for a service (like IMS might use AF to request QoS for voice media). The AF communicates with the PCF via the NEF 707 or directly if trusted in the network domain. The NEF 707 is essentially an API gateway into the operator core that allows external (or non-core) services to request certain capabilities in a controlled manner. It can translate external requests to internal policy requests.

In a design, the AF 705 would forward the UE's intent (possibly with some processing or verification) to the NEF 707 using a service call (Npcf_PolicyAuthorization or similar). The NEF 707 then interfaces with the PCF 146. (In some networks, NEF can directly inject policies to PCF or can act as a proxy.) In still other embodiments, Application Function 705 is not limited to merely forwarding UE-originated intents; it may also generate an AF-originated IntentRequest on the UE's behalf when higher-layer application logic executing in the cloud or edge determines that a forthcoming transaction (for example, a server-initiated volumetric software update or a cloud-rendered AR scene) will require elevated QoS. Such AF-generated intents carry the UE's IMSI in the target-subscriber field and a proof-of-delegation token that the PCF validates before resources are granted, thereby permitting operator-controlled, server-side optimisation while preserving subscriber authentication boundaries.

The PCF 146, upon receiving this request, interacts with SMF 144 to enforce the QoS if approved. This is how an AF normally gets QoS for a flow: the PCF authorizes a QoS and installs it via the SMF into the session. The decision logic (as described in FIG. 1 for controller 150) in this scenario would largely reside in the PCF 146 (with PCF consulting NWDAF 752 for analytics if needed) because the PCF is making the final call on policy. The AF/NEF might not do AI decisions; they just convey requests. Alternatively, the AF 705 could embody some of the controller's logic too, but likely the PCF has the subscription info and network conditions (through NWDAF) needed to decide.

FIG. 9 thus shows: UE agent 101—>AF 705: intent request (over user-plane internet). The intelligent agent is depicted on the UE for clarity; however, the disclosure equally covers a Remote Agent Function (RAF) hosted in an edge cloud or private data centre. In that variant the UE streams real-time context (application ID, buffer depth, radio metrics) over a secure gRPC channel to the RAF, which performs intent formulation and transmits the resulting request to AF 705. All intent messages include a subscriber-signed policy token, so whether the agent logic resides on-device or off-device, the network authenticates the request against the same subscriber identity.

AF 705—>NEF 707: API call forwarding that request in 5G API format. NEF 707—>PCF 146: passes the request (with authentication that this request comes from an authorized AF for that UE). PCF 146—>SMF 144: if approved, PCF sends policy update to SMF (like “install QoS rule for UE X flow Y with Z Mbps”). SMF 144—>gNodeB & UPF: enforcement of QoS (as usual). PCF 146—>NEF/AF: result (if needed, PCF may send response so AF/UE knows). AF 705—>UE 101: returns success/denial info.

By leveraging NEF/AF, an operator can deploy the application without waiting for a new standard for UE-to-core QoS negotiation. It repurposes what exists for third-party applications to now serve the UE's internal agent.

One might note that this essentially means the UE's agent is acting like a “third-party application” relative to the mobile core, but since it's under the operator's control (the UE is a subscriber device), it's in a gray area. However, many 5G networks allow certain device applications to use exposure APIs (especially in private networks or operator-provided apps). An approach could initially be offered via an SDK where the device makers or app developers use an operator API to request QoS. Eventually, standards might formalize direct UE intents.

FIG. 9 labels should correspond: 705 (AF), 707 (NEF), 146 (PCF), 144 (SMF), 752 (NWDAF perhaps). The main takeaway is that the architecture of the application can be overlaid on the current 5G service-based architecture using NEF as an entry point for intent messages.

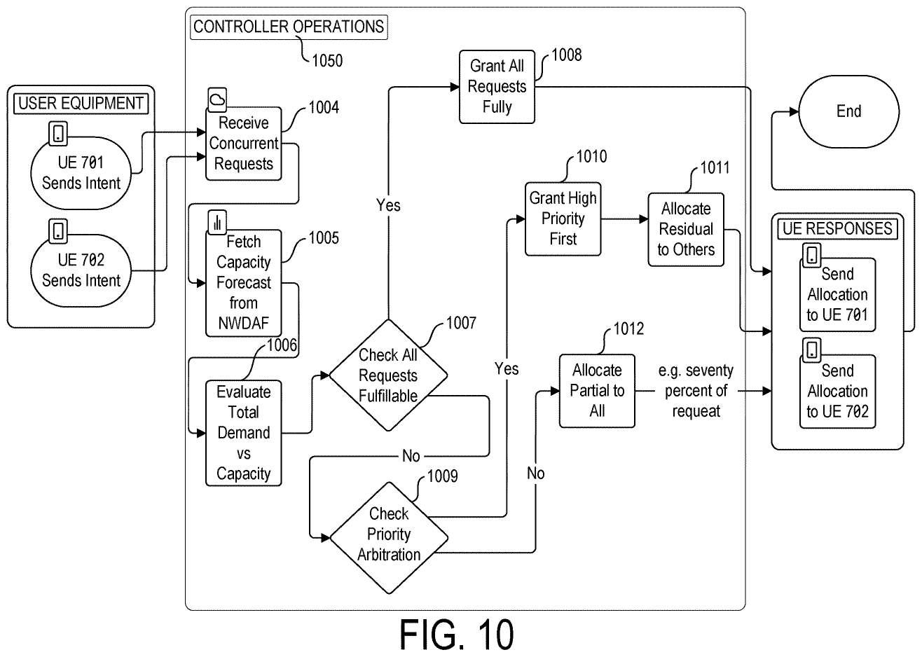

FIG. 10 is a schematic illustrating multiple UEs 701, 702 simultaneously using the intent-based QoS negotiation framework and how the network controller 1050 arbitrates among them. A representation of priority levels or utility values may be included for each request, for example, UE1's request is granted immediately while UE2's request is queued or partially granted, demonstrating multi-agent negotiation and conflict resolution by the network's AI engine.

FIG. 10 addresses multi-user scenarios. Since a network will have many UEs, each possibly with its own agent, the system must handle concurrent negotiations and ensure one user's micro-SLA doesn't disastrously impact others. In the figure, two UEs 701, 702 are shown sending requests to the network controller 1050 around the same time 1004.

UE1 701 might be a premium user or running a critical app; UE2 702 might be a normal user. The controller 1050 receives both intents. The controller's internal logic evaluates 1006 both together based on capacity 1005 from NWFAF. Possibly a table or queue is depicted inside 1050 listing requests and their attributes (like required bandwidth, priority, etc.).

Concurrent requests 004 may be received from UE 701 and UE 702, and a capacity forecast 1005 may be fetched from the NWDAF so that total demand vs capacity 1006 can be evaluated. If all requests are fulfillable 1007, then all are granted 1008. Otherwise, a priority arbitration 1009 is checked. The high priority 1010 may be first and the rest residual 1011. If there is not a priority based arbitration, then all may receive 1012 partial allocation.

The outcome illustrated could be: UE1's 701 request is granted fully, while UE2's 702 request is either delayed or partially granted. Alternatively, both are granted but with some compromise: e.g., each gets 70% of what they wanted.

This figure emphasizes the role of the AI/decision module in performing resource arbitration. The concept of utility or priority can be shown: perhaps UE1's request had a higher utility score to the network (maybe because of subscription or because its intent type is considered more important, like emergency call vs file download).

The controller might perform something like a weighted fair allocation or apply a policy like “no more than N micro-SLAs per cell concurrently”.

The NWDAF may make a prediction that “only X total throughput available to share”, and the controller splitting it.

An important part of conflict resolution is also how to ensure stability: e.g., if too many requests come, the controller might start rejecting new ones to keep the network stable, which could be depicted as additional UEs with red crosses (denied). When the admission threshold is reached, the controller returns an Intent-NACK to the originating UE, setting cause code ExcessRequests and a retry-after interval that instructs the agent to withhold additional non-critical intents for the specified time. If overload persists, the serving gNodeB broadcasts a cell-wide Intent-Pause indicator in system-information; UEs must suspend best-effort intents until the timer elapses, while emergency-priority intents (priority≤2) remain admissible but still undergo resource checks. These explicit signals ensure each device is informed that too many requests are in play and can throttle its intent rate accordingly, preventing signalling storms and maintaining overall stability.

The multi-agent scenario also could consider malicious or selfish behavior—presumably the network has safeguards like not allowing one UE to hog too much for too long if others need it, etc.

Dozens of UEs might be negotiating at any given time. The intelligent controller can juggle these, effectively acting as a micro-SLA orchestrator that maximizes overall network efficiency while meeting individual intents as well as possible.
User-driven vs Network-driven: Unlike NWDAF-based QoS optimization (e.g., WO2022/005037) that is entirely network-driven, the present application puts the user equipment's agent in the loop, enabling proactive requests rather than just reactive network tuning. This is a fundamental paradigm shift in how QoS is managed.
Granularity and Temporality: Prior art QoS solutions often deal with relatively coarse changes (e.g., permanent policy changes or long-term QoS settings). The present micro-SLA approach operates on very short timescales and can be targeted to individual flow instances. For instance, US2024/0163734 monitors QoS generally for a service; it does not teach setting up a special 2-minute contract for a single occurrence of that service.
Two-way Negotiation: Many existing systems are one-way (network dictates QoS, or user just experiences whatever network gives). The user side requests in semantic terms and the network side decides and replies. That two-way handshake with possible offers/counter-offers is new in this domain, similar in spirit to how TCP might negotiate options but at a higher service level.
Intent Semantics: The application deals with intents, which are a higher-level abstraction than typical QoS parameters. Descriptions like “HD video streaming” are allowed which encapsulate a pattern of requirements, and the network can interpret that (especially with AI) to allocate resources in an optimized way. This is more advanced than say an API that just says “give me X bandwidth” without context. Context allows smarter decisions (the network might treat a medical telemetry app's 1 Mbps differently than a file download's 1 Mbps because the intent and implications differ).
Extensibility to Future Networks: The framework is designed to be forward-compatible. As networks evolve (more virtualization, open RAN, etc.), the core idea of communicating intents and setting up temporary QoS guarantees can be realized in those contexts with appropriate adaptations. For example, in an open RAN environment, the RAN Intelligent Controller (RIC) could play a role akin to the intent controller for RAN slicing; in a cloud-edge deployment, the edge cloud might directly grant resources to an app instance based on these signals. The patent covers these variations as well.

In terms of deployment feasibility, an operator could introduce this application incrementally. Initially, it might be offered as a premium feature to certain users or applications. Over time, if standardized, it could become a ubiquitous mechanism, improving network utilization (since resources are not statically reserved but allocated on demand) and user satisfaction (since performance is boosted when it really matters). Additionally, the data gathered from micro-SLA usage can inform network planning—e.g., if many users request better video QoS at certain locations/times, the operator knows where to add capacity or a small cell.

Those skilled in the art will appreciate that various modifications can be made to the embodiments described without departing from the scope of the application. For instance, while the examples often assumed downlink video streaming requiring high downlink bandwidth, the framework equally applies to uplink-heavy scenarios (such as live broadcasting from the UE).

A method of dynamically negotiating quality-of-service (QoS) parameters between a user equipment (UE) and a mobile communication network, the method comprising: (a) monitoring, via a processor, at an intelligent agent within the UE, one or more operating conditions of an application executing on the UE to detect an intent indicating a need for enhanced QoS for a data session associated with the application; (b) generating, by the UE in response to the detected intent, an intent message comprising a request for a temporary QoS enhancement, the intent message including information about the application's service requirements and an identifier of the data session or traffic flow; (c) transmitting, via a transceiver, the intent message from the UE to a network-side QoS control function over a signaling interface; (d) evaluating, at the network-side QoS control function, the request by analyzing current network conditions and policies, including determining whether the requested QoS enhancement can be granted and to what extent, wherein said evaluating uses at least one of: real-time network analytics, the UE's subscription profile, and predictive models of resource availability; (e) sending a negotiation response from the network-side QoS control function to the UE's intelligent agent, the response indicating whether the requested QoS enhancement is approved, and if approved, specifying a set of negotiated QoS parameters and a validity period for a micro service-level agreement (micro-SLA) during which the QoS parameters will be enforced; (f) upon approval, configuring network resources in accordance with the negotiated QoS parameters for the identified data session or traffic flow, including adjusting at least one of: a QoS flow in a core network, a radio bearer in a radio access network, or a network slice assignment for the UE; (g) during the validity period of the micro-SLA, enforcing the negotiated QoS parameters for the UE's data session such that the application traffic receives the requested QoS treatment; and (h) automatically terminating the micro-SLA upon expiration of the validity period or upon detection that the enhanced QoS is no longer required, by reverting the UE's QoS treatment to a baseline level and releasing any temporarily allocated network resources.

Monitoring the operating conditions of the application in step (a) comprises detecting a trigger event selected from: the application entering a high-bandwidth mode, initiation of a latency-sensitive task within the application, a user input indicating a request for better performance, or an accumulation of data in a buffer exceeding a threshold, and wherein the intent message generated in step (b) includes an indication of a type of service associated with the trigger event.

The intent message in step (b) specifies one or more target performance metrics for the data session, the performance metrics comprising at least one of: a minimum downlink throughput, a minimum uplink throughput, a maximum allowable latency or jitter, a priority level relative to other traffic, and an identifier of an application type or service category.

The signaling interface for transmitting the intent message in step (c) is a Non-Access Stratum (NAS) or Radio Resource Control (RRC) signaling channel between the UE and the mobile communication network's control plane, the method further comprising securing the intent message with authentication and integrity protection provided by the UE's access credentials.

The signaling interface for transmitting the intent message in step (c) is a service-based application programming interface (API) exposed by a network exposure function (NEF) in the mobile communication network, the method further comprising the UE acting as an authorized application function (AF) client invoking a policy authorization service on the network to convey the intent message to the QoS control function.

Evaluating the request in step (d) includes utilizing an artificial intelligence or machine learning algorithm to estimate an impact of granting the requested QoS enhancement on overall network performance, and to determine an optimal way to fulfill the request, the algorithm taking into account at least current cell load and predicted traffic patterns.

The network-side QoS control function applies operator-defined policy rules during step (d) such that the requested QoS enhancement is granted only if it falls within allowed parameters for the UE's subscription level, and wherein if the request exceeds a permitted level, the network-side function automatically modifies the request to a lower, allowed level and includes the modified QoS parameters in the negotiation response of step (e).

The network-side QoS control function coordinating with a slicing management function during step (f) to assign the UE to a particular network slice that is configured to meet the negotiated QoS parameters, wherein the UE's data session is moved to or established on the network slice for the duration of the micro-SLA.

The enforcing the negotiated QoS parameters in step (g) comprises installing, by a policy control function (PCF), a temporal policy rule in the core network for the UE's session that defines the QoS treatment (including a QoS profile or 5G QoS Indicator value) for the identified flow, and signaling, by a session management function (SMF), to the radio access network to activate a corresponding dedicated bearer or QoS flow with the specified treatment.

Automatically terminating the micro-SLA in step (h) includes one or more of: sending a termination notice from the network-side QoS control function to the UE's intelligent agent indicating the end of the enhanced QoS period, removing any QoS policy rules associated with the micro-SLA from the core network's policy control function, tearing down any dedicated radio bearers established for the micro-SLA, and notifying charging systems to properly account for the duration of enhanced QoS provided.

After step (h), analyzing by the network-side QoS control function the performance data of the micro-SLA and feeding the data into an analytics module or machine learning model to improve future QoS negotiation decisions, thereby allowing the network to learn usage patterns and optimize resource allocation over time.

The UE's intelligent agent and the network-side QoS control function perform additional messaging to adjust or update the micro-SLA during its validity period, including: (i) the network-side function sending an intent update message to the UE if changing network conditions necessitate a modification of QoS parameters (such as reducing guaranteed throughput due to unforeseen congestion), or (ii) the UE sending an intent withdrawal or adjustment message if the application's requirements change (such as completing the high-demand activity early), and upon such messages, mutually adjusting the terms or ending the micro-SLA accordingly.

A user equipment (UE) device operable in a 5G or beyond-5G wireless network, the device comprising: a radio transceiver for communicating with a base station of the wireless network; one or more processors; and a memory storing program instructions that, when executed on the one or more processors, cause the UE device to perform functions including: executing one or more user applications that generate network traffic; running an intelligent QoS agent configured to monitor performance requirements of the user applications and detect triggers indicative of an application needing improved network QoS; upon detecting a trigger, formulating an intent message representing a request for temporary enhanced QoS, the intent message including at least an identifier of the application or traffic flow in need and data specifying a desired QoS level or performance objective; transmitting the intent message over an established signaling or data channel to a QoS control entity in the network; receiving a QoS negotiation response from the network's QoS control entity, the response indicating either a grant of enhanced QoS (with details of QoS parameters and a time duration) or a denial of the request; if enhanced QoS is granted, coordinating with the device's protocol stack to utilize the enhanced QoS, including mapping the application's traffic to any new QoS flow or bearer set up by the network and potentially adjusting local application settings (such as video bitrate or upload rate) in accordance with the granted QoS parameters; and after the expiration of the granted QoS duration or upon receiving an indication from the network, reverting the device's traffic handling to a default QoS state and ceasing use of any temporary QoS enhancements.

The intelligent QoS agent is further configured to interface with the device's operating system or application programming interfaces such that it can obtain real-time metrics on network throughput, latency, and application buffer status, and wherein the agent uses these metrics to decide when to send intent messages and to verify if granted QoS enhancements are effectively improving the application performance.

The intent message is formatted according to a predefined schema understood by the network's QoS control entity, and wherein the UE device stores network-provided parameters identifying how and where to send the intent message, the parameters including at least one of: a logical or physical channel designation for intent signaling, an address or endpoint (URL or IP address) of a network server that accepts intent requests, and a security token or credential for authenticating intent requests.

The radio transceiver and associated protocol stack are configured to support multiple QoS flows simultaneously, and the device's intelligent QoS agent is capable of assigning the application's traffic to a dedicated QoS flow when enhanced QoS is granted by the network, such that the dedicated QoS flow is used for the duration of the micro-SLA and provides the contracted QoS, after which the traffic is automatically moved back to a default QoS flow.

The UE intelligent QoS agent includes a learning component that adapts its trigger detection logic based on past outcomes, such that if certain types of intent requests were frequently denied or unnecessary, the agent becomes less aggressive in those scenarios, whereas if certain contexts consistently benefitted from QoS boosts, the agent becomes more proactive in anticipating and requesting them.

A network-side apparatus in a mobile communication system for providing adaptive QoS control, the apparatus comprising: a network interface for communicating with core network functions and with at least one base station; a processor; and a non-transitory memory storing instructions that, when executed by the processor, configure the apparatus to: receive a QoS intent request originating from a user equipment (UE), the request conveying an application's QoS needs and a desire to establish a short-term QoS guarantee for a specific traffic flow; authenticate and validate the request against subscriber entitlements and service policies; obtain current network state information relevant to the request, including performance metrics of the UE's serving cell or slice and any ongoing QoS commitments; execute a decision algorithm that determines whether to grant the requested QoS enhancement, and if so, at what level and for what duration, the decision algorithm accounting for network capacity and pre-configured priority rules; responsive to a decision to grant, initiate configuration of network resources to fulfill the request by interfacing with at least a policy control function (PCF) or equivalent to install a time-limited QoS policy for the UE and with a session management function (SMF) or radio controller to allocate the necessary bearer or flow with the enhanced QoS;-generate a response message to the UE indicating the outcome of the request, including any granted QoS parameters or reasons for denial, and cause the response message to be sent via the network interface to the UE; monitor the status of the granted QoS during its active period, including tracking the time remaining and the performance delivered, and if needed, adjust or revoke the QoS guarantee in real time if network conditions degrade beyond acceptable thresholds or if the UE's usage deviates from the expected pattern; and upon reaching the end of the QoS guarantee period, automatically deallocate or downgrade the resources associated with the QoS enhancement and update the network state to reflect the cessation of the micro-SLA, thereby making those resources available to other users.

The apparatus implements the functionality of an intent-based QoS negotiation controller as described in the specification, and is integrated with a 5G core network, such that the apparatus communicates with core network functions over standardized service-based interfaces (SBIs)-including receiving intent requests possibly via a NEF (Network Exposure Function) and controlling QoS via PCF/SMF-while optionally utilizing analytics from a NWDAF (Network Data Analytics Function) to inform its decision algorithm.

The decision algorithm utilizes a multi-user resource allocation strategy to handle concurrent QoS intent requests from multiple UEs, the strategy ensuring that granting a new micro-SLA does not violate QoS commitments of ongoing micro-SLAs, and wherein in cases of contention, the algorithm prioritizes requests based on at least one criterion selected from: subscribed QoS tier of the UE, the criticality of the application's service type, a first-come-first-serve order, and real-time computed utility values for each request.

The apparatus is further configured to support non-terrestrial or intermittent communication resources by recognizing when a UE's intent request pertains to use of a temporary high-capacity link (including satellite links), and in response, scheduling the QoS enhancement to align with the availability window of said link, and coordinating with network elements (such as a satellite gateway or integrated access backhaul node) to effectuate the QoS guarantee during that window.

The generated response message to the UE includes a token or identifier for the micro-SLA, which the UE can reference in any subsequent communications (such as early termination or extension requests), and wherein the apparatus uses said identifier to manage the lifecycle of the micro-SLA in its internal records.

The apparatus, upon detecting that the UE has moved to a different cell or network slice during an active micro-SLA, ensures continuity of the QoS guarantee by re-instantiating or transferring the QoS parameters to the UE's new serving cell or slice, or if such transfer is not possible, by notifying the UE that the micro-SLA is terminated due to mobility events.

apparatus logs details of each QoS negotiation and outcome, and periodically provides or exposes these logs to an analytics system or operations support system, enabling the operator to review QoS negotiation statistics, identify trends in application demand, and adjust network provisioning or policy rules accordingly for future improvements.

A communication system comprising: at least one user equipment device as recited in claim 13; a radio access network configured to provide wireless connectivity to the user equipment device; and a core network including at least one network-side apparatus as recited in claim 18; wherein the user equipment device and the network-side apparatus are configured to interact as a system to carry out adaptive QoS negotiation and micro-SLA enforcement for application traffic, such that the user equipment device's application-driven QoS requests are intelligently served by the network in real time, thereby providing enhanced quality of experience to the user equipment device while maintaining efficient resource utilization in the network.

The system is further configured to operate within the framework of a 5G New Radio (NR) network, and the core network's policy control and charging subsystem is augmented to handle intent-based QoS requests from user applications, and wherein the communication system ensures backward compatibility by processing any unsupported or unrecognized intent messages in a safe manner (ignoring or rejecting with proper signaling) such that legacy network components or devices not supporting the application are not adversely affected by the introduction of the intent-aware micro-SLA framework.

The communication system supports deployment in a heterogeneous network environment that includes terrestrial base stations and non-terrestrial nodes (satellites or aerial platforms), and the user equipment device's intelligent agent is capable of selecting or indicating a preferred access for the QoS enhancement (terrestrial vs satellite) in its intent message when relevant, and the network-side apparatus correspondingly provisions the QoS on the indicated access network segment for the duration of the micro-SLA.

Multiple user equipment devices in a common cell are simultaneously utilizing the adaptive QoS negotiation framework, and the system further comprises an arbitration mechanism implemented by the network-side apparatus to manage radio and core network resources among the multiple devices' micro-SLAs, preventing over-commitment of resources by dynamically adjusting, denying, or terminating QoS guarantees in a manner that preserves overall network stability and meets a predefined fairness policy among users.

The network-side apparatus (intent-based QoS controller) is implemented as a cloud-native network function that can scale horizontally based on load, and wherein the system includes an orchestration component that monitors the volume of QoS intent requests and instantiates additional instances of the QoS controller function during high demand periods, thereby ensuring low-latency processing of intent negotiations even as the number of participating UEs grows.

The system is configured such that failure of the intent-based QoS negotiation process (due to lack of resources or any communication error) does not interrupt the UE's ongoing data session but simply results in the session continuing with best-effort service, thereby defaulting gracefully to normal operation if the enhanced QoS cannot be provided, and ensuring that the introduction of the micro-SLA mechanism does not introduce single points of failure for baseline connectivity.

Modern mobile networks face rising demand for real-time multimedia streaming at scale. This proposal presents a novel peer-to-peer (P2P) multimedia communication system, inspired by BitTorrent's decentralized distribution, but optimized for real-time streaming over mobile networks. The system leverages artificial intelligence (AI)—including federated learning (FL), reinforcement learning (RL), and graph neural networks (GNNs)—to dynamically optimize peer selection, content caching, QoS, congestion control, and routing. The architecture integrates with 3GPP standards: utilizing the PC5 interface for device-to-device (D2D) links, aligning with the 5G service-based architecture (3GPP TS 23.501), and extending 5G multimedia streaming concepts (3GPP TS 26.501) toward 6G-ready functionality.

Real-time video and multimedia services are straining mobile networks as user demand skyrockets. Traditional client-server streaming architectures impose heavy load on centralized servers and backhaul, often leading to scalability bottlenecks and high latency. Peer-to-peer (P2P) content distribution is a promising alternative-it has proven massively scalable in Internet settings (e.g., BitTorrent swarms serving millions of users). However, applying P2P to mobile multimedia streaming introduces challenges: wireless links have variable quality, mobile peers are resource-constrained and transient, and cellular networks are traditionally centralized. There is a pressing need for a decentralized streaming architecture optimized for mobile environments, one that can reduce server load and latency by leveraging device-to-device connections, while maintaining robust Quality of Service (QoS).

Simultaneously, the advent of 5G and emerging 6G architectures provides new tools to realize such a system. 5G's Service-Based Architecture (SBA) (3GPP TS 23.501) enables flexible deployment of new services as modular network functions. 5G also specifies a PC5 interface for direct UE-to-UE communication (the sidelink in Proximity Services), initially introduced in LTE Rel-12 for public safety and vehicle-to-vehicle use cases. This sidelink (D2D) communication can be leveraged for sharing multimedia content directly between nearby users, offloading the core network. Moreover, 5G's media streaming architecture (5GMS) (3GPP TS 26.501) envisions tight integration of third-party content delivery with the mobile network to improve QoE. Yet, current 5G standards primarily cater to client-server or broadcast models, lacking an explicit P2P content-sharing framework.

This proposal introduces a novel AI-driven P2P multimedia system for mobile networks that fills this gap. The key idea is to create a decentralized “swarm” of mobile users who cooperate to stream video and other media (including emerging formats such as augmented reality (AR) and extended reality (XR) content) by sharing data chunks, analogous to BitTorrent but tailored for real-time requirements. Intelligence is embedded throughout the system: peers use local and collaborative AI algorithms to make optimal decisions on whom to connect to, what content to cache or relay, and how to adjust to changing network conditions. By integrating with the mobile network's control plane (via SBA) and using PC5 D2D links for data transfer, the system maintains compliance with 3GPP standards. Furthermore, it is future-proof for 6G by embracing the vision of AI-native networking and by maximizing spectral efficiency through localized content exchange.
Technical Innovation: The proposed architecture is the first to merge decentralized P2P streaming with AI-driven optimization in a 3GPP-compliant mobile environment. Prior P2P streaming solutions (academic and patented) have not fully addressed the unique constraints of mobile networks or incorporated advanced AI. For instance, earlier systems constructed static or heuristic-based P2P overlays or relied on infrastructure-based multicast (e.g., leveraging IMS and MBMS). In contrast, the approach employs machine learning for real-time adaptability and uses device intelligence and network assistance in tandem. This results in a self-optimizing system where peers learn to cooperate efficiently, improving performance as the network evolves.

Overall, this proposal outlines a path toward significantly more efficient and smart mobile streaming. By treating user devices as cooperative nodes rather than mere clients, the system can reduce strain on network infrastructure and bring content closer to users, enabling low-latency, high-quality streaming even as demand grows. The innovation lies in orchestrating this distributed system with AI and aligning it with telecom standards—a combination that is original and ripe for both academic exploration and patentable invention.

Peer-to-peer streaming has been extensively studied in the context of wired networks and the Internet. Systems like BitTorrent proved that distributing content pieces among peers (“swarm downloading”) can drastically improve scalability and reduce server load. Two main overlay topologies are common: tree-based (peers form distribution trees) and mesh-based (peers form an unstructured graph). Mesh overlays, as used in most P2P video systems, have shown greater robustness against churn (peers frequently joining or leaving). In mesh overlays, each peer exchanges data with a set of neighbors without a strict hierarchy, which improves resilience and load balancing. However, random mesh connections are suboptimal; without guidance, peer selection can be inefficient. Traditional P2P networks also face the free-rider problem and need incentive mechanisms (e.g., BitTorrent's tit-for-tat). In the mobile domain, additional hurdles include limited upload bandwidth, device energy constraints, NAT/firewall traversal for direct connections, and fast-changing network conditions.

Early research on mobile P2P streaming adapted Internet P2P to wireless. For example, super-peer architectures have been proposed where a few high-capability nodes (or base stations) assist in organizing the mobile P2P network. Xie et al. (2013) describe a mobile P2P video system with “General” and “Special” super-peers, the latter controlled by the operator to maintain controllability. This highlights an important point: unlike open Internet P2P, in cellular networks the operator may need some oversight for reliability and policy control. Nonetheless, pure device-to-device sharing in cellular has been considered beneficial for offloading traffic. 3GPP introduced Proximity Services (ProSe) to enable D2D content sharing and public safety communications in LTE and 5G. In ProSe, devices discover each other and communicate over the PC5 interface (sidelink) without routing through the core network. This feature is now part of 5 G (Rel- 16 and beyond) and used notably in V2X (vehicle-to-everything) scenarios. The present system leverages this capability for general multimedia sharing among nearby users, effectively creating dynamic P2P overlays within a cell or cluster of users.

Despite these advances, no mature P2P content delivery solution exists in today's mobile networks for mainstream video streaming. Several challenges remain: how to efficiently form peer clusters on the fly, how to maintain QoS comparable to traditional streaming, and how to integrate P2P with operators'control over the network.

Artificial intelligence and machine learning are increasingly applied to optimize wireless networks. In fact, 6G visions position AI as a core pillar, with AI-native network architecture where algorithms operate across all layers. AI can help tackle the complexity of distributed, dynamic networks by learning from data and making adaptive decisions in real time. In embodiments, AI paradigms are used: federated learning (FL), reinforcement learning (RL), and graph neural networks (GNNs), each addressing different aspects of the P2P network optimization:
Federated Learning (FL): FL enables multiple devices (peers) to collaboratively train a global model (e.g., a content popularity predictor or network condition predictor) without sharing raw data. This preserves privacy and suits distributed systems. In caching, for instance, FL can be used so that users collectively learn which content pieces are likely to be popular in a region, and pre-fetch or cache accordingly. Recent literature shows FL can predict content popularity effectively for caching nodes. FL tunes models like a “neighbor selection policy” or “bandwidth allocation predictor” across peers. Each peer periodically trains on its local observations (e.g., experienced throughput from neighbors, chunk miss rates) and sends only model updates to an aggregator (which could be a base station or a logical function in the core). The aggregated model then improves peer behavior without exposing user data. FL thus helps optimize caching and peer selection globally while respecting user privacy and heterogeneity.
Reinforcement Learning (RL): RL is used for decision-making problems where an agent learns to take actions that maximize long-term reward. Networking problems like congestion control and dynamic routing can be naturally modeled for RL. In an embodiment, each peer (and optionally a network-side agent) can have RL agents for tasks such as peer selection (choosing which peer to fetch the next chunk from), bitrate adaptation for streaming, or congestion control (adjusting send rates over PC5 links to avoid overload). Prior works have applied RL to network resource allocation with success, as RL can find strategies superior to fixed heuristics under varying conditions. For example, a peer could use a multi-armed bandit or Q-learning approach to decide among multiple available neighbors for downloading a video chunk, balancing factors like observed throughput, reliability, and the neighbor's remaining battery. Over time, the peer “learns” which neighbors are most reliable or fastest for different content, significantly improving QoS (e.g. fewer stalls) compared to random or round-robin selection. RL is envisioned at the network side: an orchestrator function in the network (e.g., at the base station or core) could use deep RL to allocate spectrum or schedule sidelink transmissions optimally for the P2P streams, akin to how networks might dynamically schedule traffic in multi-hop D2D scenarios. The network orchestrator's RL agent might observe metrics such as sidelink load, interference levels, and peer throughput reports, and then decide how to assign radio resources to P2P links. Using deep RL, it can learn a scheduling policy that maximizes overall video quality and spectral efficiency. The orchestrator could take actions like granting more transmission opportunities to certain peer links or shifting some traffic back to the downlink if interference becomes high. Over time, the agent learns the optimal allocation strategy (e.g., how to split time-frequency resources between P2P sidelink and regular downlink) that yields high total throughput without harming cellular users. By employing RL in the scheduler/orchestrator, the system adapts resource allocation in real-time to network conditions, which would be hard to achieve with static rules alone.
Graph Neural Networks (GNNs): In a P2P overlay, the peer connectivity forms a graph-nodes are peers and edges are potential or active connections (D2D links). GNNs are a class of neural networks designed to operate on graph-structured data, learning representations of nodes or of the whole graph that capture connectivity and link-state information. They have recently been shown to achieve near-optimal performance in various network optimization tasks with fewer training samples. In context, a GNN model could be trained to estimate, for example, the expected quality (throughput, delay) of a particular peer-to-peer path by considering the graph of current connections and states. Each peer (or a central coordinator) could run a GNN that takes as input the local topology (which peers are connected to which others, what their link qualities are) and outputs predictions or decisions: e.g. a ranking of candidate peers to connect to, or detection of clusters of peers that should be formed to localize traffic. The GNN essentially helps in routing and cluster formation—by treating the network as a graph, it can capture complex relationships (like mutual interference or multi-hop connectivity) that would be hard to model with traditional approaches. GNNs could also assist a federated learning aggregator to intelligently select a subset of peers for model training (since FL client selection can be cast as a graph problem if communication costs and data overlap are considered). By utilizing GNN inference, the system can better exploit network structure, leading to smarter peer clustering and routing decisions.

It is important to note that integrating AI into a live network requires careful design: models should be lightweight to run on devices, and training should not overwhelm network resources. Techniques like on-device inference acceleration and performing training rounds only when devices are charging or under low load will be used. Moreover, the AI algorithms will be compliant with 3GPP's network automation efforts (e.g., NWDAF-Network Data Analytics Function in the 5G Core, which supports ML-driven analytics). The design effectively extends the concept of network analytics to the edge and device level, creating an intelligent cooperative network of peers. This aligns with the trend that 6G will embed AI/ML at every layer and node, moving toward an AI-native network.

To ensure the embodiments can be deployed in real networks, it is built to comply with and complement relevant 3GPP specifications:
Device-to-Device Communication (PC5 Interface): The PC5 interface enables direct communication between UEs without going through the base station for user-plane data. Initially developed for ProSe (Proximity Services) in LTE, it has been enhanced in 5G NR for uses like vehicle-to-vehicle (V2V) communication and vehicle platooning. Over PC5, UEs can communicate in or out of network coverage, with or without control from the network. For P2P streaming, PC5 is utilized in an in-coverage scenario with base station coordination for resource allocation (to avoid interference). 3GPP defines how UEs discover each other (via direct discovery announcements) and how the network can authorize and assist D2D links (e.g., by providing timing synchronization and allocating sidelink resource pools). These standard mechanisms are utilized so that any two users watching the same video (or subscribed to the same content service) in proximity can automatically discover each other and establish a secure P2P link. In embodiments, discovery and routing procedures may be performed based on an intent. The security and authentication procedures for PC5 (as per 3GPP specifications) will be honored, ensuring only authorized devices share content. For digital rights management (DRM)-protected media, the network and content provider maintain control over content access. In practice, media chunks are encrypted such that only devices with valid decryption keys (obtained through a secure license exchange with the content provider's server) can play them in embodiments, DRM may be based on or associated with a service level agreement. If one device shares a chunk over sidelink, the receiving peer must have already been authorized and acquired the decryption key to use that chunk. The P2P application server, which may take into consideration micro-SLA rules, (or a license server) coordinates with the IMS/core network to verify each user's content rights before enabling peer-to-peer transfer. In this way, the system's use of sidelink for content distribution does not bypass DRM restrictions-unauthorized devices cannot decrypt or view content even if they overhear it, and only legitimate subscribers can participate in P2P sharing of protected content. Essentially, the system rides on the existing LTE/NR sidelink channels with appropriate scheduling. This compliance ensures that the P2P traffic will coexist with regular cellular traffic, reusing uplink or dedicated sidelink resources as configured by the gNB (5G base station). Prior work on cellular D2D has shown that such reuse can greatly increase spectral efficiency if managed properly. The algorithms (especially the RL-based scheduler described above) aim to maximize these gains while controlling interference.

5G Service-Based Architecture (SBA, 3GPP TS 23.501): The 5G Core (5GC) introduced a service-based architecture where core network functions (NFs) expose services to each other via APIs, and new functions can be added more easily. This modular architecture allows third-party application functions (AFs) to interact with the core for capabilities like user traffic routing, policy control, and resource allocation all based on a micro-SLA in embodiments. An “Edge Content Distribution Function” may be integrated as an AF in the 5GC. This function interfaces with the Network Exposure Function (NEF) and possibly the Policy Control Function (PCF) to obtain network context (e.g., which UEs are in proximity, their subscription profiles for the P2P service) and to request certain treatment (like prioritizing sidelink resources for the service's traffic). It will also interact with the RAN (via defined interfaces or custom extensions) to collect radio metrics and facilitate device discovery, effectively acting as the orchestrator for the P2P overlay from the network side. Because it's built as a service-based function, it can scale and deploy on edge cloud infrastructure. From the devices'perspective, the system will be implemented mostly at the application layer (an app or service on the UE that handles P2P communication and AI logic), but with hooks into lower layers via standard APIs (for example, using the device's ProSe/V2X API to request PC5 links). By staying within the 5G architectural framework, the system coexists with other network services and can leverage features like network slicing (a slice or dedicated QoS flow could be allocated for P2P streaming traffic to guarantee performance).

3GPP 5G Multimedia Services (5GMS, TS 26.501 and related): The 5G Media Streaming architecture defines components like the 5GMS Application Function (AF) and 5GMS Application Server (AS) that work with the 5G core to enhance streaming. In the standard scenario, a 5GMS-AS might be a CDN or media server, and the 5GMS-AF interacts with the core for QoS and policy control. The P2P system can be seen as a logical extension or add-on to this architecture. It is assumed that there is an original content server (the origin or CDN that initially provides the multimedia stream), analogous to a 5GMS-AS. The difference is in the distribution method: instead of (or in addition to) delivering chunks directly from the server to all clients, clients share chunks among themselves. This coordination role is performed by a newly defined function termed the P2P Overlay Management Function (P2P-OMF), which resides either within the 5GMS-AS or as an adjunct AF module. The P2P-OMF is responsible for managing peer clustering, media availability tracking, and distributing P2P configuration parameters. The 5GMS-AF, which provides control-plane configuration to UEs (like which URLs/MPDs to use for DASH streaming), can be enhanced to provide a “P2P assist configuration”—instructing capable UEs to participate in P2P and providing any bootstrap information (like a group ID or content ID for discovery). This ensures that from the perspective of 3GPP standards, the solution does not break the existing model: essentially augmenting the delivery between the standard server and client with an overlay of sidelink transfers among clients. Notably, 3GPP Rel-17 has also worked on 5G multicast and broadcast (FeMBMS) for streaming, but that's a purely one-to-many downlink approach. The approach is orthogonal and can complement it: for example, a broadcast could deliver a base layer of a popular video to all users, while the P2P swarm delivers enhancement layers or less popular content among users.
IP Multimedia Subsystem (IMS) Integration: The IP Multimedia Subsystem is the core framework in 4G/5G networks for session control of IP services (commonly used for voice, video calls, and Rich Communication Services). In the design, IMS can be utilized for registering and managing the P2P streaming service at the control plane. In practice, when a user device wants to participate in P2P streaming, it can perform a service registration via IMS signaling. For example, the UE could send a SIP REGISTER message indicating its desire to use the P2P content sharing service (using a service profile or Public Service Identity for the P2P application) so long as its micro-SLA supports it. The IMS core (through the P-CSCF and S-CSCF) would route this to an IMS Application Server associated with the P2P service. The P2P application server (which may be the same as the P2P Orchestrator Server mentioned above, or interfaced with it) then authenticates and registers the UE for the P2P service, possibly checking the user's subscription or permissions. Once registered, the UE can join or initiate a P2P streaming session using IMS-based signaling. For instance, the UE could send a SIP INVITE (or a re-INVITE) to the P2P Application Server when it starts streaming a particular content; this invite might carry details like a content identifier or group ID. The Application Server, via IMS, can then coordinate session establishment: it could reply with information or trigger procedures that help the UE connect with peer nodes (for example, by invoking the content tracker function to get an initial peer list). Throughout the session, IMS can be used to convey control messages or updates—for example, if the user pauses the stream or moves to a new network, IMS can signal the P2P service to update peer relationships. IMS thus provides a robust control and signaling channel for the P2P system, leveraging existing operator infrastructure for authentication, authorization, and service provisioning. With the IMS core, the IMS core forwards this to the P2P Application Server (which acknowledges and sets up the user's service context), and subsequently the UE signals through IMS to join a content “swarm,” upon which the Application Server provides initial peer discovery information. By using IMS in this way, the solution can be offered as an operator-managed service with full support for carrier-grade features like user authentication (via SIM), billing, and policy control, all while the actual content exchange happens directly between devices or through edge servers as described.
6G Readiness: Looking ahead, 6G is expected to embrace even more device-centric and AI-driven networking. Key buzzwords include “self-driving networks,” “AI at the edge,” and extreme D2D communication for things like drone swarms, AR/VR glasses, etc. The architecture inherently moves in that direction by making devices more autonomous in content delivery and by embedding AI in the communication loop. It is reasonable to anticipate that 6G standards will explicitly support distributed learning across devices and more flexible peer-to-peer interactions beyond what is in 5G. In fact, it is projected that AI/ML will be integrated across all layers of 6G and in every protocol. Moreover, 6G might operate in new spectrum (e.g. mmWave, sub-THz bands) where cell sizes are small—P2P sharing between nearby users in those scenarios could dramatically improve coverage and throughput (one device can relay to another when the direct base station link is blocked or weak). 6G will also likely incorporate non-terrestrial networks such as satellite links. Certain aspects of the invention can extend to these environments; for instance, if 6G UEs are connected via a low-earth orbit satellite, clusters of users on the ground could still form a P2P mesh and share data, with the satellite acting as a high-latency link bridging distant clusters—and such may be supported given micro-SLAs among the devices on the ground. Scalability to massive numbers of devices is proposed (not just phones streaming video, but perhaps IoT devices sharing sensor media), focusing on dense network scenarios—a likely requirement for 6G. Security and trust are also paramount for open 6G ecosystems; by tying peer participation to subscriber identities and network authentication (potentially via SIM/IMS integration), the system lays a groundwork for secure P2P operation in future networks.
Microsoft's P2P Streaming Overlay (US 20100146092A1): This patent application (granted as U.S. Pat. No. 8,352,585) describes constructing a live streaming overlay using a directed graph model. It introduces protocols for peers to join and algorithms for optimized parent-child relationships in the overlay. The system uses an adaptive out-degree (peers with more capacity serve more neighbors) and a contribution-aware incentive mechanism. While innovative for its time (filed 2008), it relies on algorithmic rules (gossip-based membership and a fixed directed graph topology) and does not leverage any learning-based optimization. It's also focused on Internet streaming and does not mention mobile or 3GPP integration. The proposal differs by incorporating AI to adapt overlay connections on the fly and by specifically targeting mobile D2D links. Microsoft's overlay could be seen as a special case of the system without AI and without network awareness.
IMS-Based P2P Streaming and Download (U.S. Pat. No. 9,398,498B2 ): Intel's patent, granted 2016, teaches a mechanism for switching between unicast DASH streaming and a broadcast/multicast delivery using MBMS (Multimedia Broadcast Multicast Service). In this method, a “host” user equipment can set up a FLUTE (File Delivery over Unidirectional Transport) based multicast session to deliver content to other UEs after a SIP session is terminated, effectively turning a unicast session into a P2P multicast/broadcast. This is clever in using cellular broadcast (eMBMS) for offloading, but it's quite different from a mesh P2P approach—it's more of a one-to-many switch, not many-to-many sharing. It also requires IMS SIP session control and a BMSC (Broadcast Multicast Service Center) function. In contrast, the system uses many-to-many mesh sharing with possibly multiple peers concurrently exchanging different chunks. The sidelink interface may be used rather than the downlink broadcast channel, which gives more flexibility for two-way exchange and small group communication. Moreover, Intel's solution does not incorporate AI or learning; it's a procedural switch likely triggered by network conditions (e.g., a threshold number of users to justify broadcast). The solution could dynamically decide when to use direct sharing versus fall back to server or broadcast—a similar spirit of switching, but via learned policies rather than fixed rules.
Hybrid CDN-P2P with Tracker (Theta Networks Patents): Recently, Theta Labs has several patents (e.g., U.S. Pat. Nos. 11,659,015 B2 and 11,153,358 B2) on decentralized data streaming. They introduce a tracker server that coordinates a global cache network of viewer nodes and caching nodes, plus a cryptocurrency-based incentive/payment system. Theta's design is aimed at video streaming with edge nodes downloading from a CDN and serving viewers, selected by a tracker. This is somewhat closer in spirit to the proposal, as it mixes peers and servers. However, Theta's system still employs dedicated “Edge Cacher” nodes and a centralized tracker logic; it's not fully device-autonomous. They do not describe any use of machine learning to optimize peer selection; instead the tracker likely uses heuristics or simple rules (e.g., select cache nodes nearest to the viewer). Additionally, Theta's patents are not focused on mobile network standards or sidelink-they operate at the application level on the internet, with incentives to encourage participation. The approach removes the need for financial incentives by operating within an operator's domain and using network-level trust. The innovation of using AI at each peer and integrating with 5G control remains unique.
Network-Aware P2P Streaming (U.S. Pat. No. 9,432,452B2 ): This patent (2016) describes dynamic creation of P2P networks among clients receiving the same content, to offload a CDN. It suggests automatically identifying clients streaming the same video and letting them exchange data rather than all pulling from the CDN server. This is relevant: it essentially pre-empts the idea of ISP or CDN-assisted P2P. The patent mentions creating sub-networks based on trace routes or IP addresses, but does not detail mobile-specific considerations. This concept is extended by embedding it into the 5G network architecture and using AI to handle the dynamic nature.

In summary, prior patents cover bits and pieces: overlay construction, IMS-controlled unicast/broadcast switching, CDN offload by grouping users, and hybrid P2P networks with trackers. None have proposed an AI-augmented, fully distributed peer network that works within the cellular infrastructure. This is a clear gap. The system's patentable advancements likely include: (1) integration of FL/RL/GNN techniques in P2P overlay control for mobile streaming, (2) use of the 3GPP PC5 interface for content sharing in a multimedia context (prior ProSe use was largely for public safety or vehicular scenarios, not consumer media streaming), and (3) a combined architecture that yields a self-optimizing, standards-compliant P2P content delivery mechanism.

From the academic side, relevant work spans wireless caching, D2D content sharing, and AI for network optimization. Many works have explored D2D content distribution to improve spectral efficiency. For instance, Li et al. (IEEE Comm. Mag., 2014) discuss how device-to-device multicast can offload popular video traffic, forming clusters of users interested in the same content. Their focus is often on algorithms for cluster formation and power control to mitigate interference. These typically assume the cellular network assists in pairing users (which aligns with the approach), but they use heuristic clustering (like grouping by physical proximity or social ties). The use of GNNs could generalize and improve such clustering decisions by learning from data of successful transfers rather than using fixed rules.

Another area is edge caching and popularity prediction-where base stations or edge servers cache videos predicted to be popular in their area. Recent proposals apply federated learning to predict content popularity trends among users without violating privacy. Similar ideas are leveraged but at the device level; each phone might cache a few segments of a video in advance based on local predictions, to serve its neighbors. The novelty is that caching is cooperative: rather than each base station caching for its cell, each device caches pieces for its peer group. This “cache-as-you-watch” distributed approach hasn't been deeply explored yet. Some works on information-centric networking (ICN) for 5G/6G hint at named content that can be stored and retrieved from anywhere (including other users), but integrating that with AI-driven learning and real-time P2P coordination is new.

On the AI front, numerous works show the benefit of ML in wireless networks. For example, graph neural networks for wireless resource allocation have demonstrated the ability to learn efficient scheduling policies. Deep reinforcement learning for video streaming (e.g., Pensieve) has outperformed conventional ABR algorithms in Internet settings. Those concepts are brought into the device mesh scenario: each peer's streaming agent can be akin to a Pensieve agent but extended to decide not only bitrate but also which peer to fetch from. Similarly, using federated learning for distributed caching among users is cutting-edge; a 2022 work by Yan et al. proposes FL-LSTM for content popularity and shows close-to-optimal performance, which inspires the FL component.

Standardization-wise, 3GPP has technical reports on LTE Proximity Services and 5G enhanced D2D that discuss use cases like local video sharing (e.g., a group of people at a concert sharing video clips). They outline the need for discovery and security, which the design covers, but they do not prescribe the higher-layer behavior like chunk-sharing protocols. This leaves room for innovation in designing the application-layer protocol for the system (e.g., messages for peers to request segments, ACK/NACKs, etc.), which fit over PC5 transport. It can work over the sidelink logical channels defined by 3GPP (possibly using unicast sidelink traffic mode for one-to-one transfers, and groupcast if sending to multiple recipients).
To conclude the literature gap analysis: leading research is converging on the idea of distributed intelligence and D2D communication, but a comprehensive system that unites these for the specific problem of mobile video streaming is not yet realized. The proposal will be the first to demonstrate a working architecture meeting these criteria.

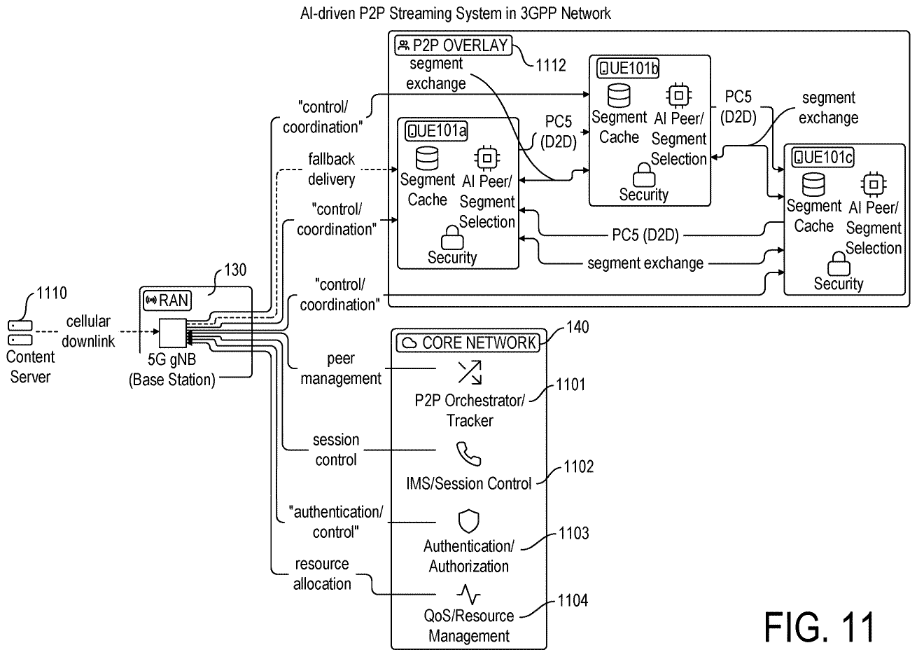

FIG. 11 illustrates an exemplary overall system architecture of the AI-driven peer-to-peer multimedia streaming system operating over a 3GPP network. The architecture includes multiple user devices (acting as peer nodes), a radio access network (RAN) node (e.g., a 3GPP base station or gNodeB) 130, and a core network 140 providing connectivity and control.

The core network 140 may be comprised of a P2P orchestrator/tracker 1101, an IMS/session control module 1102, authentication/authorization server 1103 and a QoS/Resource management module 1104. Each user device 101a, 101b, 101c is capable of both requesting and serving multimedia content to other peers depending on a micro-SLA. A peer to peer overlay 1112 facilitates efficient transfer and dissemination of trained AI/ML models among peers.

In the illustrated embodiment, a content source or streaming server 1110 is connected to the core network, providing an original media stream that can be distributed among peers. An AI controller (which may be cloud-based or part of the core network) is also shown, coordinating intelligent decisions in the system (such as peer selection or mode switching, as described later). The user devices communicate through the RAN 103 and core network to discover each other and exchange content. In some scenarios, direct device-to-device links may be employed (e.g., via a 3GPP side-link interface) when available, enabling efficient local content exchange. Overall,

FIG. 11 provides a high-level view of the system's entities and their interconnections, wherein the AI-driven logic embedded in the controller and/or devices oversees the peer-to-peer streaming process over the cellular network infrastructure.

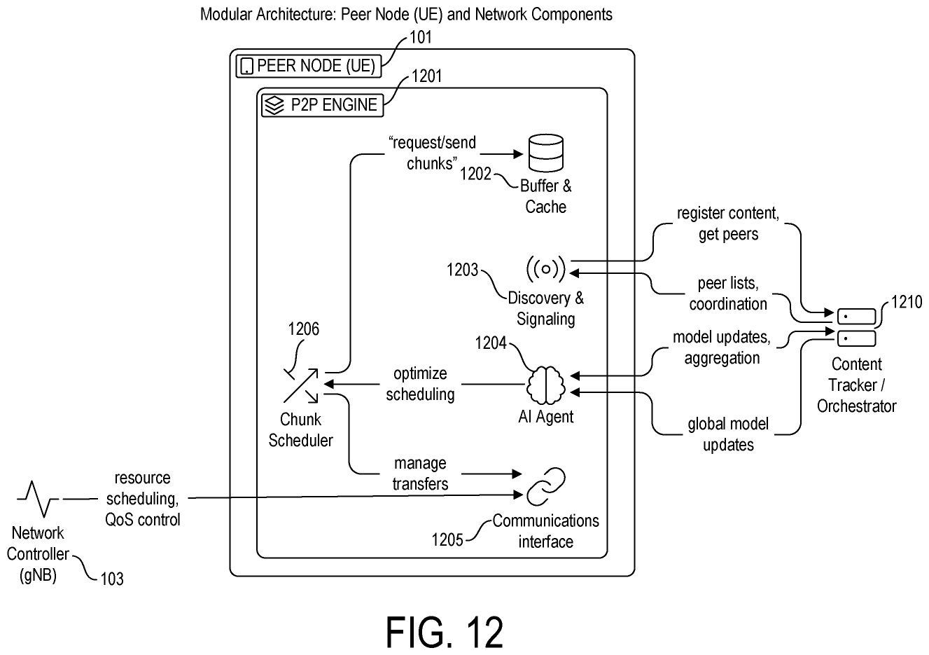

FIG. 12 is a block diagram detailing the system components and modular architecture of the peer-to-peer streaming system. In this diagram, each user device (peer) 101 is shown with a P2P engine 1201 having internal functional modules that enable P2P multimedia streaming. For example, within a representative device, a streaming client module handles media playback and buffering, a P2P communication module 1205 manages peer discovery, content requests, and data transfer protocols, and an AI decision module 1204 runs a local AI model to assist with decisions such as peer selection or bitrate adaptation. Additional components on the device may include a buffer manager 1202 for caching content segments, a chunk scheduler 1206 and a QoS monitor that tracks network conditions (e.g., signal strength, throughput, latency). A discovery and signaling module 1203 is employed to discover and initiate communications with other devices. On the network side, the RAN node 103 and associated core network functions include a peer coordination unit, which maintains information about which devices have particular content and facilitates discovery (this can be a logical function, such as a tracker or a directory service 1210, accessible via the cellular network). The core network or an application server may host a content directory or peer index database that the coordination unit queries during peer discovery. The figure shows interactions between modules—for instance, the AI decision module in the device receives inputs from the QoS monitor and uses them to influence the P2P communication module (such as selecting an optimal peer or adjusting delivery mode). Likewise, the peer coordination unit in the network exchanges signaling with the P2P module of various devices to distribute peer status and content availability information. The modular architecture illustrated in FIG. 12 emphasizes the separation of concerns: each component has a specific role, and together they cooperate to achieve efficient AI-enhanced peer-to-peer streaming over the 3GPP network.

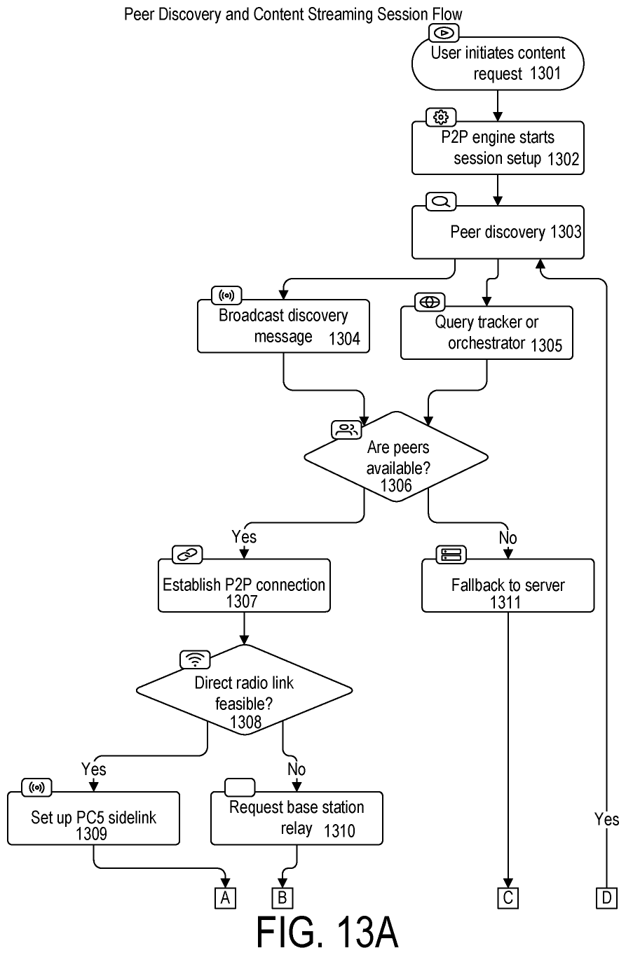

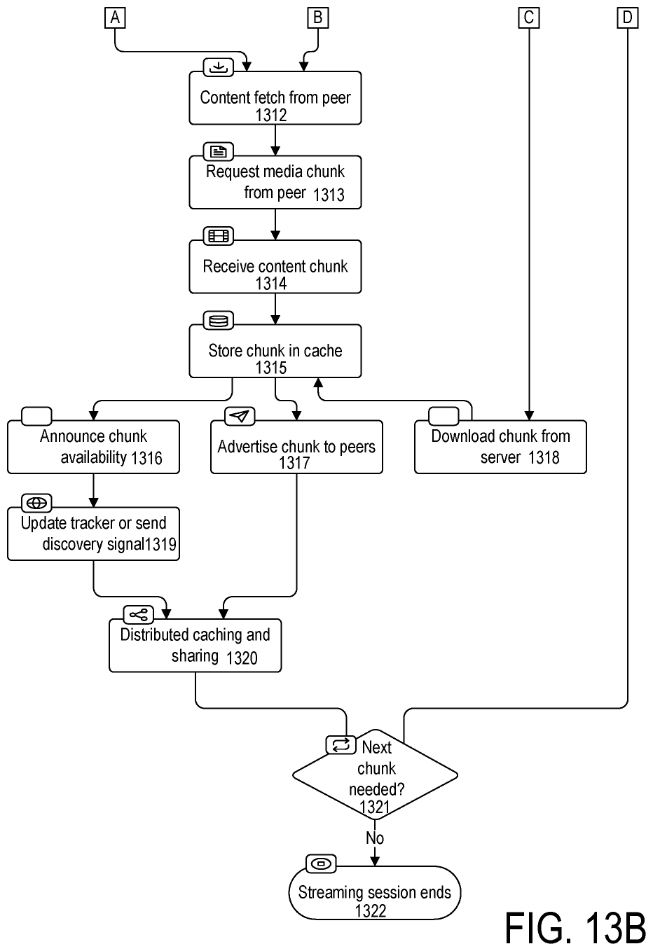

FIG. 13A and FIG. 13B (hereinafter FIG. 13) show a Peer Discovery and Content Streaming Session Flowchart

FIG. 13 is a flowchart illustrating an example peer discovery and content streaming session setup procedure in the system. The process begins at step 1301, where a requesting user device (peer) initiates a content request—for instance, a user device desiring a particular video stream triggers a Discovery Request message and the P2P engine session is setup 1302. At step 1303, the system performs peer discovery in accordance with micro-SLA of potential peer devices: the coordination service or nearby devices identify one or more candidate peer devices that have the requested content available (either fully or partially cached) and have a sufficient micro-SLA (or potentially the SLA is adapted). A discovery request 1304 is transmitted over the network (via the base station) to either a central peer coordination service or broadcast to neighboring peers, depending on implementation. Alternatively, or in combination, a tracker is used 1305. A Discovery Response is returned 1306 to the requesting device, containing information such as identifiers or addresses of candidate peers that can serve the content, and possibly metadata like content segment availability and peer link quality. Next, at step, the requesting device selects a suitable peer from the candidates (this selection may be based on criteria like proximity, signal quality, or an AI-provided ranking) and sends a Session Setup Request to that peer to initiate a streaming session 1307. Step entails a handshake between the two devices (through control signaling via the RAN or directly if in proximity 1308), negotiating parameters such as streaming bitrate, transport protocol, and buffering requirements. Once the target peer accepts the request, the content streaming session is established via PC5 1309 or via base station 1310. Alternatively, if no peers are available, then a server fallback is employed 1311 for download 1318.

Beginning on FIG. 13B, the fetched media content 1312 (video or other multimedia segments) is requested 1313 and delivered 1314 from the serving peer to the requesting peer, either directly over a device-to-device link or routed via the base station, and the playback begins from storage in cache 1315. The chunk availability may be announced 1316 and advertised to peers 1317. The tracker may be updated 1319 and distribution caching and sharing may be continued 1320. The flowchart concludes at end block 1322 after no further chunk is needed 1321.

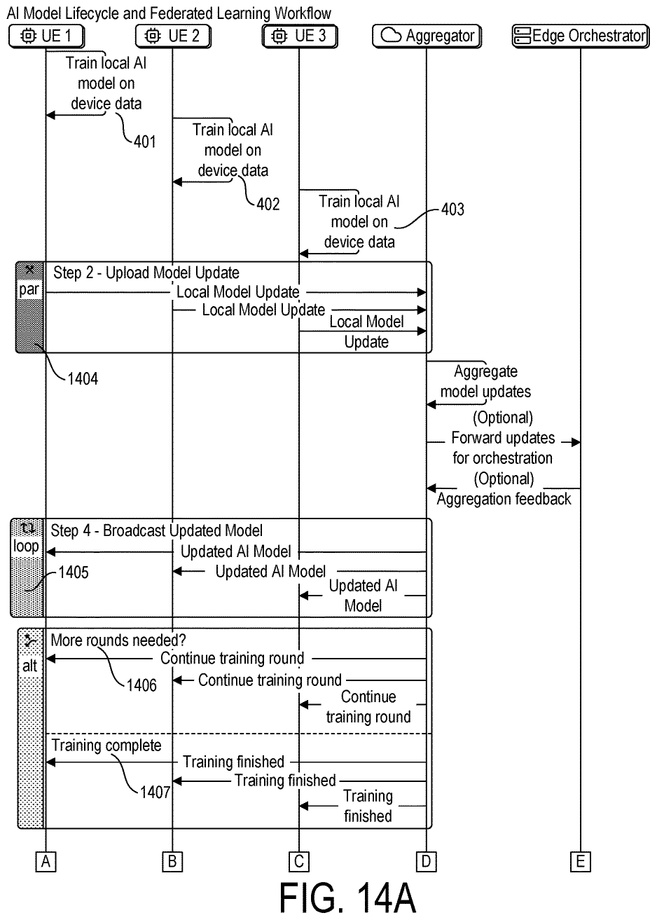

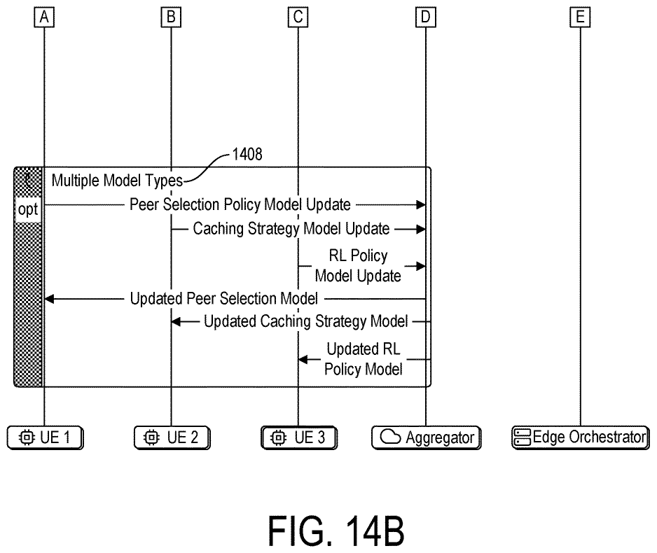

FIG. 14A and FIG. 14B (FIG. 14) show an AI Model Lifecycle and Federated Learning Workflow.

FIG. 14 depicts the AI model lifecycle and an exemplary federated learning workflow incorporated into the peer-to-peer streaming system. The lifecycle begins with a global AI model that is trained on an initial dataset (for example, using historical network and streaming performance data). This trained model is then distributed from a central training server or AI controller to multiple user devices in the network. At the device side, the model is deployed as a local instance within the AI decision module, where it is used during runtime for making streaming decisions (such as predicting the best peer or optimal delivery mode under current conditions). As users engage in streaming sessions, each device continually collects local data about its experience: network metrics, peer responsiveness, video quality, congestion events, etc. Instead of sending raw data back to the server, each device periodically uses this local data to train 1401-1403 or fine-tune its local AI model, improving the model's performance on that device. At designated intervals or when certain conditions are met, the devices participate in a federated learning cycle: as indicated, each device uploads 1404 an AI model update (e.g., refined model parameters or gradients, not raw user data) to the central AI controller or aggregator. The aggregator combines the updates from many devices to produce an updated global model; this may involve averaging model weights or using more sophisticated federated averaging algorithms known in the art. The updated global model is then redistributed 1405 to the user devices, replacing or updating the previous model on each device, thereby completing one round of the federated learning loop. FIG. 14 also highlights the continuous nature of the AI model lifecycle: the model undergoes deployment, inference, feedback, and update in successive cycles 1406, allowing the streaming system to learn and adapt over time and may also adapt an SLA or form new ones. This distributed learning approach enables the AI models to improve prediction accuracy (for peer selection, network condition forecasting, etc.) across the network without centralizing sensitive raw data, thus efficiently leveraging collective insights from all participating peers. The aggregator may indicate to UEs that training is complete 1407. In embodiments, there may be a multiple model type procedure 1408 performed wherein each UE provides information about different model types. In the procedure shown at FIGS. 14B, 1408, UEs may receive information about particular model types.

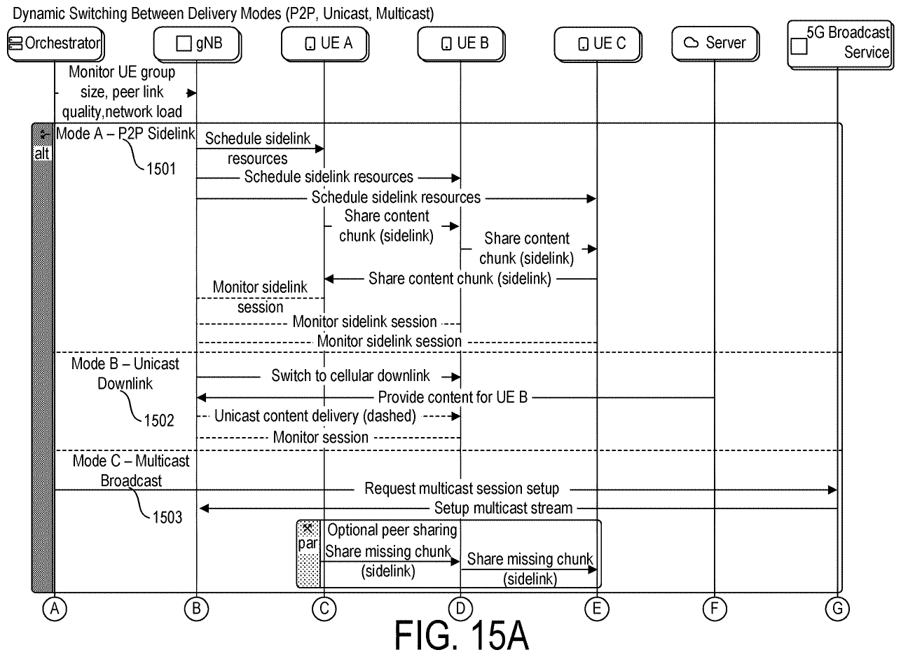

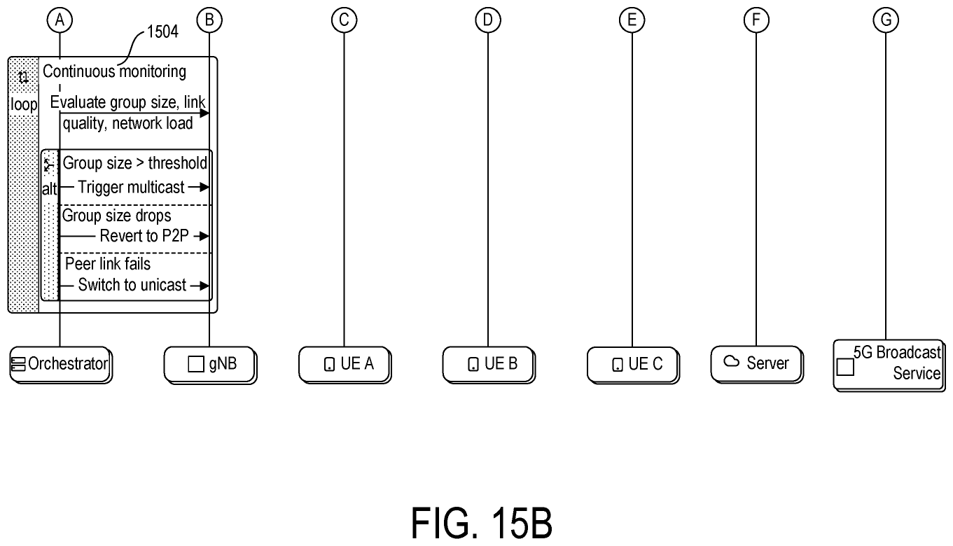

FIG. 15 shows a schematic diagram of dynamic switching between multiple content delivery modes—peer-to-peer, unicast, and multicast—in the streaming system. In the illustrated scenario, a user device can receive multimedia content through different delivery mechanisms, and the system intelligently switches among these modes to optimize performance and resource usage. Initially, the device may obtain content via P2P delivery 1501, wherein another peer device (acting as a content source) streams the media over a peer-to-peer link (either directly or relayed by the base station). If the serving peer becomes unavailable or network conditions degrade (for example, the peer goes offline or the P2P link quality drops), the system seamlessly transitions to a unicast mode 1502: the requesting device then fetches the remaining content from a centralized streaming server or content source through a traditional client-server unicast connection over the cellular network. Conversely, if multiple user devices in the same cell or area request the same content around the same time, the system can invoke a multicast/broadcast mode 1503 (leveraging 3GPP multicast delivery, such as LTE/NR eMBMS or 5G broadcast, if supported). In this mode, the base station transmits the content once to serve all those devices concurrently, rather than handling separate unicast streams or relying on P2P connections. FIG. 15 illustrates the decision logic that governs these switches: an AI-driven delivery controller (which could be part of the AI controller or distributed among devices) monitors real-time factors like peer availability, number of interested receivers, radio link quality, and network load. Based on predefined rules or AI predictions, the controller triggers a switch to the most efficient delivery mode. Continuous monitoring 1504 may be performed and transitions include from P2P to unicast or from P2P to multicast, when certain thresholds or conditions are met. Through this dynamic mode switching, the system ensures robust streaming: it maximizes P2P usage when beneficial, falls back to unicast for reliability, or employs multicast for efficiency, all transparently to the end-user.

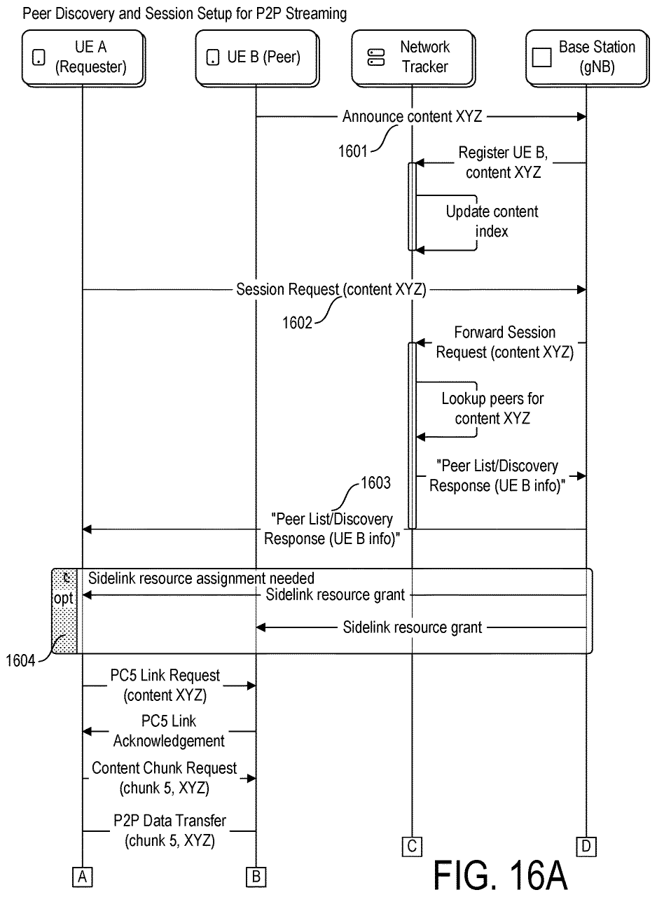

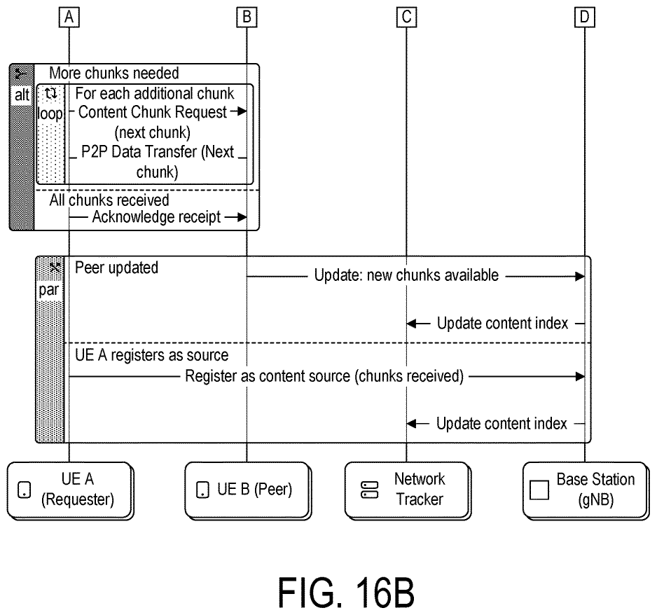

FIG. 16 illustrates an example sequence of control messages exchanged for peer discovery and session setup in the P2P streaming system over a 3GPP network. The diagram is organized along timelines for three principal entities: the requesting user device (Peer A), a network node or coordination function (e.g., base station and/or a peer discovery server in the core network), and the content-providing peer (Peer B).

At message, Peer A sends a Peer Discovery Request 1601 (for a specific content) upward to the network-this may be implemented as an application-layer request tunneled via the base station or a specialized discovery request following 3GPP service protocols. The network processes this request and at message 1602 forwards a discovery query or broadcast to potential peers in the vicinity (for instance, the base station might broadcast a notification within the cell to discover which devices have the content, or a server might query a directory of content holders). Next, at message, Peer B (which has the requested media content) responds with a Discovery Reply 1603, indicating its willingness or ability to share the content (this reply is sent via the network to ensure it reaches Peer A, unless a direct D2D discovery channel is available). The network passes this information back to Peer A at message in the form of a Discovery Response containing Peer B's identity (and any needed connection info or security credentials). Upon receiving the peer information, Peer A proceeds to set up the streaming session: at message, Peer A sends a Session Setup Request (e.g., a handshake message to initiate a streaming connection) directed to Peer B (often routed through the base station if a direct link is not yet established). Peer B, upon receiving the setup request, returns a Session Acknowledgment/Acceptance at message, confirming that it is ready to stream the content. With this handshake complete, the data path for the media session is established at step this could involve the allocation of radio bearers for a direct device-to-device link or setting up appropriate tunnels if the content will flow via the network. Finally, at message, the actual content stream (data packets containing the multimedia content) begins to flow from Peer B to Peer A. FIG. 16 thus details the step-by-step signaling involved in discovering a peer content source and negotiating a session, ensuring that both peers and the network are coordinated before the streaming data transfer commences.

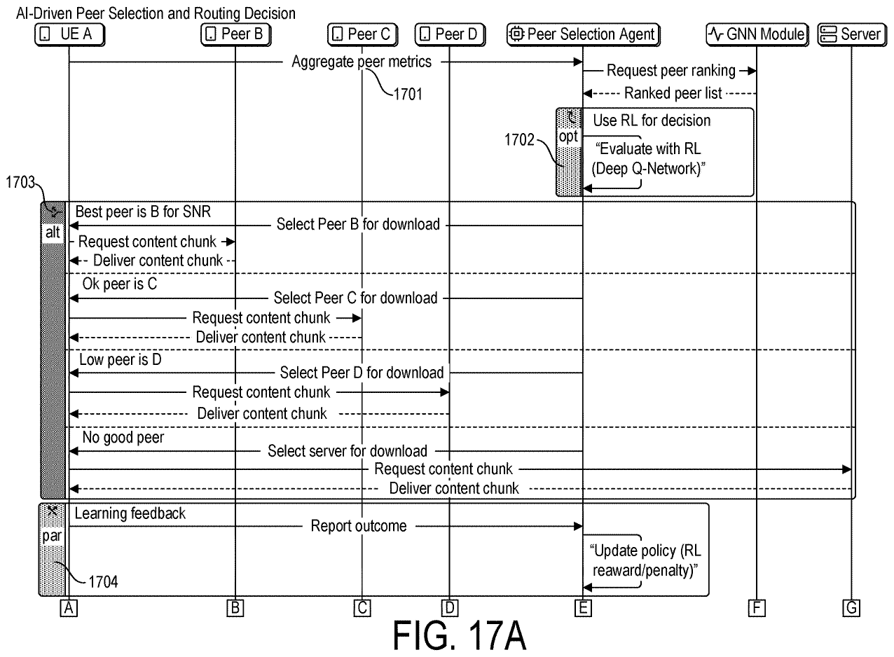

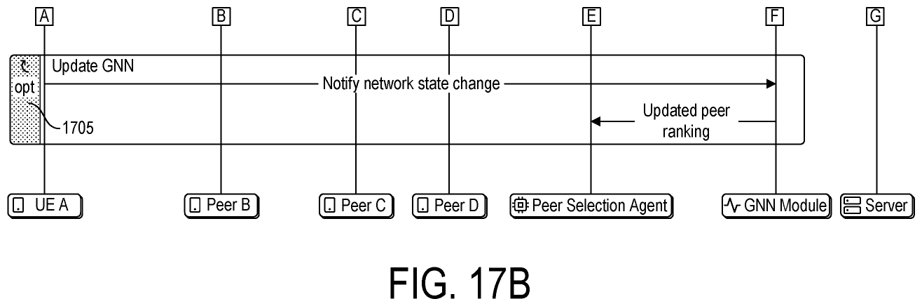

FIG. 17 illustrates an AI-driven peer selection and routing decision mechanism employed by the streaming system to enhance content delivery efficiency. The diagram presents a decision engine or AI module that is responsible for evaluating potential content sources (peers) and determining the optimal way to route the content to the requesting device. In this embodiment, when a user device requests a stream, the AI module (which may reside in the device, in the network, or be distributed) gathers context information from various sources: for instance, it obtains network state data (such as current RAN conditions, signal quality, and congestion levels for the device), peer status information (e.g., a list of peer devices that have the content along with their battery levels, link quality, and availability), and any historical or learned performance metrics (such as past throughput achieved from certain peers or prediction of stable connection duration), hereinafter peer metrics 1701. Using this input, the AI decision engine evaluates 1702 each candidate peer against multiple criteria. In the figure, three peer options (Peer B, Peer C, Peer D) are scored or ranked. For example, Peer B might have the strongest signal but high load, Peer C has moderate signal and is under light load, and Peer D has a sufficient cache of the content but is moving at cell edge. The AI algorithm (which could involve a trained neural network or heuristic model) processes these factors and selects 1703 one or more of the peers most likely to provide the best streaming experience. Once a peer is selected, the AI module also decides on the routing method for the content: whether to establish a direct device-to-device link (if supported by the network as a proximity service) or to route the stream through the base station and core network (if direct link quality is uncertain or not permitted). Communications with a selected Peer may be via the determined path (either direct or network-assisted). In addition, the AI module can continuously or periodically re-evaluate its decision, allowing dynamic switching of source or path if conditions change during the session. Through this AI-driven peer selection and routing mechanism, the system intelligently connects users with the most appropriate content source and delivery path, improving throughput and reliability in the peer-to-peer streaming network. Based on learning feedback 1704, a GNN may be updated 1705 as shown in FIG. 17B.

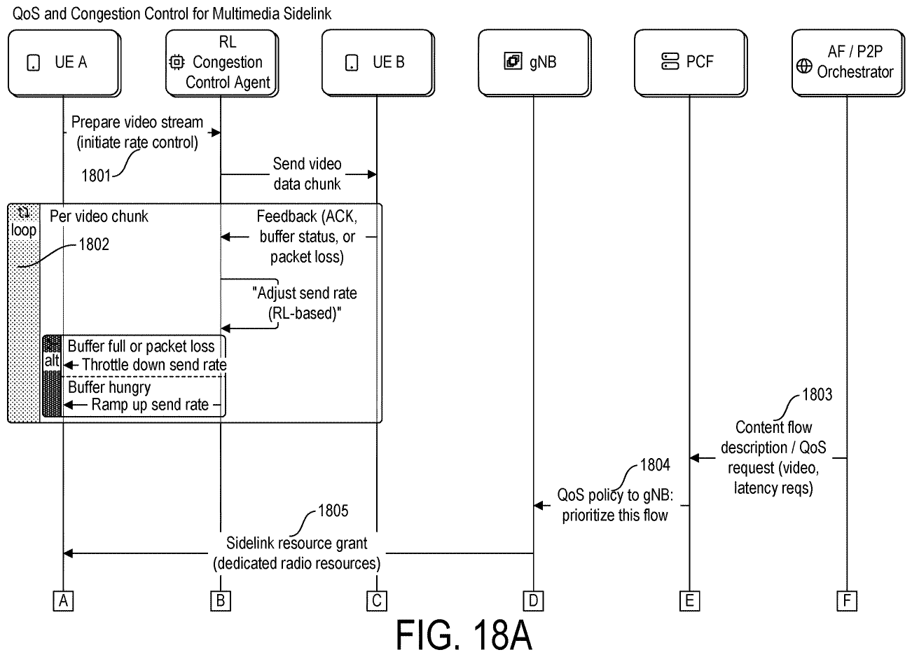

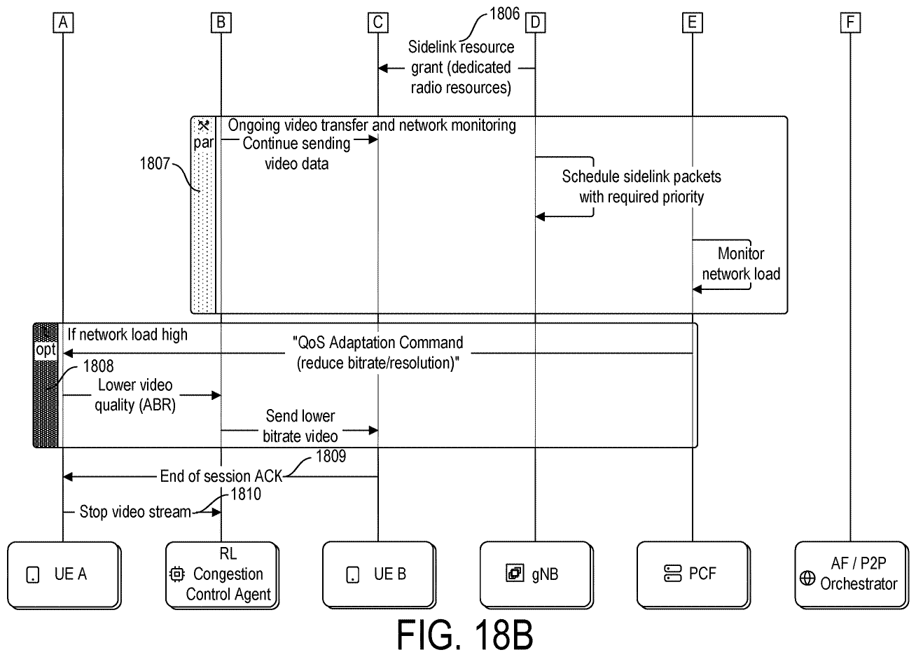

FIG. 18 depicts the quality of service (QoS) management and congestion control mechanisms integrated into the peer-to-peer streaming system to maintain stable performance over the 3GPP network. The diagram shows a feedback-loop architecture between the network and the peer devices to ensure streaming quality. At the center, a network node (such as the base station or a core network controller) includes a congestion detection module that continuously monitors network load and radio link conditions—metrics like throughput per user, buffer status reports from devices, and overall cell utilization. When this module detects emerging congestion or QoS degradation (e.g., high packet loss or buffer buildup indicating that a peer-to-peer transfer is overwhelming the cell capacity), it generates a congestion alert. This alert is sent to the involved user devices. Upon receiving a congestion or QoS control signal, each device's local rate adaptation and QoS module takes responsive action. For instance, the sending peer (peer streaming the content) may throttle its upload rate or temporarily reduce video quality (such as switching to a lower bitrate segment), and the receiving peer may adjust its buffer strategy or request a quality change, thereby alleviating network strain. Additionally, FIG. 18 shows that the system supports prioritized communication channels for control versus data: critical control messages like congestion alerts or rerouting instructions are transmitted with higher priority (or via reserved RRC signaling) to ensure they are promptly delivered even under load. The figure also illustrates an AI-enhanced QoS predictor (optionally part of the AI controller) that can anticipate congestion based on patterns (for example, predicting a spike in traffic) and proactively instruct devices to preemptively adjust rates or switch delivery modes. All these mechanisms work together in a closed-loop fashion: the network observes performance and informs devices, and devices react to control their transmission behavior, which in turn improves the network conditions. Through the procedures shown in FIG. 18, the peer-to-peer streaming system maintains smooth playback and fair resource usage, dynamically controlling congestion and upholding QoS targets even as multiple peers share the 3GPP network.

Specifically, UE A prepares a video stream 1801 and sends chunk(s) to another UE. A feedback loop 1802 is used to provide feedback (ACK, buffer status or packet loss information) to a congestion control agent which provides feedback to the sending UE. A P2P coordinator may provide a content flow description 1803 to the PCF which provides priority information 1804 to the gNB serving one or more of the UE(s) such that the UE(s) receive sidelink resource grant(s) 1805, 1806 accordingly. The system continues video transfer and network monitoring 1807. If network load is high 1808, then video quality may be adapted, e.g. it may be lowered. Once the session end is acknowledged 1809, the video stream 1810 and transmission cease.

The proposed system is a hybrid P2P streaming architecture deployed in a mobile network environment. It includes mobile user devices (UEs) that form a P2P overlay for sharing multimedia content, and network-side components that facilitate this overlay. The design is modular, consisting of distinct functional components that interact via defined interfaces (some standard, some new). Devices may communicate directly (over sidelink) and with the core network support for control and coordination.

At a high level, the system works as follows: when a user requests a video stream (e.g., an on-demand video or a live event), the system first checks if nearby peers have the content (or relevant segments) available. This check is performed by the device's P2P engine querying its discovery information or a network index: for example, the UE may send a small request to the tracker function in the network indicating the desired content, or it may have received announcements from peers advertising which chunks they hold. Using either method (network query or local peer discovery), the UE determines whether one or more peers in its vicinity possess the needed data. If yes, the user's device will fetch segments from those peers over a direct sidelink connection; if not, it will fetch from the original server or CDN through the normal cellular downlink. In cases where a peer is identified but a direct radio link is not viable (e.g., slightly out of range), the system can fall back to using the standard network path (the peer's data would travel via that peer's uplink and the requester's downlink, effectively using the base station as a relay), though the primary mode is via direct sidelink to minimize core network use. As peers receive segments, they cache them temporarily and announce their availability to other peers, creating a distributed cache among users. An orchestrator (tracker) function helps peers discover each other and coordinates the overall distribution; this function can be partially centralized as a network AF (application function) in the core, but it does not handle actual media data-peers exchange data directly. Throughout this process, AI algorithms running on the devices and in the network continuously learn and optimize performance: choosing optimal peer partners, deciding which content to cache at which node, and allocating resources to meet QoS targets. The architecture is designed to manage these tasks while addressing challenges like peer churn, variable mobile signal quality, and device energy limits.

Key design principles are modularity and layered control: the heavy data plane (actual media chunks) is handled in a distributed way by the peers, while the control plane (peer discovery, analytics, coordination) is assisted by the network infrastructure. The operator's network provides crucial assistance, such as maintaining a registry of content availability, scheduling sidelink resources, and enforcing policies (like DRM or usage policies), to ensure the P2P swarm operates efficiently and securely within the cellular system.
Peer Node (UE) with P2P Engine: Every participating user device runs a P2P engine application (at the application layer). This software module manages chunk requests and uploads, maintains a list of known peer partners, and runs local AI agents that make decisions. Sub-modules of the P2P engine include:
Buffer & Cache: Stores recently downloaded chunks and possibly future chunks (prefetched data). A portion of this cache is made available for upload to other peers. The caching policy is adaptive—for example, it might keep high-value chunks (like the most requested segment in the last minute) longer if storage permits, and it might evict or compress older chunks as needed. This module ensures that once a device has downloaded content, it can serve as a source for others for some time.
Discovery & Signaling: Handles announcing the device's presence and the availability of certain content chunks to nearby peers. In one embodiment, this uses a lightweight discovery protocol over a direct device-to-device link (such as the 3GPP PC5 sidelink interface). For instance, it could build on the ProSe direct discovery messages defined by 3GPP, extended with application-specific info like “I have chunks X, Y, Z of video ID W”. Alternatively or additionally, discovery can be assisted by the base station broadcasting a “matchmaking” signal to users interested in the same content (for example, the gNB could periodically transmit a list of content IDs that have active sharers in the cell). The discovery subsystem ensures that when a UE joins a streaming session, it can find others in proximity for potential sharing.
Communications Interface: Responsible for establishing and maintaining P2P communication links to peers. For direct D2D, this means setting up PC5 sidelink connections with chosen peer devices. The P2P engine's communications module interfaces with lower-layer radio APIs to configure sidelink channels (for example, using sidelink unicast RLC channels as specified in 3GPP). It abstracts the complexity of the D2D radio, presenting a socket-like interface to the higher P2P logic. Thus, to the P2P engine, sending a chunk to peer B is handled similarly to sending data over a TCP socket, although under the hood it uses a specialized sidelink transport.
Chunk Scheduler: Decides which chunk to request next and from whom, and coordinates parallel downloads. For instance, akin to BitTorrent, the engine can request different chunks from different peers concurrently to maximize speed. It also decides which peer gets upload priority if multiple neighbors request data-possibly implementing a reciprocal fair sharing (tit-for-tat) mechanism to incentivize cooperation. The scheduler may also obey network-imposed rate limits or priorities (e.g., the network could signal that uploads should not exceed a certain rate to preserve uplink capacity).
AI Agent(s): This includes the on-device intelligence, such as RL agents for peer selection or bitrate selection, and local inference using GNN or other models to estimate network conditions. The agent observes metrics (throughput from each neighbor, chunk loss or delay statistics, battery levels, etc.) and takes actions (e.g., switch to a better peer, request a particular chunk from a specific neighbor, adjust sending rate on a link, or choose a lower bitrate for the video). The agent's policy is periodically updated either via on-device learning or via federated learning rounds coordinated by the orchestrator (described below). Through continuous learning, the AI agent improves the peer's decisions over time.
Content Index & Tracker (Network AF): This is a logical function in the network (likely an edge cloud or core network service) that keeps track of which peers have which content chunks and relevant micro-SLAs, and helps peers find each other—similar in spirit to a BitTorrent tracker, but implemented within the operator's network for awareness and control. When a peer joins a streaming session, it notifies the tracker about its interest in “content XYZ” (this could be a simple HTTP API call to the AF via the NEF, or a SIP message if using IMS signaling). The tracker records the peer's participation and the chunks it has (initially none, or some if it joins mid-stream), and returns a list of nearby peers (e.g., in the same cell or region) that are also in that session. The response might include each peer's reachable address or a temporary identifier for direct connection (such as a ProSe Peer ID or a temporary session token). A temporary identifier could be, for example, a short-lived numeric ID assigned by the tracker to each peer in the session, or a hash of the device's subscription ID, which peers use to address each other without revealing phone numbers or permanent IDs. This allows the requesting UE to connect to those peers over the sidelink or other channels. The tracker can be decentralized—for example, there could be one instance per cell or region to avoid a single point of failure and to minimize lookup latency. The tracker also gathers statistics: how many peers are in a swarm, which chunks are most replicated, etc. These stats can feed into network decisions (like whether to proactively cache certain content at the edge if P2P is insufficient). Notably, the tracker enforces operator policies: for instance, the operator might configure the system to only enable P2P sharing if at least 3 users in a cell are watching the same video (to avoid wasting device battery and radio resources when there's no real benefit). Such thresholds or criteria are set as policy by the operator or content provider and are applied by the tracker when deciding whether to facilitate P2P for a given content.
Network Sidelink Controller (gNB function): At the RAN (Radio Access Network) level, the base station (gNB) includes a scheduler that controls radio resource allocation for uplink, downlink, and sidelink. For the system, the base station is enhanced with logic to manage sidelink resources for P2P streaming. This could be part of the existing Radio Resource Management (RRM) function but guided by the orchestrator's needs. For example, if 10 UEs in the cell are actively doing P2P streaming, the base station may allocate a certain chunk of subchannels or timeslots specifically for their sidelink transmissions, to avoid collisions with regular traffic. This component ensures that P2P data transfers do not negatively impact other users (and vice versa). It can also leverage proximity information: if two devices are very close to each other, the base station might allow them higher transmit power or aggressive frequency reuse on sidelink, knowing their interference footprint to others is small. The design can use either Mode 2 (autonomous sidelink resource scheduling by UEs) or Mode 1 (centralized scheduling by gNB) as defined in 3GPP sidelink standards; gNB-scheduled (Mode 1) operation is preferable for reliability in coverage, with an option to fall back to autonomous Mode 2 if the network is unavailable or too busy (particularly relevant for out-of-coverage scenarios, though the primary focus is in-coverage use). The network can also signal QoS requirements via PC5 QoS flows for the P2P session, ensuring the radio treats video chunks appropriately (e.g., assigning a high priority QCI for real-time video segments exchanged over sidelink).
Content Server/CDN Origin: This is the original source of the multimedia content. In typical operation, it could be a video server in the cloud or at the network edge that provides video segments via standard protocols like DASH or HLS. In the system, the content server is augmented to be aware of P2P offloading. For instance, it might embed metadata in manifest files indicating that P2P sharing is available for this content. If none of the peers have a given segment (e.g., the first user to request the content will obviously need to get it from the server), the server serves it as usual. As more peers join and share, the server will see fewer direct requests. In some embodiments, an edge cache may be deployed at the base station or MEC which acts as a seeder (an initial peer) for popular content. For example, the operator might preload some segments of a trending video in a base station cache, which then behaves like another peer with very high bandwidth in the swarm. This hybrid approach (peers+an edge cache peer) maximizes efficiency and ensures that even if user devices have not yet fetched a chunk, the local network could supply it quickly. In such a setup, the base station or edge cache uses its local storage and backhaul connectivity to contribute chunks. It would utilize normal downlink transmissions (or potentially a special sidelink role, if defined) to send data to UEs, effectively acting as a super-peer. The base station leverages its ample resources—high throughput and low latency to the users—to guarantee that at least one reliable source for each segment is present in the swarm. Notably, this base station “peer” would draw on the operator's backbone or content delivery network to get content ahead of time, then serve it over the air interface, relieving the core network once peers begin sharing among themselves.
Security and Permission Module: Since P2P can raise content rights and security issues, a module to handle encryption and rights management of content is disclosed. One approach is to have all content pieces encrypted end-to-end, such that only authorized clients (who have obtained the decryption key or license from the content provider after authentication) can decrypt and play them. Peers then exchange encrypted chunks; even if intercepted by an unauthorized party, the content remains protected. This module deals with key exchange and license acquisition, likely leveraging existing 5G security infrastructure—for example, a UE could fetch a DRM license or decryption key from the content provider's license server over a secure connection (perhaps during the initial content request or via a pre-provisioned key). The module also ensures that malicious peers are detected and isolated. For instance, if a peer consistently sends corrupted data or incorrect chunks (“gibberish”) instead of the real content, the receiving peer can drop that connection and report the misbehavior to the tracker or network controller. Such a report could be a secure message to the P2P orchestrator indicating the offending peer's ID and the nature of the issue. The network can then blacklist that peer or revoke its ability to participate further. Redundancy and hash-checking (as used in BitTorrent) is employed for integrity-every chunk has an associated checksum, so peers verify that received chunks match the expected hash, detecting tampering or errors. Identity management is tied into the existing telecom security: each peer's P2P identity can be associated with its SIM/eSIM identity or network subscription. For example, an operator could provision the user's SIM profile with credentials or an application identifier for the P2P service (GSMA's standards for eSIM allow downloading such service profiles). This means when a device joins the P2P network, it could authenticate using SIM-based keys, and the network can trust that the peer corresponds to a legitimate subscriber. By tying peer IDs to SIM/eSIM identities, a root of trust is established—an advantage the system has over open Internet P2P, where peers are often anonymous. In practice, this could work as follows: during IMS or network registration for the P2P service, the network issues the device a unique P2P peer identifier (or certificate) linked to its subscriber ID. That identifier is used in the P2P swarm and assures others (and the tracker) of the peer's authenticity. This greatly reduces the chance of rogue devices participating, and if a security issue arises with a particular peer, the operator can trace it to a subscriber and take action.

Modularity ensures each piece (device software, network AF, base station scheduler, etc.) can be developed and improved independently, and the system can degrade gracefully. For example, if the AI agents fail or are temporarily turned off, the system should still function using baseline heuristic algorithms (e.g., always choose the peer with the highest signal or lowest recent latency). Conversely, if the network assist is minimal (say the system is deployed in an unmodified LTE network that doesn't explicitly manage sidelink), the peers can rely on more ad-hoc discovery methods (like falling back to Wi-Fi Direct or Bluetooth for discovery if PC5 isn't available).
Session Initiation: A user opens the streaming app and requests a video or live stream. The app contacts the content server for the manifest (e.g., a DASH MPD file or HLS playlist) as usual. The manifest may be augmented with a pointer to the P2P tracker or include a flag indicating that P2P sharing is enabled for this stream, along with a content identifier that the P2P engine can use.
Tracker Registration & Discovery: The device's P2P engine registers with the tracker AF (network-based tracker) by sending its user ID (or an anonymized temporary ID) and the content ID it wants to join. Notably, the UE does not need to explicitly report its location or cell—since the request reaches the tracker through the network, the tracker can infer the cell or region (via the source IP or through NEF which provides location info). The tracker records the device in the swarm and returns a list of peer IDs in the vicinity that are also streaming the same content (or have recently streamed it, if this is VOD). It may also provide an identifier or address for each peer so the UE knows how to contact them. If the tracker finds that no other peers are yet present (i.e., this device is the first viewer in this area), it will inform the device that it is initially alone. In that case, the device knows it must fetch from the server initially and will act as the seed peer for others who join later. There may be policy thresholds applied here: for example, the tracker might decide to enable P2P only if at least one other peer is available or if certain criteria are met (as discussed, e.g., a minimum of 3 peers in area).
Content Fetching (Hybrid P2P/Centralized): The device begins fetching video segments. For each segment, it will try P2P first if any peers have announced that segment. Suppose for the very first segment of the video, no peer has it (because the device might be the first user or the content is live and just starting). In that case, the device retrieves segment 1 from the content server over the downlink. Once it has this segment, it notifies the tracker (or directly notifies nearby peers via a short-range broadcast on PC5 or a unicast message) that “Peer X has segment 1 of content Y.” Meanwhile, as soon as segment 2 becomes available (either because the server provided it or if another peer got it), the device will attempt to get segment 2 from a peer if possible. For instance, it might fetch segment 2 from the server concurrently while another peer (if present) supplies segment 1, or vice versa. In practice, ‘segment 2’ refers to the next time chunk of the video. Each segment is generally fetched from one source to keep things simple and efficient. However, the system could allow splitting a segment among multiple peers to speed up download (each peer sends part of the data), or use layered video coding where one peer could send a base layer and another an enhancement layer of the same segment to combine for higher quality. These advanced strategies are optional—the primary approach is one full segment per source at a time-but they illustrate how the design can accommodate even greater parallelism or quality boosting if needed.
P2P Sharing Between Peers: Now assume a second user in the same cell starts the stream slightly later. When this User 2 requests the content, it goes through the same registration and gets informed by the tracker that User 1 (the first user) has some segments (say segment 1, and maybe segment 2 if user 1 has fetched that by the time user 2 starts). The two devices then establish a direct connection (after discovery). They perform a quick handshake over PC5—this could involve exchanging a security token to verify each other (perhaps issued by the tracker) and agreeing on QoS parameters or a channel for the link. Once the sidelink between User 1 and User 2 is set up, User 2 can request the already-downloaded segments from User 1 instead of the server. For example, User 2 might immediately request segment 1 from User 1 and concurrently start downloading segment 2 from either User 1 (if available) or from the server. They will pipeline this process—while User 2 is retrieving segment 1 from User 1, it might simultaneously fetch segment 2 from the server (since User 1 didn't have segment 2 yet when User 2 started). As more users join, this mesh network of peers grows. Each peer uses its peer selection algorithm (potentially AI-driven) to decide whom to ask for a given segment, considering who has it and the quality of those links. If a peer fails or leaves mid-stream, the requesting peer will gracefully switch to another source (with help from the tracker if needed to find alternates). The content server remains a fallback source at all times.
AI Optimization Loop: During streaming, suppose the initial peer selection choices are not optimal (maybe Peer A chose Peer B as a source, but Peer C would have been faster). The RL agent on Peer A will observe the actual throughput from Peer B is lower than expected and may decide to explore a switch to Peer C for the next chunk. Over a few segments, the agent learns which neighbor tends to offer better performance under current conditions. Simultaneously, all peers might periodically report stats (like achieved throughput, latency, etc.) to the tracker, which runs a federated learning aggregation to improve a global model. For instance, an FL round might produce a neural network model that can predict chunk download time given certain features (peer signal strengths, network load, etc.), and that model is sent back to all peers. Each peer's AI agent can use such a model to refine its decisions (e.g., predicting which peer will likely send a chunk fastest). Thus, the system improves over time, even adapting to diurnal changes (at night fewer users, etc.), network load changes, or new peer behaviors. This continuous learning framework allows the swarm to optimize itself as conditions evolve.
Congestion and QoS Control: If the cellular cell becomes congested (for instance, if there is too much sidelink usage or the base station senses the uplink is being heavily utilized for P2P), the base station can intervene by adjusting resource allocation or it may be that micro-SLA is adjusted. It might assign fewer radio resources to sidelink and more to downlink (or vice versa if the downlink is congested and sidelink underutilized). It can even send a control message to the tracker or directly to the UEs, for example: “reduce P2P rate to X Mbps total.” The system will respect such messages; the RL agent's reward function at each peer can be designed to include a penalty if it exceeds a target share of cell capacity set by the network. Concretely, the base station (via RRC signaling or via a message through the tracker) could instruct peers to temporarily throttle their P2P transmissions or to fetch every Nth segment from the server instead of peers. The peers'P2P engines would seamlessly comply—since they always have the capability to get data from the server, they would simply shift more requests to the server until the sidelink usage falls within limits. This switch is designed to be seamless to the user's video player. The streaming client on the phone does not know whether a given segment came from a peer or the CDN; it just sees that segments arrive in time. So if the network commands a reduction in P2P, the engine might start pulling, say, 50% of segments directly from the CDN. The video playback continues normally, perhaps with a slight adjustment in adaptive bitrate if throughput changes. Later, if the congestion eases, the base station can allow more P2P traffic again (e.g., “you may raise P2P rate to Y Mbps” or allocate more sidelink resources). The orchestrator and AI agents incorporate these signals: the network's instructions effectively shape the reward structure (the peers learn that exceeding that rate is undesirable), ensuring that the system's behavior aligns with operator policies and network conditions. This dynamic allocation and switching capability ensures that P2P usage benefits overall capacity without ever overwhelming the network or harming other services.

Dynamic switching between sidelink P2P and server-based streaming may be performed under network control. In a first phase, Phase 1, peers heavily utilize sidelink to exchange chunks (indicated by thick arrows between UEs), while the base station monitors load. In Phase 2, when congestion is detected, the base station signals the peers to reduce P2P usage. Subsequently, one peer fetches more data from the content server and reduces sidelink transmissions (thin arrow between UEs), thereby offloading the cell. The switch is orchestrated by the network so that the user's experience (video playback) is uninterrupted—the change happens in how the data is sourced, not in what the user sees. Once network conditions improve, the base station can signal a return to more P2P operation.

Session Termination: When a user finishes viewing or leaves the area, it deregisters from the tracker and disconnects from peers. Its cached chunks might remain for a short while in case it re-joins or another user arrives very soon (to avoid losing a chunk that could immediately help a neighbor), but eventually, the device will clear the cache or let the chunks expire to free memory (and also to respect content licensing durations). The tracker updates its peer list by removing the departing node. The content server and orchestrator may also log that this user's chunks were delivered via P2P for analytics or billing purposes (e.g., to potentially reward the user with data credits for contributing upload bandwidth, if the operator chooses to incentivize participation).

Throughout the above, standard video streaming logic (buffering, adaptive playback) runs on the client. The goal is that the P2P underlay is transparent to the actual media player—it just sees a source of data. If chunks arrive faster, the player's adaptive bitrate logic might increase quality; if slower, reduce quality. The system aims to keep that logic in a high-performance state (less stalling). The interface with the media player (e.g., the Media Session Handler in the 5GMS client) is maintained. For example, one way is to implement a virtual HTTP server on the device that the player (DASH player) connects to; this local server either returns data from local cache/peers or fetches from the network as needed. That way, from the viewpoint of the video player, it's doing normal HTTP streaming, unaware that behind the scenes, some of those HTTP GETs were fulfilled by a neighboring phone.

This design also accommodates scenarios where a server performs substantial processing tasks, such as rendering complex scenes or volumetric content. In such configurations, the server pre-renders complex media content, encoding it into 2D formats accompanied by necessary metadata. These pre-rendered views are then transmitted to client devices, which decode and integrate them into local scenes. The P2P framework enhances this process by enabling devices to share received content chunks with nearby peers, reducing redundant server requests and optimizing bandwidth usage.

By facilitating peer-to-peer sharing of server-rendered content, the system decreases latency and alleviates network congestion, which is crucial for immersive experiences where timely content delivery is essential. Peers can distribute pre-rendered views among themselves, ensuring smoother playback and reducing the load on central servers.

By integrating P2P capabilities with server-based rendering, the framework supports scalable, efficient, and low-latency delivery of immersive media content, aligning with emerging 3GPP standards in the field.

Peer selection is the process of choosing which other node(s) a device should connect to or request data from. In a mobile P2P overlay, making a poor peer choice can severely impact performance (e.g., choosing a peer with a weak signal could lead to lost packets and rebuffering). Traditional systems might use simple heuristics like favoring peers with higher past throughput or closer proximity. In embodiments herein, each device's P2P engine includes a Peer Selection Agent that uses reinforcement learning (RL) to dynamically select peers and update those choices over time.

State, Actions, Rewards: peer selection may be formalized as an RL problem. The agent's state could include: current list of candidate peers and their attributes (signal strength, recent throughput, buffer status, etc.), the device's own buffer level (how urgent is more data), time since last segment needed, etc. An action is choosing a particular peer to download the next chunk from (or possibly an action could be a vector if requesting multiple chunks in parallel from different peers). The reward can be defined based on streaming QoE: a positive reward for successfully received chunk data (especially if it prevents a buffer stall), and negative penalties for outcomes like a stall event, high latency, or timeouts. Over many chunk requests, the agent learns which peer choices maximize cumulative reward (which correlates with smooth playback).

A contextual bandit or Q-learning approach may be applied initially, given the action space is discrete (choice of peer) and environment is semi-stationary. A neural network function approximator (deep Q-network) can be used to handle the complex state space. Alternatively, a simpler multi-armed bandit with Thompson sampling could work if state is minimal (like picking the fastest peer on average, but that ignores varying conditions).
Graph Neural Network for Peer Ranking: Another method is to use GNNs to aid peer selection. The local peer connectivity can be seen as a graph where the device is a node connected to candidate peer nodes. A GNN may be fed with node features (like each peer's link quality metrics) and edge features (like capacity of link) to compute a score for each neighbor indicating utility. This effectively can perform an aggregation of not just direct peer info but second-hop info if available (maybe a peer that has many other connections could be more loaded, etc.). The GNN model could be trained (via supervised or RL) offline and then run quickly on device to output a ranking of peers. One advantage of GNN here is scalability: if the number of peers changes, the GNN can handle variable input graph sizes and still output a decision.
Federated Learning for Selection Policy: it is anticipated that an individual device might have limited training opportunities (one device sees only its own environment). To avoid each device having to “reinvent the wheel,” federated learning is used to train a global peer selection model. In practice, this could mean each device occasionally shares anonymized experience data (state-action-reward tuples) or gradients of its RL model to a central aggregator (tracker AF). The aggregator performs a federated averaging of the model parameters, yielding a global model that is then sent back to devices. This means if many devices observe that certain patterns (like a peer with high RSSI tends to give good throughput) correlate strongly with good outcomes, the global model will quickly latch onto that, and even a new device can benefit from this knowledge without having to learn it from scratch. Of course, each device will still fine-tune to its context, but FL accelerates learning and adapts to macro patterns (like, maybe one brand of phone has a faster Wi-Fi Direct which could be captured as a feature).
Cold Start and Peer Discovery: Initially, when no learning has happened, the system can default to a rule: e.g., pick the peer with highest reference signal (RSRP) or the peer recommended by the tracker (the tracker might sort peers by proximity or known capability). As data accumulates, the agent will gradually override the default with learned policy. The RL exploration is controlled—using techniques like epsilon-greedy with decaying exploration—so that the agent doesn't thrash or cause too many stalls by exploring bad peers frequently. In streaming, maintaining QoE is paramount, so the RL will be tuned to be safe (there are known methods for RL in sensitive domains, like giving some baseline guarantee or switching off if performance drops). Domain knowledge can be integrated: for example, obviously blacklisting a peer that consistently fails to deliver (no need to keep exploring that).

Each peer has limited cache/storage for content. Deciding which content to cache or prefetch is critical for maximizing the P2P system's usefulness. Ideally, peers collectively maintain as much of the relevant content in the vicinity as possible, reducing the need to fetch from remote servers.
One approach: a model is trained to predict the popularity of content segments among the local group of peers in the near future. For example, in a live stream, it might predict how many peers will request the next chunk, or in a VOD scenario, which part of the video is likely to be replayed or accessed by others (if many are around the same playback point). Using FL, each device can use its viewing history and maybe contextual info (time of day, location events) to train a local popularity model (perhaps an LSTM or sequence predictor for content interest). The aggregated model then gives all peers a sense of which chunks are hot. Armed with this, peers can prefetch those chunks even before they themselves watch them, solely to serve others. For instance, if a user is 10 seconds ahead in a video, they might cache the upcoming segments and a trailing peer can get them from this cache. In effect, peers slightly ahead in the stream timeline serve as proactive cache nodes for those slightly behind.

Not every peer should cache the exact same segments (except super-critical ones)—it's wasteful. A possible solution is a distributed caching game where each peer, after receiving a segment, decides whether to keep it based on how many copies it believes are already nearby. This belief can be formed via messages (peers can tell the tracker which segments they currently hold). The tracker (or a decentralized gossip) can inform peers, “segment 5 is currently held by 3 peers in your cell.” If that is sufficient (given maybe 5 peers need it soon), a new peer might choose to free that segment earlier, focusing on another segment that's less common. An optimization problem may be formulated: maximize the coverage of distinct segments cached across all peers under their size constraints. This is similar to cooperative caching algorithms in literature. A distributed auction or RL may be used to allocate segments to peers'caches. Each segment could have a “value” (expected number of times it will be requested by neighbors) and peers bid their cache space for it. An RL agent may be trained at the tracker to allocate who caches what segment (the action being an assignment of segments to peers, state being request forecasts, reward being cache hit reduction in server downloads). This might be complex to do in real-time for every chunk, but a simplified periodic approach (like every few minutes, optimize which segments to retain) is feasible.

To implement prefetching, it should be ensured that when a peer has spare download capacity (its playback buffer is comfortably full), it can request chunks slightly ahead of its playhead not just for itself but specifically to help others. The AI model will guide which those might be. This uses network resources, so it's a trade-off: this may be done only if the predicted demand is high enough to justify the extra load. Because all this happens within an operator-controlled environment, the network can also limit prefetch if needed (ensuring it doesn't congest the cell).

In scenarios where accurate content caching and prefetching information significantly enhances overall network efficiency, relevant predictive analytics derived from the federated learning process should indeed be reported to the network. Specifically, the prediction of segment popularity or anticipated peer requests can be reported through the 5G IMS infrastructure or through a dedicated Application Function (AF) interfacing directly with the Policy Control Function (PCF) or Network Data Analytics Function (NWDAF). The procedure for this reporting involves each peer aggregating its local caching prediction statistics periodically (e.g., every few minutes) and transmitting summarized data to the P2P orchestrator (which acts as an Application Server in IMS architecture). The orchestrator or the AF compiles and forwards relevant aggregated analytics to the NWDAF or directly to the PCF using standardized 3GPP interfaces (N5 for PCF, N23 for NWDAF). This information enables network functions to dynamically adjust QoS policies, provision additional bandwidth for segments predicted to experience high demand, or instruct certain peers to proactively cache or clear specific segments. The IMS or AF uses existing SIP signaling channels or the NEF/PCF/NWDAF APIs defined by 3GPP to facilitate secure and standardized information transfer, thus seamlessly integrating caching intelligence into the network control plane.

Maintaining QoS is crucial for live multimedia. metrics like low latency (startup delay, rebuffering rate) and stable playback with high quality may be used. The P2P system must not introduce instability (like highly variable throughput due to peer changes). The approach to QoS is twofold: end-to-end and network-level.

End-to-End Rate Control: Each peer uploading content must should perform congestion control similar to TCP (but here it's UDP or custom transport over PC5). An RL-based congestion control (inspired by PCC Vivace or BBR algorithms, but possibly learning-based, is used in embodiments). The sender can probe and learn the optimal rate to send to a particular peer. For example, an RL agent on the sending peer can adjust send rate (or chunk send interval) to maximize throughput without causing excessive packet loss (which would harm QoS). The reward could incorporate the receiving peer's buffer health as well (since some control info can be exchanged between peers). This becomes a cooperative optimization: both peers want the stream to be smooth. It might be that a simpler approach, like additive-increase multiplicative-decrease (AIMD) tailored to sidelink, is enough. But having a trainable algorithm means it could adapt to different RAN scheduling policies or interference situations better than a static one.
Network-aware QoS: The core network and base station can provide guidance via the 5G QoS framework. For instance, the network might classify P2P video packets with a certain 5QI (QoS indicator) that ensures they get appropriate priority. The network classifies video packets through the 5G Policy Control Function (PCF), using policy rules triggered upon receiving traffic descriptors from the Application Function (AF). Specifically, the P2P Application Function communicates with the PCF via the standardized N5 interface, specifying flow characteristics (such as media type, bitrates, latency sensitivity). The PCF then dynamically assigns an appropriate QoS Flow Identifier (5QI) based on operator-defined policy, ensuring packets for sensitive video streams receive necessary scheduling priority and resource allocation in the base station's scheduler. The assigned QoS profiles directly inform the NG-RAN and UPF to prioritize packet handling according to these QoS Flow Identifiers. If the cell is overloaded, the network can signal the devices to reduce their video bitrate (similar to how YouTube might lower quality in congestion, but here the network can directly hint it). Such signals can be incorporated in the agent's state or as overriding rules. Additionally, if the network detects congestion on the sidelink (maybe too many collisions or high interference), it could instruct a fallback to more use of downlink. The system is flexible: in worst case, it can always fall back to client-server delivery. So the AI in peer selection might also learn network conditions: e.g., if the sidelink becomes unreliable due to distance, it might route data indirectly or switch to infrastructure.

PC5 in current 5G doesn't natively support multi-hop forwarding, but nothing stops the application from forming multi-hop routes (a peer forwards a chunk to another peer, who then forwards to a third). This could be beneficial if two devices wanting to share are not within direct range but can reach via an intermediate. The GNN model could identify if multi-hop would help (like a graph path exists with strong links). If so, a peer could be designated as a forwarder. This essentially creates an overlay route similar to a small MANET. However, each hop adds delay and complexity if needed (perhaps in sparse scenarios). The focus is mostly on single-hop given typical cell coverage areas, but the architecture doesn't preclude multi-hop extension (which might align with 6G's device-as-router concepts).

Routing means deciding the path that content takes from a source peer or server to the requesting peer. In the design, two main paths exist: direct P2P path (sidelink between devices within a cell or in proximity) and indirect path via network (either via the cell's base station or via another peer). Dynamic routing entails switching between these or combining them. A scenario illustrating this: User A and User B are peers in the same cell. Ideally, A sends to B directly. But if at some moment the direct link quality degrades (maybe one walked behind a building), it might be faster for A to send to the base station (uplink) and B to receive from base station (downlink), essentially falling back to using the network as a relay. While this defeats some of the offload benefits, it might be necessary to maintain QoS if direct fails. The system can make such routing decisions on the fly.

The orchestrator (or a distributed consensus) can decide if a certain peer pair should use direct or go through eNB (which is basically normal network). In some cases, even if direct works, using the eNB as relay could provide a more consistent latency (since the eNB can schedule it). However, that uses twice the spectrum (uplink+downlink) whereas direct uses only sidelink. This is a trade-off between quality and efficiency. E.g. a policy: always prefer direct unless predicted quality falls below a threshold. The prediction can come from a GNN that looks at current link metrics and perhaps interference. If prediction says “link A-B can't support required bitrate”, then route via infrastructure.
Another aspect is path diversity: sending duplicate critical data via multiple paths for reliability. For example, important initialization data or very popular segment might be sent to multiple peers or via multiple routes (like peer plus base station) so that it definitely arrives. This is analogous to using error-correcting codes or multi-source streaming. With AI, a model can be trained to identify when to use redundant sending—e.g., a model could learn that on cellular at edge-of-cell, packet loss spikes, so to maintain QoE you need redundancy. Then peers at cell edge could request the same chunk from two different peers (or peer+server) and use whichever arrives first (the other is mostly waste, but ensures no stall). This kind of decision could be made by a learned policy that balances the cost (extra network usage) and benefit (avoiding stall). Indeed, the P2P overlay facilitates efficient transfer and dissemination of trained AI/ML models among peers. For instance, trained federated learning models or incremental model updates can be efficiently distributed directly among peers or from a central orchestrator to devices using the same P2P protocol infrastructure described. Model transfers leverage secure, encrypted channels established via the SIM/eSIM-based identity and authentication described previously, ensuring authenticity and integrity. Moreover, the P2P orchestrator coordinates incremental model updates, disseminating only changes (differential updates) to minimize bandwidth overhead, integrating with existing 3GPP AIML model transfer initiatives.
Graph-based Routing: If a cluster of peers is considered, potential connections can be modeled as a graph. Running a shortest path or max-flow algorithm on that graph could maximize overall throughput in the cluster essentially constructing a distribution tree for content (like how multicast would). A central function (tracker) could compute an optimal overlay topology for the peers (who should connect to whom) to maximize speed and minimize redundant transmissions. This is similar to classic overlay optimization problems, which are NP-hard in general, but the approach is to have a learned heuristic (via GNN). The GNN could be trained on examples of small networks to approximate the optimal solution (there is research in using GNN for network flow optimization that shows promise). The output would be, for each pair, a suggestion if they should connect or not. The peers then form those connections under guidance. This way, instead of random mesh, a purposefully optimized mesh is obtained that might, for example, form a multi-tier structure: a peer with good backhaul stays primarily server-fed and then forwards to others (like a de facto super-peer). The difference from old super-peer designs is that this role is not fixed or manually assigned; it emerges from the model's evaluation of capabilities and can change if that peer leaves or its conditions change.

In summary, AI helps handle the dynamic nature of routing in the P2P system, making it adaptive rather than static. These optimizations collectively ensure that the P2P architecture isn't brittle-it can adapt to network changes, user movement, and varied demand patterns. The ultimate goal is that users experience streaming as smoothly (or better) as they would in a pure CDN approach, but with far less strain on the network and potentially lower latency (since local transfers can be quicker than going through a distant server).

Scalability is addressed on multiple fronts in the design. On the peer side, the use of gossip discovery and hierarchical tracking (e.g., track by cell/region) means that even if thousands of users are streaming the same event, each peer only deals with a manageable subset (nearby ones). The heavy-lifting of global swarm coordination is distributed. For example, tracker signaling per peer might be O(1) and overall O(N) for N peers, which is fine up to huge N if the tracker is cloud-based (can scale out). The peer mesh itself will naturally segment if peers are far (since PC5 range is limited, typically a few hundred meters max). That means the system forms localized swarms (which might overlap via some bridging peers if content needs to hop across). This locality is good for scalability and also aligns with network topology (peers in same cell or neighboring cells form clusters these clusters can be seen as independent or lightly interacting).

One potential bottleneck is if one peer becomes too popular (like a super-peer serving dozens of neighbors). The incentive and load-balancing mechanism (plus the AI agent's selfish objective to maximize its own QoE) should prevent a device from overwhelming itself. If a peer's upload is saturated, it will start denying new requests or the orchestrator will direct new peers elsewhere. This is similar to how BitTorrent seeds have limited slots. Each peer declares an upload capacity (could be dynamic based on its battery or data plan) and the system respects that. Thus, load can be spread among peers. In worst-case scenarios where most peers are very low capacity, the system gracefully falls back to more server help.

In terms of computational scalability (AI training etc.), federated learning on the devices is designed to be lightweight: models used (for popularity or selection) are relatively small (not millions of parameters as in vision tasks). Devices in aggregate doing FL actually scale well—more devices can mean better model quality up to a point (statistical benefit), with the trade-off of more communication for FL synchronization. But FL rounds might be done infrequently (e.g., once every few minutes or triggered by significant changes), so the overhead remains low.

The orchestrator function might run some heavy tasks (like aggregating hundreds of model updates, or computing optimal overlays for a big swarm). This is feasible with modern cloud computing—it's not more intensive than analytics tasks carriers already plan for (like NWDAF doing big data analysis). And because it's content-specific, these costs could potentially be shared or even offloaded to the content provider if they deploy an instance of the function in their CDN.

Security is paramount since device-to-device communication can introduce vulnerabilities if not properly secured. The system leverages the security frameworks of 5G:
Device Authentication: All participating peers are authenticated subscribers on the network (via SIM/AuC). The PC5 link setup can use established security (in LTE ProSe, there were sidelink security mechanisms using pre-shared keys or certificates issued by the operator). Only authorized devices can exchange data. This prevents rogue devices from injecting themselves into the mesh unless they pass network authentication.
Encryption of Content: To enforce content rights and privacy, content is encrypted end-to-end from the content server to the player application. Existing DRM or simpler symmetric encryption per stream may be used. Keys are distributed by the content provider (e.g., through a license server during session setup) to legitimate clients. Peers do not need to decrypt content to forward it, they can just pass encrypted bytes. This ensures that even if someone manages to eavesdrop on the sidelink or hack a peer app, without the key they cannot view the content. It also means that the network/tracker doesn't see the actual media bits, just encrypted payload—which is good for user privacy (the network knows user is streaming something, but that's true anyway in conventional streaming).
Integrity and Cheat Prevention: chunk hashing may be used like in BitTorrent (each chunk has a known hash from the manifest or initial metadata). When a peer receives a chunk from another peer, it verifies the hash. If it doesn't match, the chunk is discarded. This prevents tampering (a malicious peer sending bogus data). It also allows detection of a malfunctioning peer—if peer X consistently sends wrong data, others can flag it. The tracker could then blacklist that peer from the swarm (or reduce its reputation). A simple reputation score may be obtained for peers (increment for successful uploads, decrement for failures) to aid selection—similar to tit-for-tat but also punishing bad behavior. This is internal, not exposed publicly, so privacy is kept.
Privacy: Federated learning helps keep personal data local. For instance, a user's viewing history or behavior pattern stays on their device; only model updates (essentially gradient info) are sent, which are not easily interpretable to extract raw data (and can be further protected by techniques like differential privacy if needed, at some cost to accuracy). The tracker can be such that it doesn't need to know user identities—it can operate with anonymized tokens. For example, it could tell peer A “contact peer B at this sidelink ID for content”, without knowing who A or B are (other than being subscribers allowed for this service). This way, if someone were to breach the tracker server, they get limited info.
Regulatory compliance: If needed (for lawful intercept or emergency override), the operator still has control as all devices are known and can be instructed. For instance, in a public safety scenario, if authorities need to shut down P2P (maybe to free resources for emergency messages), the network can signal to disable the service. This is an advantage of integrating with 3GPP—unlike pure ad-hoc networks, here the operator is in the loop and can enforce policies.
One possible security concern is free-riding: users might want to benefit from peers but not share their own uplink (to save battery or data). A peer that refuses to upload will soon not be prioritized by others (similar to tit-for-tat in BitTorrent). If a peer's contribution is below a threshold, the tracker stops giving it peer lists or peers drop connections. Since all users ultimately want good service, they are incentivized to contribute if they can. This “equal effort” model tends to naturally arise, but will carefully tune so that low-capability devices aren't unfairly penalized (e.g., a phone with poor uplink shouldn't be cut off as a leecher if it genuinely can't upload much; the system should recognize capacity differences-which may be done via initial ability advertisement or through AI learning who can contribute how much).

The system aims to improve spectrum usage by reducing duplicate transmissions. In traditional streaming, if N users in a cell watch the same video, the base station sends N separate streams (unless multicast is used). With P2P sharing, ideally the base sends one stream and devices share it, meaning much less downlink airtime is used. Some of that load shifts to sidelink and uplink:
Uplink: Peers will transmit chunks to others. This uses uplink spectrum which otherwise might be idle (in many cases downlink traffic dominates video usage, uplink is under-utilized in cells with mostly consumers). By activating uplink for content distribution usage is balanced. This is especially valuable in 5G where massive MIMO and scheduling can handle uplink efficiently for short ranges. The uplink transmissions in the scenario are generally local (to reach a neighbor device), which can often be done with lower power and coding (since neighbor likely hears well), so it can be spectrally efficient (higher MCS, less redundancy needed).
Sidelink: If using dedicated sidelink channels (like those defined for V2X in 5.9 GHz or in-band sidelink), are utilized only when needed. 5G NR sidelink allows reuse of frequencies. Sidelink may operate operate on the same carrier as cellular (under gNB control mode 1) or a separate carrier (less common for general devices). In either case, these resources are not wasted because they are allocated on-demand. If no P2P activity, they can be used for something else or remain free.
Multicast vs P2P: eMBMS is great for very large groups (like broadcasting TV to thousands), but for moderate groups it's inefficient to reserve a broadcast channel. P2P scales naturally with group size: it's more efficient than unicast once there are a few receivers, and doesn't require continuous dedicated spectrum as multicast would. P2P also works for content with different timings per user (VOD) which multicast can't handle well. So P2P is complementary—filling the gap for small/medium groups and asynchronous consumption, thereby achieving efficiency where multicast isn't applicable. For group sizes in the range ~3 to 50, P2P yields substantial gain, whereas below 3 it falls back to unicast and above 50, one might consider switching to a broadcast if available (though even at 50, P2P might still be fine if network can support the mesh).

An additional enhancement to the architecture involves leveraging the concept of “sidelink multicast groups,” as supported by 3GPP NR sidelink standards (originally defined in V2X applications). Specifically, when several peers in close geographic proximity simultaneously request the same content at roughly the same playback position, the orchestrator (P2P-OMF) can dynamically establish a sidelink multicast group for direct D2D multicast. This approach involves scheduling one peer (chosen based on signal quality and resource availability) to multicast the content segment to multiple peers simultaneously within the designated sidelink resource pool.

While the system primarily excels in moderate-sized groups (as explained above), there is potential for very large group sizes, where sidelink-based P2P alone might face scalability or efficiency challenges. If the orchestrator identifies a scenario where a large number of users in a cell (e.g., significantly more than 50) request the same content simultaneously and in synchronization, it can dynamically coordinate with the 5G core network's control-plane functions (such as the 5G Broadcast/Multicast Service Function, BMSF, and the Policy Control Function, PCF) to establish an FeMBMS multicast channel from the gNB. In this scenario, the gNB initiates a traditional broadcast or multicast session, allocating dedicated multicast resources (broadcast resource blocks), efficiently serving the high number of simultaneous users without overloading sidelink and uplink channels. Implementing sidelink multicast groups significantly reduces redundancy compared to multiple independent sidelink unicast transmissions. Instead of transmitting the same chunk individually to each peer in the vicinity, a single transmission efficiently serves multiple peers simultaneously, further enhancing spectral efficiency. This mechanism is particularly beneficial during local peaks of simultaneous viewing—for example, a cluster of users watching a high-interest scene or live-streamed event simultaneously. Additionally, in advanced network architectures supporting integrated terrestrial and non-terrestrial networks (NTN) like satellites, the orchestrator may dynamically leverage satellite-based FeMBMS broadcast capabilities. For instance, if terrestrial network congestion or user distribution across multiple geographically dispersed cells occurs, satellite multicast might become a more efficient content delivery option. In such scenarios, orchestrators coordinate with NTN control functions via standardized 3GPP interfaces to temporarily offload heavy content distribution onto satellite multicast channels, significantly reducing terrestrial spectral load and ensuring seamless and efficient content delivery to large-scale user populations.

Importantly, the system incorporates a fully bidirectional capability—transitioning smoothly from pure P2P (for smaller, moderate groups) to multicast/broadcast approaches (for larger synchronized groups) and vice versa. The orchestrator continuously monitors group dynamics, network load, and consumption patterns. If a previously large synchronized group (served efficiently by multicast) decreases over time—such as viewers gradually leaving or becoming asynchronous—the orchestrator can dynamically disable multicast channels and smoothly revert content delivery back to efficient sidelink-based P2P communications. Conversely, if user demand grows rapidly or synchronizes again, the orchestrator seamlessly re-establishes multicast channels. Through this adaptive, dynamic mechanism, the architecture inherently supports a hybrid multicast-P2P delivery approach, optimizing spectral efficiency across the full spectrum of user-group sizes, ranging from small asynchronous clusters to large-scale synchronized viewing events.

One possible drawback is interference: multiple devices transmitting could interfere with each other or with cell signals if not coordinated. Using the base station's coordination (scheduling different time-frequency resources for different PC5 transmissions) may mitigate. Also, since transmissions are local, their interference range is smaller (a device transmitting to a neighbor won't greatly affect another far user if appropriate power control is used). Devices can transmit at just enough power to reach their peer reliably, rather than max power, which localizes interference. This is something that could be offloaded to a GNN or algorithm that, knowing network topology, sets powers to an optimal trade-off.

In terms of spectral efficiency in numbers: Suppose baseline unicast uses X spectrum for N users. P2P might use about X/~N on downlink (as one copy) plus overhead Y on sidelink. Typically, if N is large, Y<<X*N, making it very efficient. If N is small, overhead might not justify—but then the system wouldn't engage P2P aggressively for 2 users unless direct is clearly beneficial (which it can be if they are near; it might save base station resources albeit using similar amount in uplink). The design can adapt—if a scenario doesn't benefit, it can quietly not use P2P (or even revert to server for everything).

6G might operate in higher bands where device-to-device could be even more efficient since direct path might exist (line-of-sight) that is better than going through infrastructure with multiple hops. Also, 6G is likely to use dynamic spectrum sharing and AI to allocate resources. The system is an early example of that: using AI (in scheduler and agents) to dynamically share spectrum between direct and network usage. It effectively proves concepts that 6G architects are discussing (like user-centric cell-free networks where users cooperate).

In conclusion, the proposed architecture is scalable to large user bases by its decentralized nature and network assistance, it is secure and respects privacy thanks to robust application of 3GPP security and additional cryptography, and it is spectrally efficient by reducing redundant transmissions and smartly leveraging underused sidelink channels. These properties make it not only an academic novelty but also a practical solution potentially adoptable in future mobile network deployments or even standardization.

A method for enabling real-time peer-to-peer (P2P) multimedia communication in a 3GPP-compliant network, comprising: a. establishing direct P2P data paths between user equipment (UEs) based on proximity and common media content interests; b. applying a distributed artificial intelligence (AI) model at each UE for real-time multimedia chunk selection, scheduling, and routing decisions; c. training said AI models locally on each UE using federated learning such that raw media or user data is not transmitted to a central server during training; d. aggregating AI model updates at a network-edge node or service to periodically synchronize a global model, which is then redistributed to the UEs; and e. utilizing a multimedia-aware quality-of-service (QoS) control function to dynamically assign transmission priorities or bitrates based on media type, buffer status, and channel conditions.

The P2P data path is established over a sidelink interface in accordance with 3GPP PC5 protocols, enabling direct device-to-device communication under the coordination of a base station. Multimedia content distribution is performed in a swarm-like manner inspired by BitTorrent, such that each UE serves as both a content requester and a content provider for different segments of the media. Each UE employs a reinforcement learning agent to optimize peer selection and transmission scheduling in order to minimize playback stalls and maximize spectral efficiency. The federated AI model is trained using a loss function that jointly considers throughput, latency, jitter, and playback smoothness for the real-time multimedia stream.

A system for federated peer-to-peer multimedia communication in a 3GPP-compliant network, comprising: a. a plurality of UEs configured with P2P engine software and 3GPP sidelink communication modules, each UE including local AI agents for decision-making; b. an edge orchestration entity configured to aggregate and broadcast global AI model updates to the UEs and to maintain a content availability index for participating UEs; c. a decentralized content registry or tracker that allows UEs to announce and discover media chunk availability among peer UEs; and d. a scheduling controller embedded in a base station (gNB) or core network function to perform media-specific prioritization and congestion control for both sidelink and downlink transmissions.

UEs include a content caching module adapted to store and share multimedia chunks with peer UEs to reduce network backhaul usage. The edge orchestration entity interfaces with core network functions including a Policy Control Function (PCF), Access and Mobility Management Function (AMF), or Network Exposure Function (NEF) to obtain context and to enforce network policies for the P2P service. The UEs are configured to perform AI-driven resource allocation and beam selection that is compatible with 3GPP NR adaptive beam management procedures, to enhance sidelink link quality.

A computer-readable medium containing non-transitory instructions which, when executed by a UE, perform the steps of: a. identifying nearby peer UEs that share a same media content interest using a discovery protocol; b. requesting multimedia content chunks from one or more of the identified peer UEs using a trust-scored peer ranking system; c. training and updating an on-device AI model that predicts optimal peer selection and transmission scheduling strategies based on observed network conditions; and d. conducting sidelink-based multimedia data transfer while adhering to network-defined QoS classes and reacting to network control signals for rate adjustment. Compressing and encrypting federated learning updates (model parameters) sent from the UE to the edge orchestration entity to ensure privacy and network efficiency during AI model training. Multimedia chunk prioritization for transmission is dynamically adapted based on emergency or public safety classifications defined by 3GPP standards, such that critical content is delivered with higher priority via the P2P network when needed. AI models utilize edge-based intelligence coordination to ensure robustness under dynamic topology changes and cellular handovers, maintaining stable performance as UEs join or leave and as they move across cell boundaries.

What is claimed is:

1. A method performed by a user equipment (UE), the method comprising:
receiving video content, from a video server, via a user plane function (UPF) of a cellular network; receiving, in accordance with information held in the user plane function (UPF), rate limiting information that indicates a rate limit applicable between the UE and the video server, wherein the cellular network administers a policy having a time defined constraint measured according to a number of seconds, wherein the constraint corresponds to a rate limit of the video content; and
self-adapting and or rate-adjusting the video content, based on the rate limit information and the number of seconds;
wherein the number of seconds is between 60 and 120 seconds.

2. The method of claim 1, further comprising:
temporarily disabling some rate limiting for a number of seconds when the network upgrades the capacity.

3. The method of claim 1, wherein the rate limiting information is information indicating an increase from a previous rate limit.

4. The method of claim 1, wherein the UPF applies rate limiting controls to flows other than video flows, including a bulk download flow.

5. The method of claim 1, wherein the rate limiting information is a maximum bitrate of a service data flow.

5. A method for enabling real-time peer-to-peer (P2P) multimedia communication in a cellular network, the method comprising:
establishing direct P2P data paths between user equipment (UEs) based on proximity and media request similarity;
applying a distributed artificial intelligence (AI) model at each UE for real-time multimedia chunk selection, scheduling and routing;
training the AI models locally using federated learning;
aggregating AI model updates at a network edge node for periodic global model synchronization;
utilizing a multimedia-aware quality-of-service (QoS) function to assign dynamic transmission priority based on media type, buffer status, and channel conditions;
wherein the P2P data paths between the UEs are rate limited by a network node.

6. A method of negotiating quality-of-service (QoS) parameters between a user equipment (UE) and a mobile communication network, the method comprising:
monitoring by the UE, one or more operating conditions of an application executing on the UE to detect an intent indicating a need for enhanced QoS for a data session associated with the application;
generating, by the UE in response to the detected intent, an intent message comprising a request for a temporary QoS enhancement, the intent message including information about the application's service requirements and an identifier of the data session or traffic flow;
transmitting the intent message from the UE to a network-side QoS control function over a signaling interface;
receiving a negotiation response from the network-side QoS control function to the UE's intelligent agent, the response indicating whether the requested QoS enhancement is approved, and if approved, specifying a set of negotiated QoS parameters and a validity period for a micro service-level agreement (micro-SLA) during which the QoS parameters will be enforced;
wherein network resources are configured in accordance with the negotiated QoS parameters for the identified data session or traffic flow, including adjusting at least one of: a QoS flow in a core network, a radio bearer in a radio access network, or a network slice assignment for the UE;
wherein, during a validity period of the micro-SLA, the negotiated QoS parameters are enforced for a data session of the UE such that the data session or traffic flow receives the requested QoS treatment;
automatically terminating the micro-SLA upon expiration of the validity period or upon detection that the enhanced QoS is no longer required, by reverting the UE's QoS treatment to a baseline level and releasing any temporarily allocated network resources.
